(19) United States
(12) Patent Application Publication
(10) Pub. No.: US 2013/0144589 A1
(43) Pub. Date: Jun. 6, 2013

(54) SYSTEMS AND METHODS FOR CIRCUIT DESIGN, SYNTHESIS, SIMULATION, AND MODELING

(71) Applicant: Delon Levi, San Diego, CA (US)

(72) Inventor: Delon Levi, San Diego, CA (US)

(21) Appl. No.: 13/702,555

(22) PCT Filed: Jun. 3, 2011
(86) PCT No.: PCT/US11/39115

§ 371 Date: Feb. 19, 2013

Related U.S. Application Data
(60) Provisional application No. 61/352,792, filed on Jun. 8, 2010.

(51) Int. Cl. G06F 17/50

(52) U.S. Cl. CPC G06F 17/50
USPC 703/14

(57) ABSTRACT

Systems and methods for specifying, modelings simulating, and implementing a circuit design using a circuit design database comprising re-usable program elements to represent circuit design elements. The re-usable program elements may be used to build an overall circuit design description in the database. In example embodiments, the circuit design may be structured as a computer program and library to deterministically specify the circuit design elements to be used. Circuit synthesis functionality and circuit simulation functionality may be embedded as part of the re-usable program elements. Libraries may be compiled with the computer program instructions specifying the circuits to generate an executable that can be used for synthesis and simulation The combined executable code may be executed on an instruction set processor directly or through an interpreter.

### CROSS-REFERENCE

This application claims priority to U.S. Provisional Patent Application Ser. No. 61/352,792, filed Jun. 8, 2010, which is entirely incorporated herein by reference.

### BACKGROUND OF THE INVENTION

As semiconductor designs have become larger and more complex, automated design tools and reusable intellectual property (IP) blocks have been developed to assist in the integrated circuit design process. For example, various design tools have been developed to help automate the process of circuit design, synthesis, simulation and modeling. High-level languages such as Verilog, VHDL and C/C++ may be used to represent circuit designs or behavior models for some tools. Some tools use iterative processes for search and optimization of integrated circuit designs. For complex designs, these processes may be computer intensive, time consuming and non-deterministic in some cases. Accordingly, systems and methods that allow for efficient re-use and redesign of complex integrated circuits and design elements are desired.

### SUMMARY OF THE INVENTION

Example embodiments include systems and methods for defining or specifying a circuit design using a circuit design database. In example embodiments, the circuit design database may comprise re-usable program elements to represent circuit design elements. The re-usable program elements may be used to build an overall circuit design description in the database. In some examples, the re-usable program elements may be classes, objects, procedures, functions, macros or other collections of computer program instructions that perform functionality associated with a circuit design element.

In example embodiments, the re-usable program elements may encapsulate computer program instructions and parameters representing (i) one or more descriptions of the functional behavior of the circuit design element; (ii) one or more implementations of the circuit design element; (iii) internal state information to simulate the behavior of the circuit design element and/or define the initial state for implementation; (iv) one or more self-tests to verify the re-usable program element, the circuit design element's functional behaviors, and the circuit design element's implementations; (v) wires attached to each of the circuit design element's inputs and outputs that connect it to other re-usable program elements/circuit design elements; and (vi) values for each of the wires indicating the current input and output states. These are defined as component re-usable program elements.

In example embodiments, the component re-usable program elements may also encapsulate computer program instructions and methods for (i) simulating the functional behaviors of the circuit design element; (ii) synthesizing the implementations of the circuit design element into equivalent netlist elements; (iii) modifying or querying the state information of the circuit design element; (iv) implementing the self-tests of the re-usable program element including tests on the functional behaviors and the netlist implementations; (v) modifying or querying the wires attached to each of the circuit design elements' inputs and outputs to connect the circuit design elements; (vi) modifying or querying the values on wires attached to the inputs and outputs.

In example embodiments, the circuit design database may comprise parameter re-usable program elements to encapsulate circuit parameters and their default values. Parameter re-usable program elements may also contain computer program instructions for querying or modifying their values, and other methods for defining new parameters with associated default values and associated instructions for querying or modifying those values.

In example embodiments, the re-usable program elements and API include parameters that specify implementation options for particular circuit components. For example, parameters may be used to specify the implementation area, speed and power requirements for the particular circuit component. The component type and implementation style may be selected by the circuit designer by specifying values for the parameters for a particular component. For example, an integer adder may be used in a circuit design by declaring an instance of a component re-usable program element that represents an integer adder. The API may also be used to select the implementation style for the integer adder. For example, the implementation style may be a fast integer adder, representing an implementation that prioritizes speed over area or other circuit characteristics. Structural implementation choices for the adder may also be set through the API. For example, the bit-width of the adder may be specified through the API. These are examples only and other embodiments may allow other implementation options to be specified.

In example embodiments, a parameter re-usable program element may have all parameters defined with default values for each. Other parameter re-usable programs may have particular parameters set at default states for creating particular embodiments of component re-usable program elements.

In example embodiments, the circuit design database may comprise wire re-usable program elements to encapsulate the connections between circuit design elements. The wires contain (i) unique names to uniquely identify them for simulation and implementation; and (ii) state with initial and changing values. Wire re-usable program elements define connections between inputs and outputs of one or more circuit design elements. The initial values define the initial state of the wires for simulation and implementation. The changing state defines the wire values for simulation, and may also define wire initial values for implementation netlists that are snapshots of simulation. Wire re-usable program elements may be defined independently or they may be automatically defined and included within the component re-usable program elements.

In example embodiments, the values on the wires may be read or written in numerous formats such as but not limited to (i) unsigned integer; (ii) signed integer; (iii) floating-point; and (iv) binary. These values may be read and written by the simulator during simulation. These values may also be read and written using programming instructions to stimulate and probe the circuit.

Instances of wire re-usable program element have the same pre-defined bit-width. This bit-width represents the maximum bit-width. Because all wires have the same width implicitly, the width is not explicitly specified at wiring creation or for wire connections. Component re-usable program elements automatically select the required bits to sink or source on connected wires.

The inputs and outputs on component re-usable program elements explicitly select the bits on the wires to sink or source. For example, the output of an 8-bit adder may drive bits 0 through bits 7 on a 32-bit wire. Only bits 0 through 7 on a wire attached to that output are driven during simulation or connected in the synthesized netlist. The circuit designer does not specify the wire width during wire creation, nor specify the bit connections to components. This simplifies connectivity specifications. The circuit designer simply creates wires and attaches them to the component re-usable program elements. The connection bits are automatically selected.

In example embodiments, the circuit design database may be a re-usable program element. This circuit re-usable program element may contain instances of component re-usable program elements, wire re-usable program elements, parameters re-usable program elements, and port re-usable program elements. It may also contain programming instructions for synthesizing the instances of component, wire, parameter, and port re-usable program elements into a net list for the circuit. The circuit re-usable program element may contain programming instructions data for simulating the circuit described by the instances. The circuit re-usable program element may contain methods and data for testing the simulated functionality of the circuit and the implemented netlist. It may further have methods and data for evaluating the results of the tests.

In example embodiments, the higher-level functional blocks may be defined through module re-usable program elements. Instances of module re-usable program elements accept instances of circuit re-usable program elements at creation. The module may then insert instances of component, wire, and other sub-module re-usable program elements to create functionality in the circuit database. Data for module re-usable program elements may encapsulate (i) type name and type code; (ii) implementation options; (iii) simulation options; (iv) instances of wire re-usable program elements for input and output pins, and for internal wires; (v) instance of component re-usable program elements; (vi) instances of module re-usable program elements; and (vi) other data variables to assist in the circuit construction. Type name and type code are unique names and codes to distinguish and identify the module. Implementation options may describe implementation size and style. For example, the implementation options may specify the bit-width, a fast implementation, or small area implementation. These options may be passed to constituent components and modules. Simulation options may specify the kinds of simulation models to use for the underlying components. For example, the simulation options may specify behavioral functional models, or fine grained circuit models for the components. These options may also be passed to constituent components and modules. Instances of wire re-usable program elements connect the module with other modules, components, and ports. Wires on a modules IO pins may be attached to IO pins of other modules, components, and/or ports to connect them. Wire instances may also be used to connect internal components, wires, and ports. A module instance may contain other module instances, even instances of itself; to create higher-level functionality in the circuit database.

In example embodiments, since the module instantiates its functionality directly into the circuit database ultimately implementing only base components and wires, which generate implementation netlists and posses simulation models, it is automatically synthesized into the netlist when the circuit database is synthesized into a netlist. Similarly, the module is automatically simulated when the circuit is simulated. The module simply constructs its functionality in the circuit, and implementation and simulation means are automatically provided. A module is a mechanism that allows the circuit designer to build their own high-level functionality. They simply create a module and insert the circuit into the module and define the components, wires, and sub-modules that create the intended functionality. The modules may be collected into an API library.

In example embodiments, the circuit design database may comprise port re-usable program elements to enable the circuit to communicate externally. The ports contain (i) a direction, like in or out; (ii) a unique name to identify the port; (iii) a bit-width; and (iv) an instance of a wire re-usable program element. The direction specifies the flow of information through the port with respect to the circuit. The name identifies the port for simulation and implementation. The bit-width defines the number of bits driven through the port. The wire instance enables the port to connect with internal components and modules. The wire has the same name as the port.

In example embodiments, some or all of the re-usable program elements may be provided in a programming language that is compiled into an instruction set binary code and executed on a instruction set processors. The instruction set binary code may represent the instructions for the computer's instruction set processor. C/C++ are example languages that are compiled directly to an instruction set binary code, or an executable. The instruction set binary code may also represent instructions for a virtual machine. An interpreter may convert the instruction set binary code for the virtual machine into the instruction set code for the computer's physical instruction set processor. Java is an example of a programming language that is compiled into an instruction set binary code for a virtual machine.

In example embodiments, programming instructions pre-defined in the programming language or programming instructions from Application Programming Interfaces (APIs) may be used to (i) construct and assemble instances of re-usable program elements in the circuit design database; (ii) connect the re-usable program element instances in the circuit design database; (iii) generate parameter values for the re-usable program elements; (iv) initiate synthesis of the circuit design database into a netlist; (v) simulate the circuit design database; (vi) store the simulation outputs; (vii) filter the simulation outputs; (viii) format the simulation outputs; (ix) present the outputs to a user interface; (x) evaluate the simulation outputs for errors; (xi) build a behavioral model of all or a portion of the circuit; (xii) co-simulate the model with the circuit; (xiii) build module re-usable program elements; and (xiv) provide a run-time interface to accept run-time inputs and generate run-time outputs. Examples of pre-defined programming instructions may be variables, constants, pointers, loops, conditional statements, functions, procedures, procedural or functional parameters, classes, or objects. Examples of API programming instructions may be file read/write, network read/write, user interface read/write, and read/write of high level data structures like dynamic arrays and linked lists.

In example embodiments, pre-defined or API programming instructions may be compiled with the various re-usable program elements and instances of the various re-usable program elements into a single instruction-set binary code. The execution of the instruction-set binary code may result in the synthesis of the circuit to a netlist, the simulation of the circuit, the generation of output test vectors from the simulation, the evaluation of output test vectors for correctness, or any combination. The execution of the instruction-set binary code may also result in the co-simulation of a circuit behavioral model with the circuit, the generation of output test vectors from the simulation, the evaluation of the output test vectors for correctness, or any combination.

In example embodiments, the compiler may produce the instruction set codes for the circuit simulation model and the circuit simulator, and may combine the instruction set codes for both into one instruction set code. When executed, the combined circuit simulation model-simulator system may load in under a second.

In example embodiments, the component re-usable program elements may use fast, high-level behavioral descriptions for the simulation model that are bit-accurate and cycle-accurate. Circuit re-usable program element may use small, efficient 2-loop or 3-loop simulation kernels. Circuit re-usable program element may use fast event-based simulation algorithms. The simulation algorithms may be accelerated by splitting component updates among multiple, concurrent instruction set processors. The combination of fast, high-level behavioral models, small efficient simulation kernels, fast event-based simulation algorithms compiled into one instruction set, and multiple, concurrent processors executing the simulation, may allow the combined circuit simulation model-simulator system to execute over one hundred times faster than VHDL/Verilog simulators.

In example embodiments, the component re-usable program element may use deterministic algorithms to quickly assemble equivalent netlist files, may copy a pre-made equivalent netlist from a netlist library locally, or modify a pre-made netlist from a netlist library to form an equivalent netlist and present it locally. The netlist library may be stored on a local storage device or on a networked storage device. Circuit re-usable program element may use deterministic algorithms to quickly create and assemble a top-level netlist file that references the lower-level component netlist files. Some example embodiments may use combinations of the above techniques to provide netlists for each of the circuit components specified in the circuit design database. Because the synthesis methods may use deterministic, assembly techniques, the compiled program executable may synthesize the circuit in under a second.

In example embodiments, some or all of the re-usable program elements may be grouped into a programming library for circuit design. The collection of re-usable program elements form an API for defining a circuit design in the database, synthesizing the circuit database to a netlist, and simulating the circuit database for correctness. Computer program instructions may be used to create instances of circuit, component, port, module, wire, and parameter re-usable program elements to form the database. The instances may contain the methods to synthesize the circuit database to netlist or to simulate it.

In example embodiments, C/C++ classes in a compile-time API library may represent a circuit, component, port, module, wire, and parameter re-usable program elements. An instance of a circuit class, a circuit object, may be created. An instance of a parameters class, a parameter object, may be created to specify 8-bit adders using fast carry-logic, and another instance of parameter class may be created to specify 8-bit adders using slower, but smaller boolean gates. The parameter object specifying the fast adder may be fed to a circuit object's component creation method twice creating two fast, 8-bit adders within the circuit database. The parameter object specifying the slow adders may be fed to the circuit object's component creation method to create one slow, 8-bit adder with the circuit database.

The wire objects on the outputs of the slow adders may be attached to the inputs of the fast adder to connect them and form an adder tree with a fast stage followed by a slow stage. Programming instructions may invoke the circuit object's synthesize method to convert the adder tree into a netlist. Programming instructions may invoke the simulation methods on the circuit object to clock data through the adder tree. A behavioral model of a state machine using conditional if-else statements and variables may control the flow of data through the adder tree by connecting to the enables of the adder components. Programming instructions may generate input test vectors and stimulate the adder tree's inputs by writing the values to the input wire objects of the slow adder. The output wire objects of the adder tree may be queried to probe the simulation outputs. Internal wire objects between the adders may also be probed. Data from the probes may be written to a file, may be written to a user interface, or may be examined by other programming instructions that compare them to expected values, determining if there are any errors, and reporting the error to a file or to a user interface. All of these computer program instructions may be compiled with the circuit API library of re-usable program elements to generate an executable computer program containing data and instruction codes. When run, the executable may synthesize the circuit to a netlist, simulate the circuit, or evaluate the results of simulation and report errors.

In example embodiments, the library may be provided as pre-compiled binary instruction codes for compiling or linking. This is defined as a compile-time library. These binary instruction codes may be selectively inserted into the compiled program instruction codes. These instruction codes may also have associated with them source files describing the public interface to the binary instruction codes in the library. For example, in the C/C++ languages these files are known as header files. These header files may be collected into a library of header files. The header source files may be used during compilation or during linking to instruct the compiler or the linker which binary object codes in the library to include with the compiled binary code of the program instructions specifying the circuits. The combined binary instruction codes may be executed on an instruction set processor directly or through an interpreter.

In example embodiments, the library may be provided as pre-compiled binary object codes for run-time linking. This is defined as a run-time library. The binary instruction codes in the run-time library may be linked at run-time with the compiled instruction codes from the computer program instructions specifying the circuits. The run-time object codes may also have associated with them source files describing the public interface to the run-time instruction codes. For example, in the C/C++ programming languages, these files are known as header files. These header files maybe be collected into a library of header files. The header source files may be used during compilation or during linking to create links between the compiled binary instruction codes of the program instructions and the run-time instruction codes. During run-time, binary instructions from the compiled program instructions and the run-time library, may be executed.

In example embodiments, the library may be provided as source code. This is defined as a source-code library. The source code library may consist of files specifying the interface and other files specifying the implementation in source format. For example, in the C/C++ programming languages, the files specifying the interface are known as header files (.h) and the implementation files are known as source files (.cpp). The source code library may consist of just the implementation files. For example, in the Java programming language, the library consists of only implementation files and the interface is implicitly specified through the implementation files. The source code libraries may be compiled with the computer program instructions specifying the circuits. During compilation, source code in the libraries may be selectively compiled into binary instruction codes, and the program instructions specifying circuits may also be compiled into binary object codes. During linking, the binary instruction codes from the source code library and the binary instruction codes from the program instructions specify circuits, may be combined into one binary instruction code. The combined binary instruction code may be executed on an instruction set processor directly or through an interpreter.

In example embodiments, the library may be provided as a combination of a compile-time library, run-time library, and source-code library. Some re-usable program elements may be defined in source-code, other re-usable program elements may be defined in compile-time libraries, and other re-usable program elements may be defined in run-time libraries.

In example embodiments, the circuit, component, wire, module and parameter re-usable program elements may have the same interface across multiple chip architectures. For example, in an object-oriented C/C++ implementation, the class constructors, method and function calls, and variables may be the same across chip architectures. The simulation model for the component re-usable program elements may be the same across different chip architectures. The implementation netlists may be the same across different chip architectures except for differences in netlist component names. The circuit design may specify a physical device to the circuit synthesis method, which is then forwarded to the component synthesis methods. The component instances automatically create equivalent netlists using component netlist libraries specific to the physical device, and the circuit instance assembles a top-level netlist referencing the component netlists. The methods and data for specifying circuits are generic, and the circuit database represents a generic circuit that can be implemented across multiple devices. Some components may have simulations and implementations that are device specific. For example, some physical devices may have custom Digital Signal Processing blocks that may be used by some components. If changes in physical device specification result in changes to component simulation models or result in structural changes to component implementation, errors or warnings may be reported to the user interface. In embodiments where the simulation model and implementation structure remain the same across different physical devices the same programming instructions defining the circuit database, the input test vectors, the simulation, the output vector evaluation, and the model construction remain the same. This allows a design and test specification to be quickly re-used across different architectures in example embodiments.

In example embodiments, the various re-usable program elements in the library may have a public interface coupled with private implementations. In example embodiments, the various re-usable program elements in the library may have a public interface coupled with public implementations.

Since the circuit design is structured as a computer program and library, the circuit design database can be compiled using a computer program compiler to generate an executable that can be used for synthesis and simulation. In example embodiments, the library and API can be used to deterministically specify the circuit design elements to be used. As a result, in these embodiments, compilation and synthesis can be performed quickly. Circuit synthesis functionality and circuit simulation functionality may be embedded in the API and library as part of the re-usable program elements. For example, the synthesis and simulation functionality may be embedded directly into the circuit design database. The circuit designer can obtain information from synthesis, simulation and modeling and then adjust the circuit design as needed. Since compilation can be achieved quickly, this process may be repeated many times in the design process without imposing significant delays. In some embodiments, the executable does not perform non-deterministic search and optimization for synthesis. Rather, the API and library provide design alternatives that can be selected to meet the needs of the particular design. The circuit designer is able to perform repeated synthesis, simulation and modeling as desired without imposing delays for non-deterministic processing during each iteration. Since the feedback is more immediate, the circuit designer can incrementally make adjustments to the circuit design database through the API and library.

This is an example embodiment only. Other examples may use other methods for executing the computer program instructions based on the specified circuit design and library. For example, some embodiments may use interpretation to execute the computer program instructions instead of compilation.

In example embodiments, the use of re-usable program elements to specify circuit elements enables efficient circuit design. The use of parameters and methods associated with the re-usable program element allows a library to be used to quickly define different instances of a circuit element in the overall circuit design. Re-usable program elements may be included in the library for types of components that share common characteristics, but may have different implementation options for specific instances of those components in the circuit design. In some example embodiments, an object-oriented programming language may be used to define classes of objects with specified characteristics. Sub-classes may be defined that inherit characteristics from the parent classes. Specific instances of the objects may be instantiated with specific structures and other implementation options to represent a particular component in the circuit. The implementation options specified for a particular object may be used to generate a particular netlist for the circuit component during synthesis. State information may also be associated with the object and may be used for simulation. The functional behavior of the object may also be used for modeling and testing the functional behavior of the circuit component. As a result, an instance of a particular re-usable program element may be used to define a circuit component along with all of the information needed for synthesis, simulation and modeling of that circuit component. A circuit design may be composed from these elements using computer program instructions that may be compiled or interpreted together with the library for execution. The executable code can then perform synthesis to generate a netlist for the circuit design, simulation of the behavior of the particular circuit and modeling of the circuit for testing the functional behavior of the circuit.

In one example embodiment, the main constructs for specifying a circuit are re-usable program elements that represent basic, low-level circuit components, like asynchronous logic and asynchronous logic circuit elements, and interconnect, like a wire element for connecting components in a circuit or to port 10 for external interfaces. A library of circuit components may be provided. Example circuit components may include:
Boolean Logic Gates (AND, OR, XOR, NOT) Asynchronous Logic
Flip-Flops (D-Type, Registers, Shift Registers) Synchronous Logic
Memories (Distributed-Fine-Grained, Block Memories) Storage
Clocks (Clock Buffers, Delay Locked-Loops, Frequency Controllers, Phase Shifters)
Routing Buffers (Hi-Drive, Low Latency Buffers)
Input/Output (Registered IO, Unregistered IO, Tri-State IO, Double Data-Rate IO)
Vcc, Gnd (Zero and One sources)

In example embodiments, functionally higher-level modules or components may be built from these lower-level components. These modules may be included as another API library that interfaces with the system or may be built into the base API library. Examples include but are not limited to:

Counters
Multiplexers
Decoders
Floating-Point Add, Subtract, Multiply, Divide
State Machines
Comparators
Digital Switches
Integer Add, Subtract, Multiply, Divide

In example embodiments, these modules/components in turn may be used to build functionally higher-level modules. These functionally higher-level circuit elements may also be implemented as components and included in the base API library. Examples include but are not limited to:

FIR Filters
Complex Arithmetic Operators
Buses
IO interfaces
IIR Filters
Processors
Bus Interfaces

In example embodiments, this process of higher-level library construction can be used to continually expand the library, or create new libraries, to enable efficient design, synthesis and simulation of more complex circuits. The API and libraries may be provided to a circuit designer as part of an automated design tool that enables the circuit designer to use computer program instructions to specify a circuit and then compile it into an executable. The automated design tool may also include utilities, like modules, that allow the circuit designer to expand the API and library to include additional circuit design components. The automated design tool may also include pre-defined netlists.

In some embodiments, synthesis is performed by generating the netlist for each circuit component (represented by a re-usable program element) that is included in the circuit design. Then the netlist for the overall circuit design is generated from the netlists for each component. Example netlist formats may be EDIF, structured VHDL, and structured Verilog. The computer program instructions for synthesis are included in the library and are compiled into the executable program that is generated from the computer program instructions representing the overall circuit design together with the re-usable program elements in the library that represent individual circuit components. In example embodiments, synthesis may be carried out based on computer program instructions included by the circuit designer or through run-time options that can be selected when the executable is run or though a user interface at run-time. In example embodiments, the information and instructions needed for synthesis are embedded into the API library, are specified or selected by the circuit designer through the API, and are automatically embedded in the executable when it is compiled. In some embodiments, separate non-deterministic algorithms for synthesis are not required. In other embodiments, optimization may be selectively included for some circuit components or for the overall circuit design. However, in example embodiments, this optimization can be disabled to allow synthesis to run efficiently and enable the circuit designer to iterate on the design quickly without imposing additional delay for optimization each time synthesis is desired.

In some embodiments, simulation is performed by setting input values and state information for the re-usable program elements in the circuit design. In example embodiments, the re-usable program elements encapsulate computer program instructions and parameters specifying the functional behavior and implementation of a circuit component. In example embodiments, state information can also be associated with each instance of a re-usable program element to represent the state of a particular circuit component. Methods associated with each re-usable program element may be used to change the inputs or state of each circuit component and, for synchronous logic elements, to advance internal or external clock cycles to change the state of the component. The state information and methods associated with each re-usable program element may be used to perform event driven simulation of the circuit or portions of the circuit. The computer program instructions for simulation are included in the library and are compiled into the executable program that is generated from the computer program instructions representing the overall circuit design together with the re-usable program elements in the library that represent individual circuit components. In example embodiments, simulation may be carried out based on computer program instructions included by the circuit designer or through run-time options that can be selected when the executable is run or through a user interface at run time.

In some embodiments, the simulation inputs may be explicitly specified in the computer program instructions and therefore are explicitly specified in the compiled binary code. Algorithms for generating the inputs may also be specified in the computer program instructions and therefore also specified in the compiled executable. At fun time, the algorithm in the executable may generate the test inputs for the circuit simulation. The input test vectors may also reside in a separate file. At run-time, the executable may read the file containing the test vectors and apply them to the circuit simulation. Any combination of these methods may also be used to generate the test vectors.

In some embodiments, the simulation outputs may be written to a file. In other embodiments, evaluation algorithms may be specified in the computer program instructions and therefore also specified in the compiled binary code. The evaluation algorithms can examine the simulation output test vectors keeping track of the errors and reporting only the errors. The errors may be reported to a file or to a run-time interface.

In some embodiments, a model of the circuit may be specified using built-in program instructions or calls from other APIs. A model may be composed of input variables, internal variables, output variables, and programming instructions to convert data between the variables. A model is a behavioral description that may not translate directly into a circuit netlist or may not be representable in the circuit database. The behavioral description may not be bit-accurate or may not be cycle-accurate. The behavioral description may describe the circuit's operation at a high-level. The model may generate values on its inputs or outputs, or may generate values on its internal computational nodes. Those values may be integer, floating-point, binary, or other data-type values. Those values may be read by the wire re-usable program elements. The wire re-usable program elements may pass those values to component re-usable program elements in the circuit database. Similarly, the wire re-usable program elements may write their values to integer, floating-point, binary, or other data structures in the behavioral model. Using the wires as an interface, re-usable program elements in the circuit design database may co-simulate with the model's behavioral description.

In some embodiments, the circuit may be represented by circuit re-usable program elements containing the component, wire, port, module, and parameter re-usable program elements, and the model may be represented as separate program instructions. For example, in object oriented languages like C/C++, the circuit may be represented as a class that is instantiated as an object. All components, wires, and parameters may be added to the object through its interface. In this example, the model may be described as programming code outside of the object. The circuit may be easily identified as the object, while the model may be identified as programming instructions outside the object.

In some embodiments, the model and the circuit may be compiled into the same binary code instruction set, and may be optimized to co-simulate quickly during execution.

Example embodiments may incorporate functionality for synthesis, simulation and modeling into a library representing circuit design components. An executable may be compiled with this functionality automatically embedded through the compilation process. Then, run-time options or user interface options may be selected to output results of synthesis, simulation and/or modeling using the same circuit design database. In some embodiments, the library may include computer program instructions and APIs used to enable synthesis, simulation and/or modeling, but the functionality to be compiled into the executable may be selected to generate versions of the executable that only include a subset of the overall functionality supported by the library. For example, in some embodiments, the computer program instructions for modeling based on functional behavior may be included without the additional information required for synthesis or simulation. In some embodiments, the overall circuit design may not specify all of the implementation options for each circuit component needed for synthesis, but may specify the functional behavior for each component. This may be compiled for modeling and verification of functional behavior. The verified functional design may then serve as the specification for the particular circuit implementation that is being designed. The implementation options for particular circuit elements may then be added iteratively and a new executable may be compiled and verified. In this way, the circuit design database may be used to bridge the design process between functional verification and synthesis/simulation of a particular circuit design. Implementation options may be specified for some of the components and then the design can be recompiled and tested. Portions of the circuit may also be synthesized and simulated where sufficient implementation information has been specified. The circuit design database may include a hybrid design with many elements specified only at the functional behavior level and other elements having specific structure and implementation options specified.

In some example embodiments, a computer system is provided with one or more processors programmed to perform one or more of the above aspects of the invention. In some example embodiments, a computer readable medium is provided with executable instructions for performing one or more of the above aspects of the invention.

It is understood that each of the above aspects of the invention may be used alone or in combination with other aspects of the invention described above or in the description below. A more complete understanding of the present invention and other aspects and advantages thereof will be gained from a consideration of the following description of example embodiments read in conjunction with the accompanying drawings provided herein.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing example steps in creating and verifying a circuit model;

FIG. 1B is a block diagram showing example steps in interfacing a circuit design database to a model, synthesizing it to a netlist, and verifying its functionality using the same steps, methods, and data shown in FIG. 1A;

FIG. 1C is a block diagram showing example steps in synthesizing a circuit design database and verifying its functionality using the same steps, methods, and data shown in FIGS. 1A and 1B;

FIG. 1D is a block diagram showing example data elements in testing a model, a model coupled to a circuit design database, and circuit design database shown in FIGS. 1A-1C;

FIG. 2A is a block diagram showing the data and methods of a circuit re-usable program element according to an example embodiment of the invention;

FIG. 2B is a flow chart illustrating a method for converting a circuit design database to a netlist according to an example embodiment of the invention;

FIG. 2C is a flow chart illustrating an algorithm for event-based simulation according to an example embodiment of the invention;

FIG. 2D is an example circuit diagram showing ordering for asynchronous components for ordered simulation and showing maxCount for unordered simulation;

FIG. 2E is a block diagram showing the asynchronous and synchronous sub-loops for a 2-loop simulation kernel according to an example embodiment of the invention;

FIG. 2F is a block diagram showing the asynchronous and synchronous sub-loops for a 3-loop simulation kernel according to an example embodiment of the invention;

FIG. 2G is a block diagram showing the algorithm for unordered simulation using the 2-loop simulation kernel according to an example embodiment of the invention;

FIG. 2H is a block diagram showing the algorithm for ordered simulation using the 2-loop simulation kernel according to an example embodiment of the invention;

FIG. 2I is a block diagram showing the algorithm for event-based simulation using the 2-loop simulation kernel according to an example embodiment of the invention;

FIG. 3A is a block diagram showing the data and methods of a component re-usable program element according to an example embodiment of the invention;

FIG. 3B is a block diagram showing the wire re-usable program elements attached to the component pins, and the GetWire and SetWire methods associated with those wires and the component pins according to an example embodiment of the invention;

FIG. 4 is a block diagram showing the data and methods of a port re-usable program element according to an example embodiment of the invention;

FIG. 5 is a block diagram showing the data and methods of a wire re-usable program element according to an example embodiment of the invention;

FIG. 6 is a block diagram showing the data and methods of a parameter re-usable program element according to an example embodiment of the invention;

FIG. 7 is a block diagram showing the data and methods of a module re-usable program element according to an example embodiment of the invention;

FIG. 8A is a block diagram showing the circuit application programming interface composed of various re-usable program elements which are instantiated using circuit programming instructions according to an example embodiment of the invention;

FIG. 8B is a block diagram showing a more detailed view of circuit application programming interface creating circuit database with ports, components, and wires, and the circuit database interfacing with a circuit model and test programming instructions according to an example embodiment of the invention;

FIG. 8C is a block diagram showing a circuit API in compile-time library form getting compiled with programming instructions, including circuit programming instructions referencing circuit API, into compiled instruction set and data according to an example embodiment of the invention;

FIG. 8D is a block diagram showing a circuit API used to create circuit database and simulate circuit database with programming instructions, and showing how programming instructions fit into steps, methods, and data of example circuit design shown in FIGS. 1A-1D according to an example embodiment of the invention;

FIG. 8E is a block diagram showing a circuit API used to create circuit database and synthesize circuit database with programming instructions, and showing how programming instructions fit into steps, methods, and data of example circuit design shown in FIGS. 1A-1D according to an example embodiment of the invention;

FIG. 9 is a block diagram showing simulation algorithms in a 2-loop kernel split among multiple processors/threads operating concurrently according to an example embodiment of the invention;

FIG. 10 is a block diagram showing a computer system with multiple processors, coupled with memory, storage, a user interface, and peripherals using a communications network according to an example embodiment of the invention;

FIG. 11A is a block diagram showing the data of a path re-usable program element according to an example embodiment of the invention;

FIG. 11B is an example circuit showing the elements of a path re-usable program element according to an example embodiment of the invention;

Table 1 shows a base-set of component building blocks for circuit construction and their mapping to fast, equivalent, high-level software simulation models according to an example embodiment of the invention. Example code in C/C++ is shown for the models according to an example embodiment of the invention.

### DETAILED DESCRIPTION

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

### Circuit Design Processes

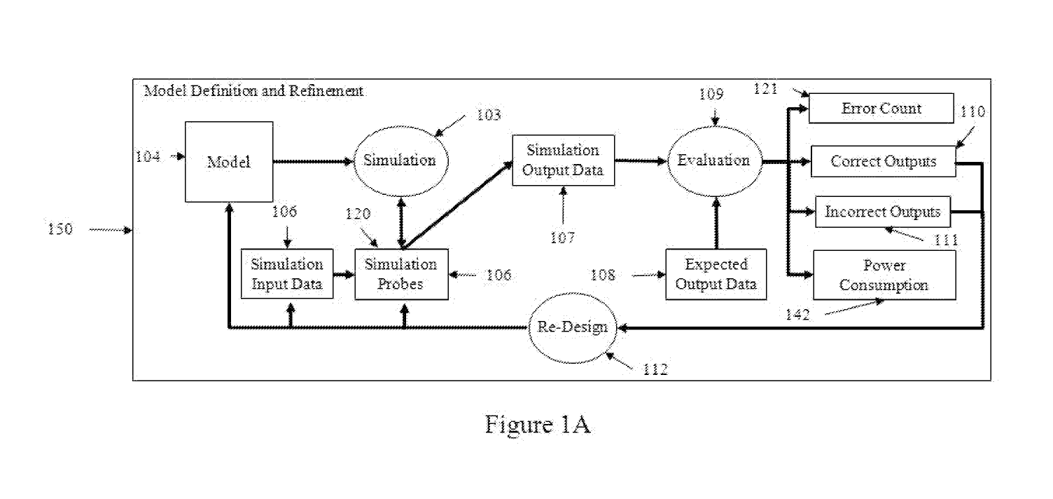

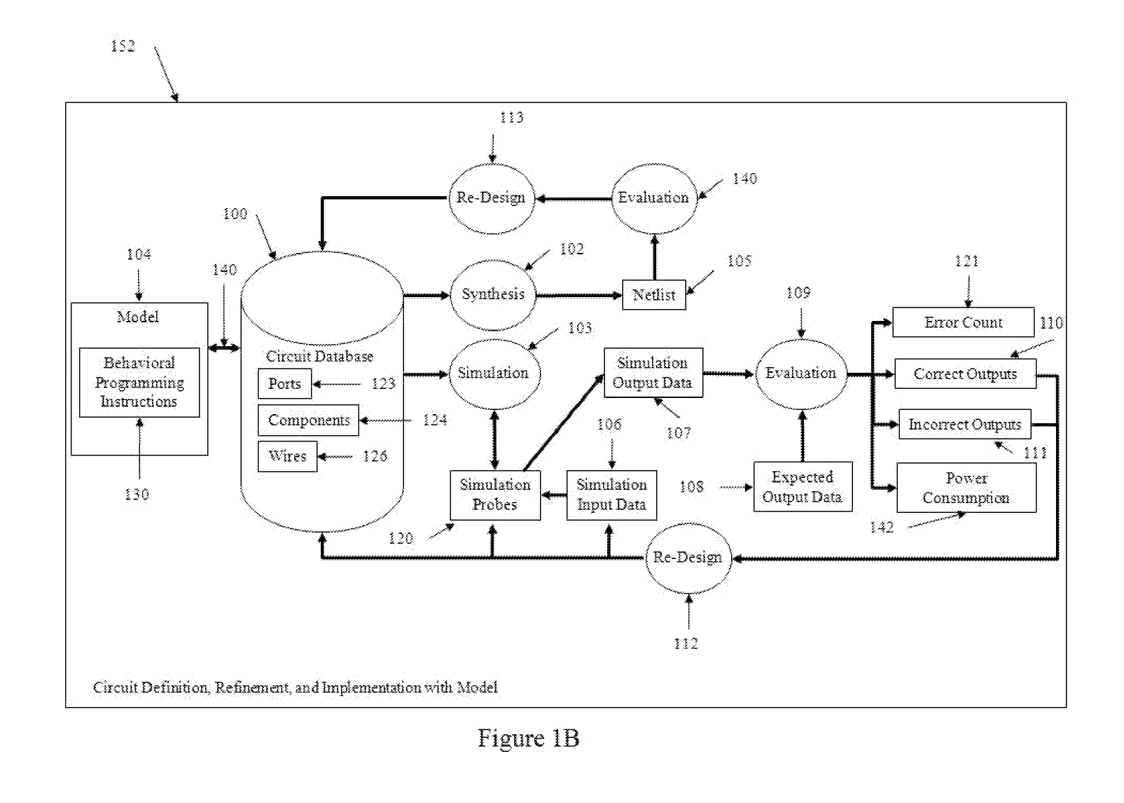

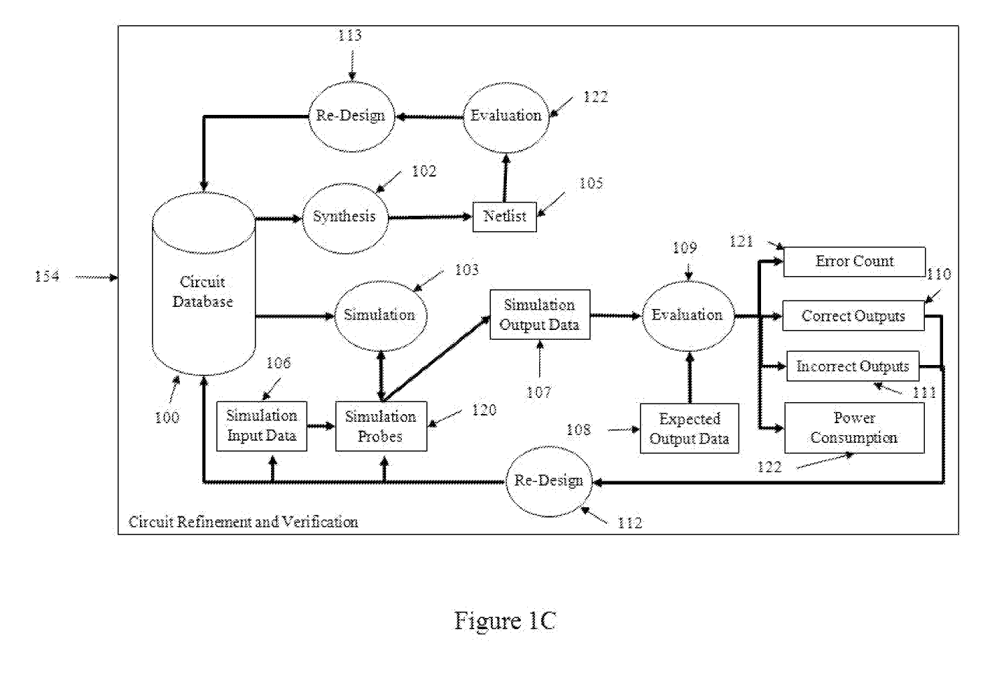

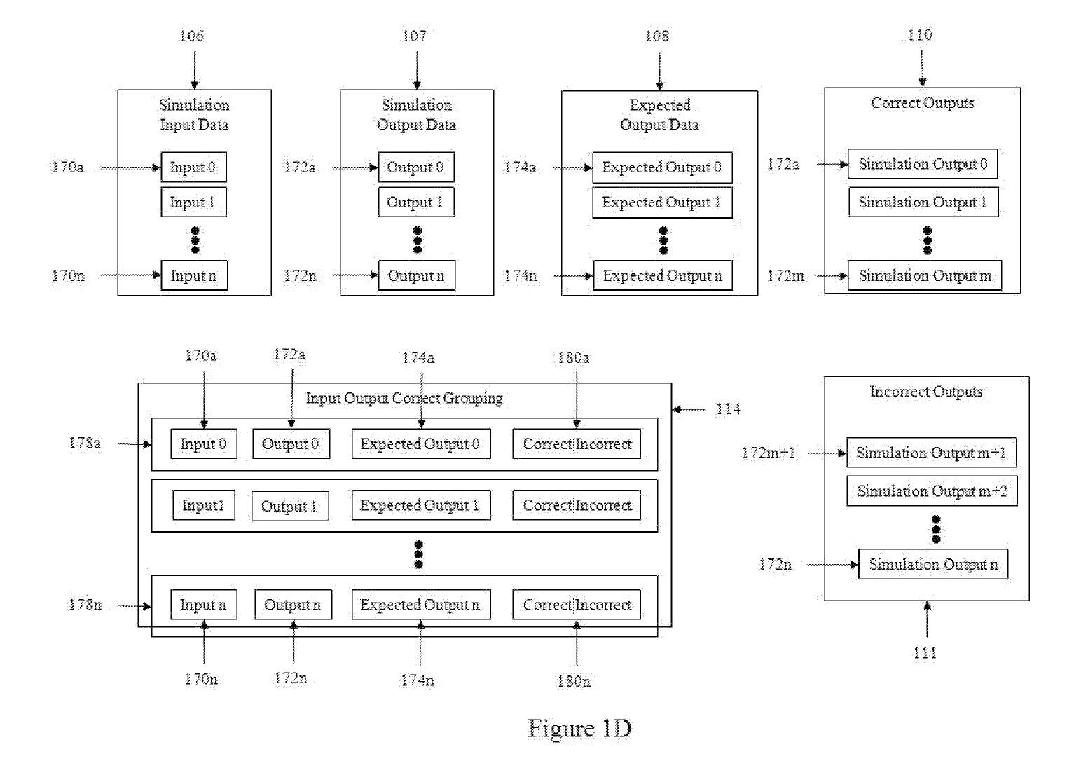

FIGS. 1A-1D show the example elements and processes of designing a circuit. A circuit database 100 is composed of ports 123, components 124, and wires 126. Ports 123 describe the input, output, and bi-directional input/output points in the circuit. Components 124 describe circuit building blocks that implement the functions. Wires 126 describe the connection between components 124, and ports 123. Those connections describe the data flow between components 124, and between components 124 and ports 123.

In designing a circuit, there are three primary processes: synthesis 102, simulation 103, and modeling 104.

Synthesis 102 is a process by which the circuit database is converted into a netlist 105. In example embodiments, a netlist may be in the EDIF, structured VHDL, or structured Verilog formats. In example embodiments, the netlist may be in a human readable form, like ASCII, while in other embodiments the net list may be in a binary format. In example embodiments, netlist 105 may be defined in a single file or it may be defined in multiple netlist files. Netlist 105 is a logical description of the circuit, though it may also contain initial state information, some physical location information, and/or timing requirements. It lists and describes the various ports 123, components 124, and wires 126 in the circuit. It describes the connections between ports 123 and wires 126, and ports 123 and components 124. It also describes the sinks and source connections for each wire 126. Sinks and sources may be ports 123 and/or components 124. Upon examining netlist 105, a circuit-designer may engage in a re-design 113 of the circuit database 100. In example embodiments, re-design 113 may occur to reduce size, reduce latency, or improve speed.

Simulation 103 is a process where the circuit described in the design database 100 is tested. Input data 106 is fed to a functional representation of circuit database 100. Input data 106 may drive input or bi-directional input/output ports 123, inputs or bi-directional input/outputs of components 124, wires 126, or any combination using simulation probes 120. Data is calculated and propagated through the functional representation. Output data 107 is a collection of data points in the circuit resulting from stimulus input data 106 and calculations through the functional representation. Output data 107 is obtained through simulation probes 120, and may represent streams of data on ports 123, components 124, or wires 126, or any combination.

Simulation output data 107 may be tested for correctness through evaluation 109. Evaluation 109 compares elements 172a-172n (FIG. 1D) in simulation output data 107 with corresponding elements 174a-174n in expected data 108. If a data element 172 matches a corresponding data element 174, data element 172 is labeled correct 180 and/or placed in correct list 110. If a data element 172 does not match a corresponding data element 174, data element 172 is labeled incorrect 180 or placed in incorrect list 111. For some data, a match may be an exact match. For example an exact bit-for-bit binary match. For some data, a match may be correct within a certain error. For example, if an error difference of 0.01 is specified, and if the difference between output data element 172 and corresponding expected data element 174 is less than or equal to 0.01 then a match is declared and output data element 172 is labeled correct and/or placed in list 110, and if the difference between output data element 172 and corresponding expected data element 174 is greater than 0.01 then a mismatch/error is declared and data element 172 is labeled incorrect and/or placed in list 111. Evaluation 109 may report a count of the errors 121.

Input 170a, output 172a, expected output 174a, and correctness label 180a together form group 178a. Each group 178 represents a single point in the test space. Groups 178a-178n represent a collection of data points in the test space. They may represent a sub-sample of the test space, or they may represent the complete test space. The number of groups 178 in input-output-correct grouping 114 is a measure of the breadth of the test coverage. Because elements 170, 172, 174, and 180 are grouped into elements 178, list 110 and list 111 also reference inputs 170 and expected outputs 174 by association. A single element in data 170a-170n, 172a-172n, 174a-174n, may represent a single variable or it may represent multiple variables.

Upon investigation of incorrect data 111, the circuit designer may re-design 112 circuit database 100 to fix the problem. The circuit designer may change simulation input data 106, may change simulation probes 120, and may change expected output data 108 to more easily identify the problem in circuit database 100 on the next iteration of simulation 103.

Simulation input data 106 or expected output data 108 may be in the form of explicit data. They may also be in the form of algorithms that generate the data. In an example embodiment, simulation input data 106 or expected data 108 may be files with pre-generated data that are read during simulation. In another example embodiment, input data 106 or expected data 108 may be programming instructions representing an algorithm that generate the data during simulation.

Model 104 in FIG. 1A represents an alternative representation for circuit database 100 in FIG. 1C. Model 104 in FIG. 1A is functionally equivalent to circuit database 100 in FIG. 1C. Model 104 is composed of behavioral programming instructions 130 that mimic the functionality of ports 120, components 124, and wires 126 in circuit database 100. Model 104's functionality may be an exact match to the functionality in circuit database 100 or its functionality may be an approximation to the functionality in circuit database 100. An exact match may mean that on every clock cycle model 104 produces exactly the same binary codes on its outputs as the circuit database 100. Model 104 may use high-level functional descriptions to specify the functionality Model 104 may have a smaller description than circuit database 100, and may have a description that is easier to modify than circuit database 100 so that the circuit designer can more easily and quickly compare and evaluate design trade-offs, and make design changes. Behavioral programming instructions 130 may simulate or may synthesize. Behavioral programming instructions 130 may not simulate or may not synthesize. Model 104 may be designed to evaluate functionality, area, speed, latency, power, or any combination of these.

Model 104 may be designed first and/or without circuit database 100 as is represented by stage 150 in FIG. 1A. It may be simulated 103 using simulation probes 120 and simulation input data 106, producing simulation output data 107. Simulation output data 107 may be evaluated 109 for correct functionality by comparing it against expected data 108 and then labeled correct 110 or incorrect 111. Upon evaluation of incorrect data 111, the circuit designer may re-design 112 the model to fix the problems, or may modify simulation probes 120 and/or simulation input data 106 and then re-simulate 103 to more closely identify the problem. Evaluation 109 may analyze simulation output data 107 and report error count 121.

Once model 104 in stage 150 is defined and refined to the circuit designers requirements, model 104 itself can be used as a specification for implementation of database 100. A separate specification may not need to be written. Behavioral programming elements 130 may be converted into functionally equivalent re-usable program elements representing ports 123, components 124, and wires 126, resulting in stage 152 (FIG. 1B) where the combination of model 104 and circuit database 100 represent the full functionality. Stage 152 is an intermediate design stage where part of the overall functionality is represented in the model 104 and part of the functionality is represented in circuit database 100. If in stage 152, model 104 is an exact functional match for the required functionality of circuit database 100, then simulation 103, simulation input data 106, simulation probes 120, expected output data 108, and evaluation 109 may be used without modification from stage 150 to verify the model 104 circuit database 100 combination. If in stage 152, model 104 is a close functional match for the required functionality of circuit database 100, then simulation 103, simulation input data 106, simulation probes 120, expected output data 108, and evaluation 109 may be modified from stage 150 to verify the model 104 circuit database 100 combination. Stage 152 allows the circuit designer to make step-by-step conversions from behavioral programming instructions 130 in model 104 to re-usable program elements in circuit database 100, and use the existing test infrastructure in simulation 103, simulation input data 106, simulation probes 123, expected output data 108, and evaluation 109, to verify that the functionality of the converted model 104 circuit database 100 system is equivalent and correct. Using this approach, if errors are detected in simulation, the circuit designer can isolate them to the changes made in the previous step. With a small number of test data groups 178a-178n that sample the whole test space, simulation 103 may be run in seconds or less, enabling the circuit designer to quickly evaluate whether changes from the previous modification were correct and maintained functional equivalency. At each conversion step in stage 152, the circuit designer may synthesize 102 the circuit design 100 into netlist 105. The circuit designer may then examine netlist 105 for latency, area, component implementation, or any combination. If the implementation in netlist 105 does not meet requirements, the circuit designer may re-design 113 circuit database 100 to modify the circuit implementation or change component parameters to produce alternative implementations.

After circuit database 100 in stage 152 has been completely converted into the full required functionality, the system arrives at stage 154 in FIG. 1C. Simulation 103, simulation input data 106, simulation probes 120, expected output data 108, and evaluation 109 in stage 154 may be used without modification from stages 150 and 152, and if model 104 is an exact functional match for circuit database 100, they may be used without modification from stages 150 and 152. If model 104 is a close functional match for circuit database 100, they may be modified from stage 150. Synthesis 102 in stage 154 may be run iteratively to generate netlist 105. The circuit designer can examine the netlist 105 and re-design 113 circuit database 100 if it does not meet requirements. Once circuit database 100 has been fully-verified and netlist 105 meets all requirements, netlist 105 represents the full, correct design and can be passed to physical design tools to imp, place, route the design onto a physical device.

### Re-Usable Program Elements for Circuit Design

A re-usable program element may include variables and/or programming instructions assembled into methods, procedures, functions, operators, or other functional assemblies, hereafter referred to generally as methods. Methods transform values in the variables, and may provide read and write access to the variables. Some variables may have unchanging, pre-defined values. Some variables may have changing values, and these variables may or may not have initial values. In an example embodiment in the C++ language, re-usable program elements may be implemented as a class.

Multiple re-usable program elements may be created to perform more complex functionality, with each re-usable program element functionally representing a portion of a solution, and the collection of re-usable program elements representing the a whole solution. The collection of re-usable program elements may be placed into a library, forming an Application Programming Interface (API). The re-usable program elements in the API may include source code, binary instruction codes formatted into compile-time libraries, binary instruction codes formatted into run-time libraries, and/or a combination of these.

Programming instructions may be made that reference one or more of the re-usable program elements in the API. Those programming instructions may be part of other programming instructions that use pre-defined constructs in the language, or reference other APIs. In an example embodiment in the C++ programming language, examples of pre-defined constructs are for-loops, if-else conditional statements, and variable declarations. Other example APIs might include methods and data for file access, network access, user interface access, or collections of high-level data structures, like dynamic arrays, or data structures for complex math. References to the API may create one or more instances of each of the re-usable program elements.

Each instance of a particular re-usable program element has the same variables and the same methods, but the values for the variables may, for each instance, change independently at run-time. Each instance therefore represents a specific run-time implementation of each re-usable program element. Multiple instances of each re-usable program elements may be created through programming instructions. The instances may be coupled by exchanging data between them. The collection of instances may represent a particular solution.

In an example embodiment, the re-usable program elements may be customized to represent the functionality of a circuit, and the design system around circuit for implementing it to a netlist and simulating its functionality, amongst other design system functions. In an example embodiment using the C++ programming language, the re-usable program elements may be implemented as classes. Some classes may implement functionality of components used as base functional building blocks of a circuit. Some classes may implement functionality for collecting the parameters for implementing and simulating the components, the circuit's ports, or high-level modules. A class may implement functionality for connecting components, ports, and modules. A class may implement the functionality for the circuit's inputs and outputs (IOs). Finally, a class may implement the data and methods for a circuit. The circuit class may provide functionality for assembling the components, wires, ports, parameters, and modules into a circuit database. It may provide functionality for synthesizing the circuit into a netlist. It may provide functionality for simulating the circuit database. And it may provide functionality for co-simulating the circuit with a behavioral model for other circuits or co-simulating it with other functionality.

In the example embodiment, the C++ classes may be collected into a library, which may include source code, binary instruction codes formatted into compile-time libraries, and/or binary instruction codes formatted into run-time libraries.

In the example embodiment, programming instructions may instantiate classes into objects representing circuits, components, parameters, wires, and modules that can be assembled together to represent a particular circuit. That collection of objects represents the circuit database. Those objects may have the functionality to synthesize the circuit database into a functionally equivalent netlist file. The objects may have functionality for simulating the circuit database, co-simulating the circuit database with models for other circuits, and/or co-simulating the circuit database with other functionality. Programming instructions may be used to generate test vectors to stimulate the circuit's simulation. Other programming instructions may be used to probe the circuit and display the results on a user-interface, or store the results to a file. Other programming instructions may generate expected output vectors and compare them with the probed output vectors, reporting the input and output vectors that do not match the expected output vectors, and reporting the number of mismatches, or the error count.

### Component Re-Usable Program Elements

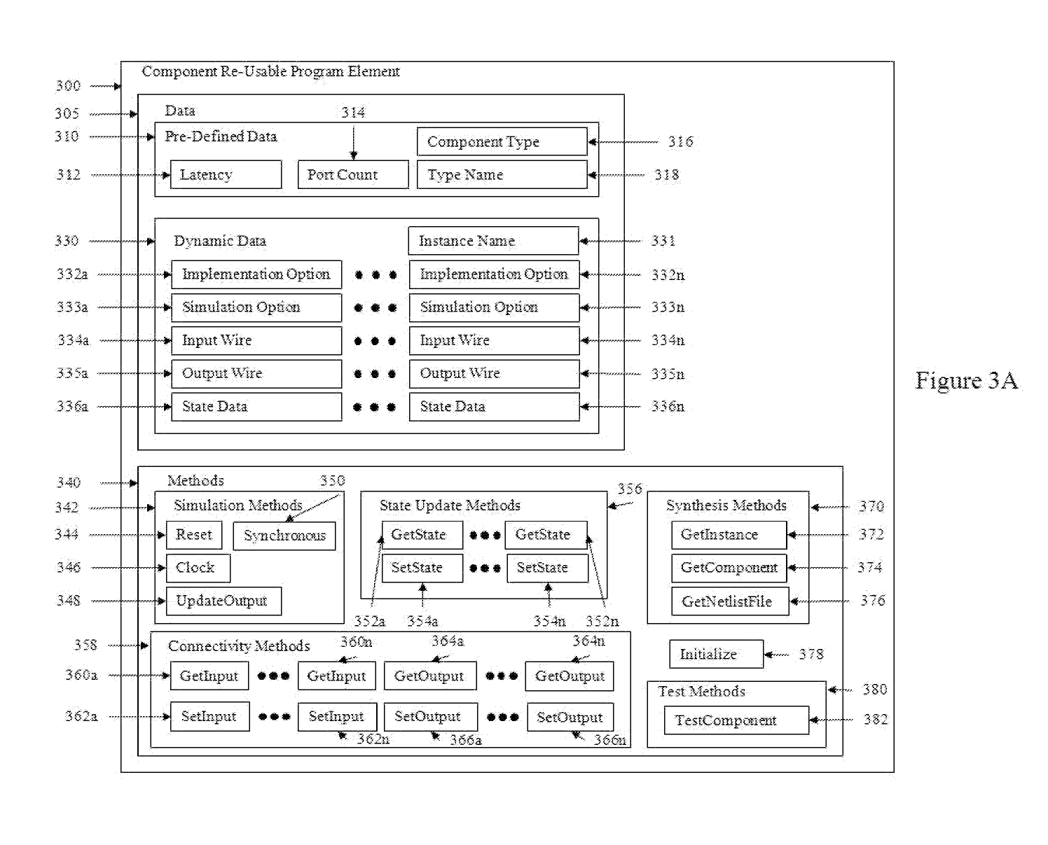

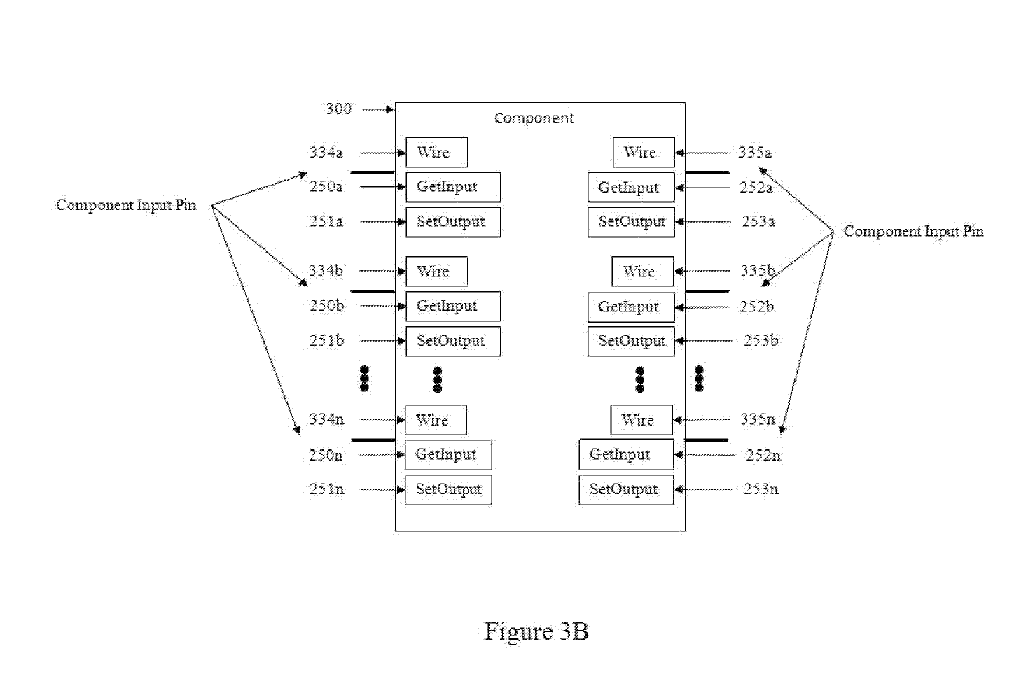

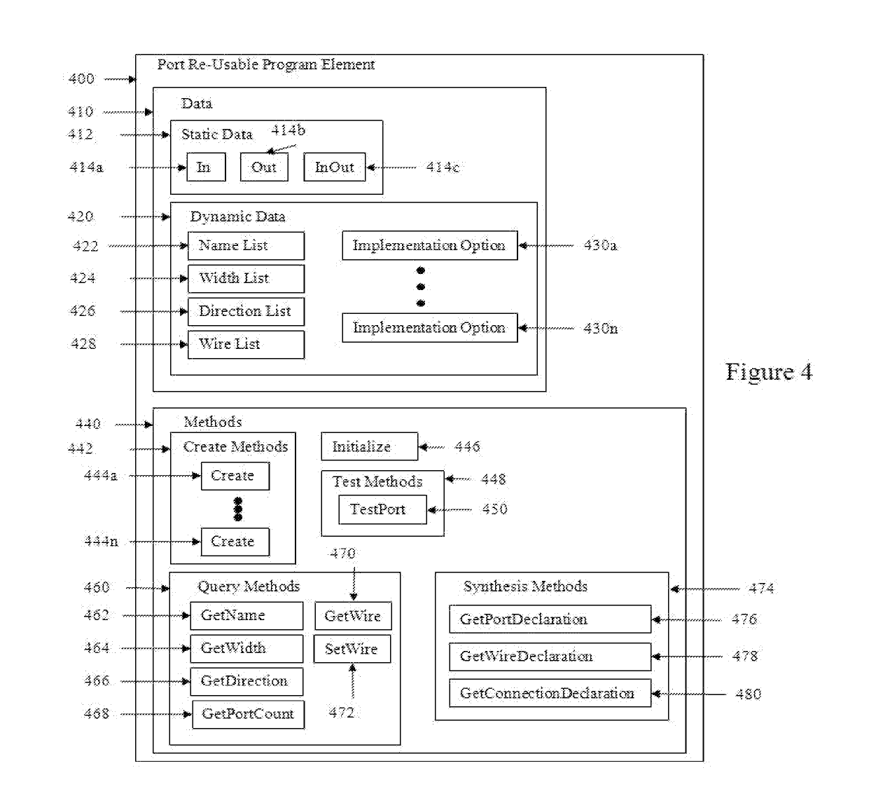

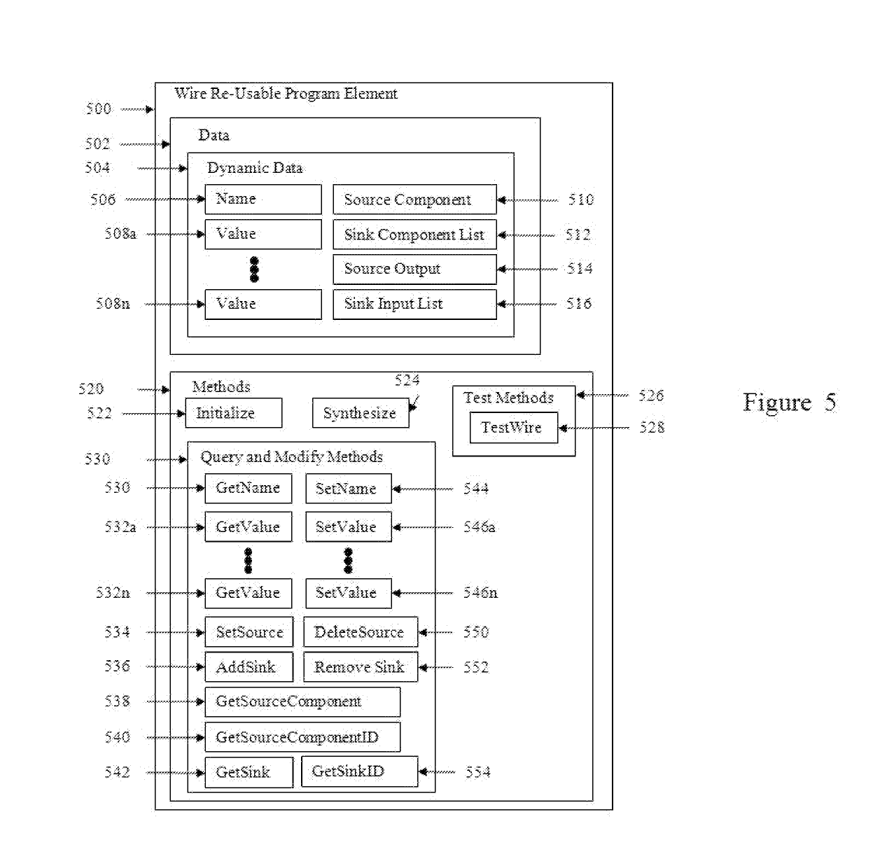

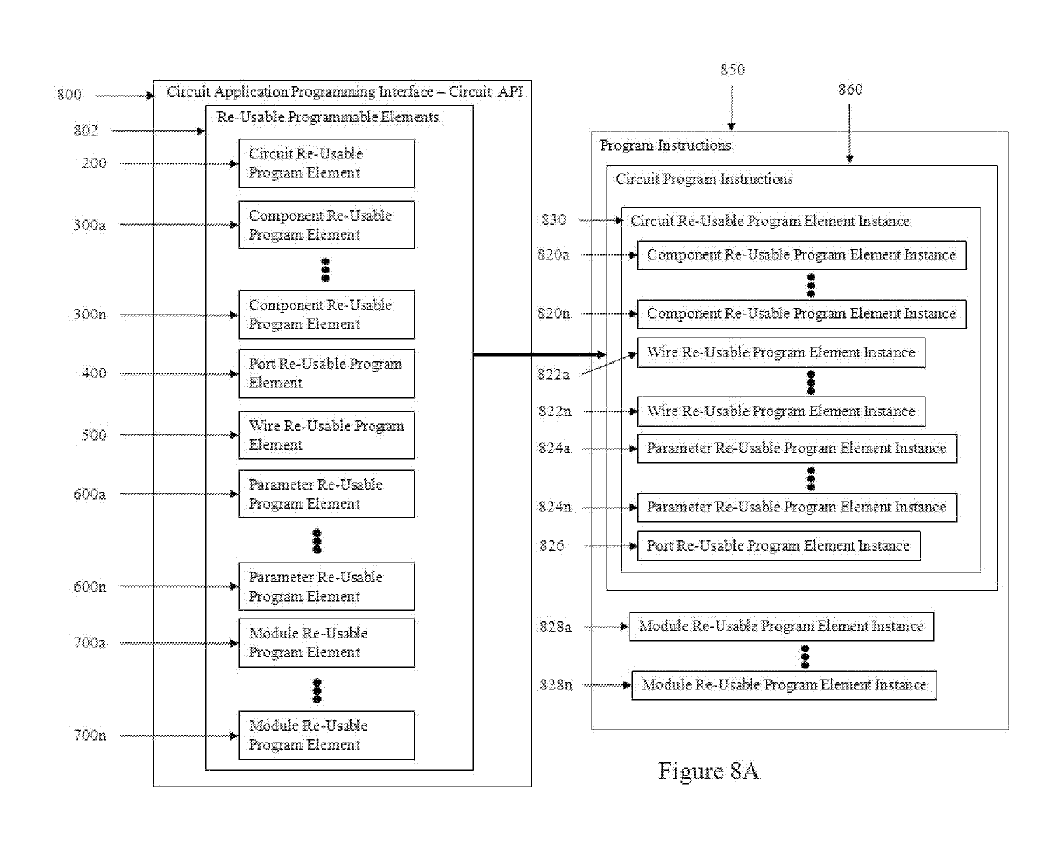

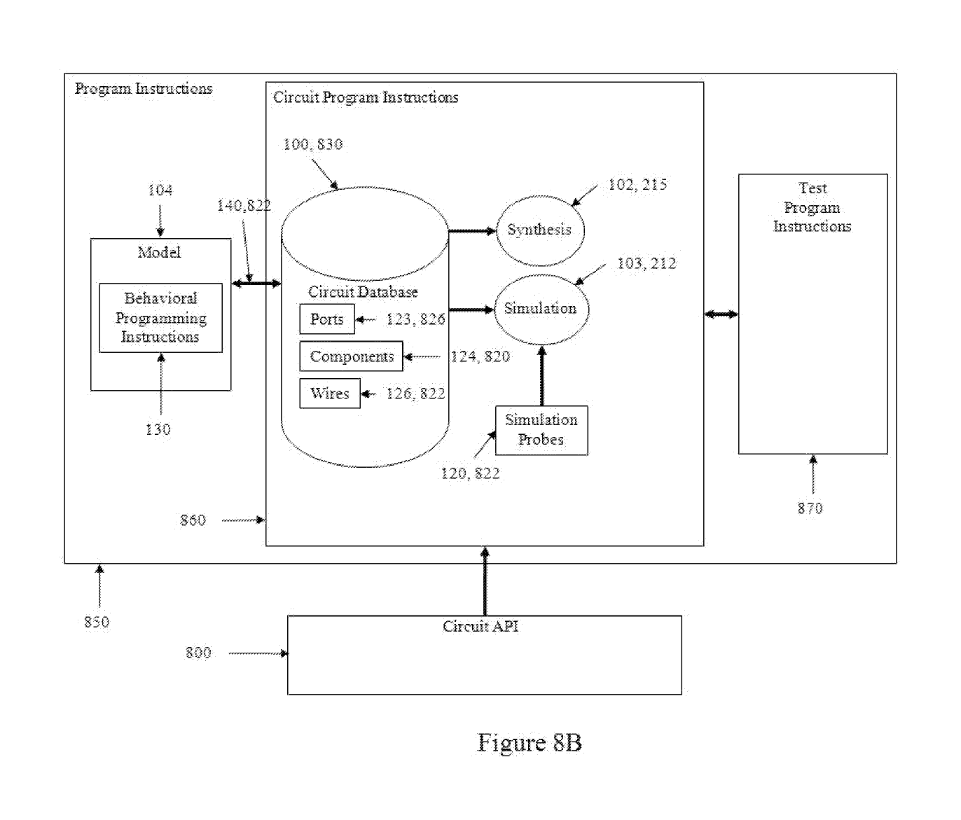

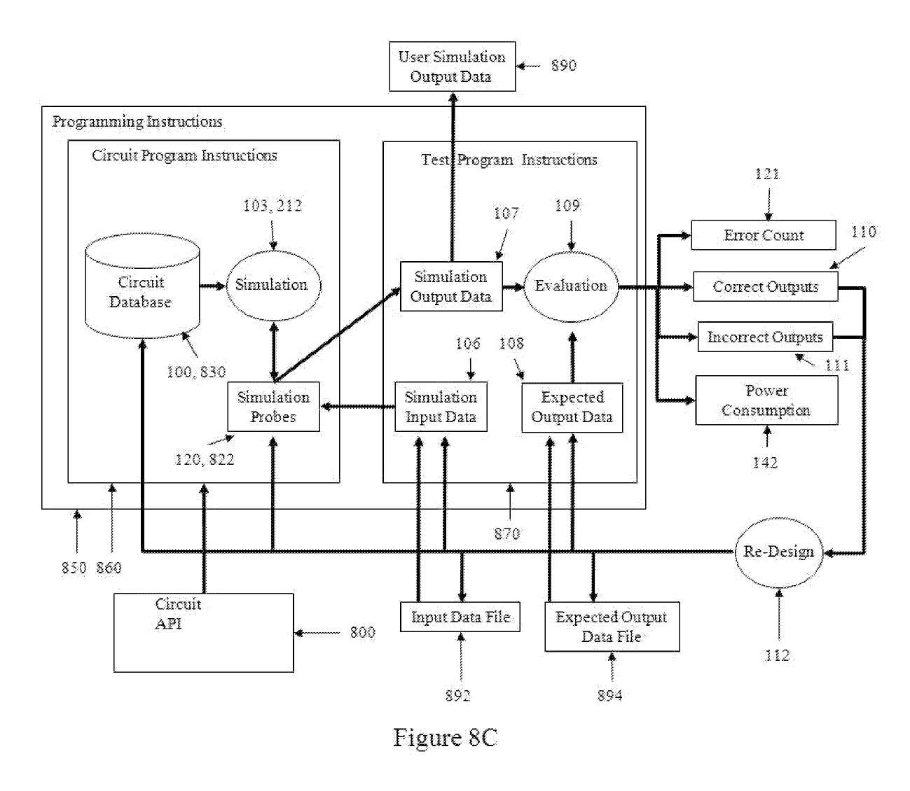

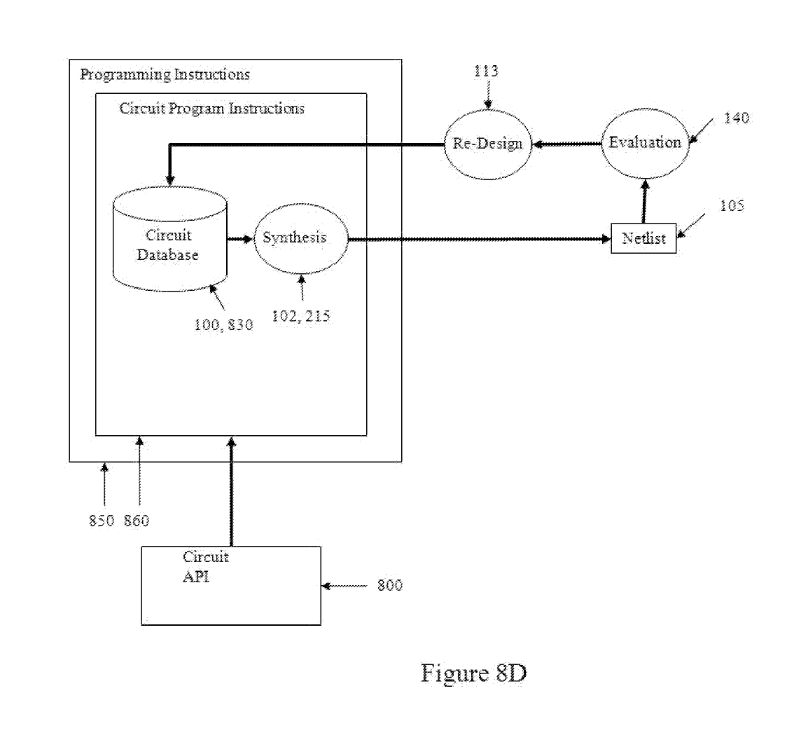

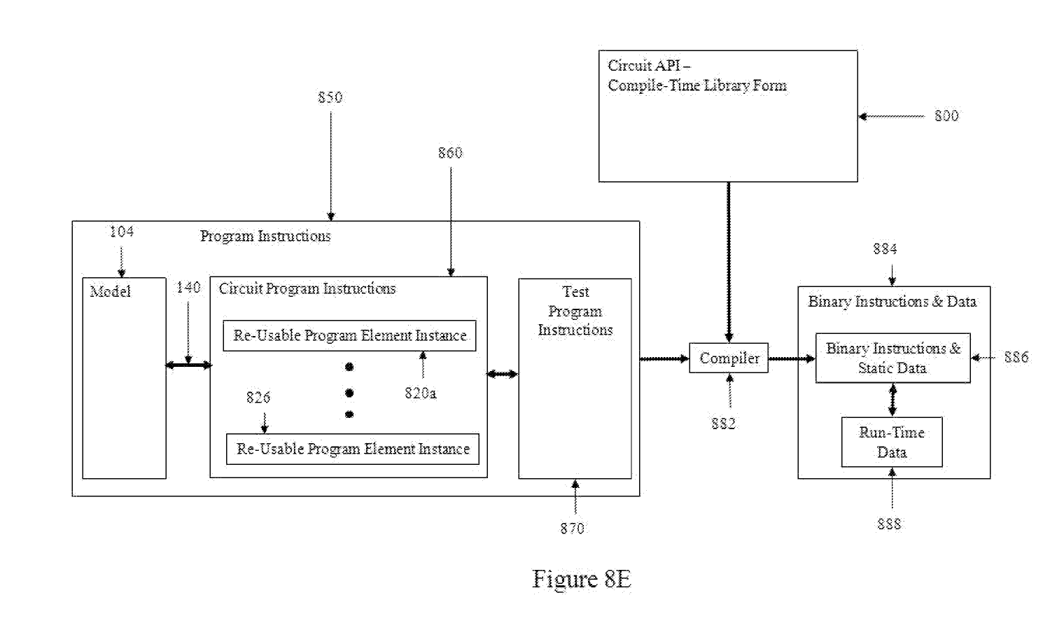

FIG. 3A shows a Component Re-Usable Program Element 300. In example embodiments, a Component Re-Usable Program Element may be used as a basic building block for circuit construction. It may be customized to form a range of building blocks. Examples may include and-gates, or-gates, flip-flops, multiplexers, counters, integer adders, and floating-point adders. Each implementation of element 300 forms a block with unique functionality. The collection of elements 300 representing various building blocks, form a library of building blocks 300a-300n, which is part of an overall library, Circuit Application Programming Interface 800, shown in FIG. 8A.

In an example embodiment, Component Re-Usable Program Element 300 contains Data 305 and Methods 340 for operation on that data. In example embodiments, component re-usable program element 300 may be implemented as a class in object-oriented languages like C++.

In an example embodiment, Data 305 has pre-defined variables 310: Latency 312, Port Count 314, Component Type 316, and Type Name 318. Latency variable 312 contains a value describing the number clock cycles required to sample data on the inputs and present corresponding results on the outputs. For asynchronous components, this value is zero. Port Count variable 314 contains a value describing the number of inputs and outputs on the component. Component Type variable 316 contains a unique value identifying the component type. For example, it may have a code specifying an and-gate or it may have a code specifying a floating-point adder. Component name variable 316 contains a unique name for the component type.

Data 305 may also contain variables 330 that may be modified at run-time. Instance name variable 331 contains the name for each component instance. Implementation Options 332a-332n hold the various options for implementing the device. The types and number of implementation options may vary from component-to-component. Example options for a floating-point adder may be 32-bit single-precision or 64-bit double precision, high-speed implementation versus low-latency implementation, whether custom math or DSP physical blocks are used in the implementation, whether the implementation uses only low level building blocks like and-gates, or-gates, not-gates, and flip-flops, and whether the underlying building blocks have auto-generated names. Example options for a counter may be bit-width, whether it counts up or down, whether the reset is synchronous or asynchronous, or whether custom math logic or DSP physical blocks are used. Simulation Options 333a-333n hold options describing the simulation model. The options 333a-333n may specify the granularity of the simulation, for example the options may specify that the model include only low-level blocks like boolean gates, flip-flops, and wires, or it may specify using behavioral functional models like high-level addition and multiplication. The options 333a-333n may also specify the accuracy of the simulation. Options 333a-333n and 333a-333n may be set when an instance of element 300 is created or they may be set by the initialize method 378.

Instance name variable 331 may be set by circuit designer, by other components or modules implementing the component, or by the component itself. The name may be a hierarchical name. For example, if the component is part of a module hierarchy, it's name may include the instances names of the modules as part of the components instance name The following is an example hierarchical instance name,
/MainALU/InputAdder8/InputAnd

MainALU is the instance name of an ALU module. InputAdder8 is the instance name of an 8-bit integer adder that is part of MainALU. InputAnd is the flat name of the and-gate component that is part of InputAdder8. The instance name may also be set automatically either by the component when it is created or through Initialize method 378, or through the programming instructions creating the component. The automatic name may be a random alpha-numeric name. Random names may be given to components to obfuscate the overall netlist. The overall circuit net list may operate correctly, but random names may obfuscate the implementation, making it difficult to reverse-engineer.

In example embodiments, Input Wires 334a-334n and Output Wires 335a-335n may be variables holding instances of Wire Re-Usable Program Elements 500. Input Wires 234a-234n connect to inputs of component re-usable program elements 225. Output Wires 335a-335n connect to the outputs of Component Re-Usable Program Elements 300. Wires 334a-334n and 335a-335n are created when an instance of element 300 is created or through Initialize method 378. Wires 334a-334n may be replaced by other instances of Wire Re-Usable Program Elements 500 through SetInput methods 362a-362nn. Wires 335a-335n may be replaced by other instances of Wire Re-Usable Program Elements 500 through Set Output methods 366a-366n.

In example embodiments, StateData 336a-336n may be variables describing the state of the Component Re-Usable Program Element 300. For example, given a version of element 300 describing a flip-flop, the state data may be a single variable describing the state of the flip-flop: either 1 or 0. In another example, for a version of element 225 describing an 8-bit wide memory with 256 elements, StateData 336a-336n may be 256 8-bit variables describing the values in each memory cell. Asynchronous logic, like an and-gate, may not have StateData 336a-336n. The values of StateData 336a-336n may be initialized when an instance of element 300 is created or through Initialize method 378. Set State methods 354a-354n may modify StateData 336a-336n. GetState methods 352a-352n may query StateData 336a-336n.

In example embodiments, Initialize method 378 may be used to initialize Data 330. It may be invoked when an instance of 300 is created. Method 378 may set Input Wires variables 334a-334n and Output Wire variables 335a-335n and State Data variables 336a-336n to appropriate default values. In example embodiments, an Input Wire on an enable input may be set to a ‘1’ by default, while an Input Wire on a reset input may be set to a ‘0’ by default. Initialize method 378 may accept values as input parameters for the initial states of Input Wire variables 334a-334n, Output variables 335a-335n, or State Data 336a-336n.

In example embodiments, Methods 340 contain methods 342 that simulate the behavior of component 300. Reset method 344 initializes the simulation by setting StateData 336a-336n to its initial state, Output Wires 335a-335n to their initial state, and all other variables associated with simulation to their initial state. Clock method 346 increments StateData 336a-336n to its next value depending on the values on InputWires 334a-334n and the current values in StateData 336a-336n. For example, a version of element 300 implementing a counter may increment the count state value 336 from a current value of 1 to 2 if the wire on the enable input has a value of 1. UpdateOutput method 348 updates the values on Output Wires 335a-335n depending on the values in StateData 336a-336n and/or the values on Input Wires 334a-334n. For example, given an and-gate version of component element 300, UpdateOutput method 348 may use the values on InputWire 334a and InputWire 334b, perform a logical AND on those values and place the resulting value on OutputWire 335a. In another example, given a counter version of component 300, UpdateOutput method 348 may update OutputWire 335a with StateData 336a representing the counter's count value.

In example embodiments, Simulation options 333a-333n may specify the use of high-level or low-level simulation models. High-level simulation models may use behavioral descriptions, while low-level simulation models may be constructed from boolean gates, flip-flops, and wire. In an example embodiment, a 4-1 multiplexer may have a low-level model composed of 2-input and-gates and 2-input or-gates wired together into a circuit. Alternatively, the multiplexer's functionality may be modeled as an if-else conditional statement. In this example, ‘If’ the select input on the multiplexer has a ‘1’, then the output value is equivalent to input value 1, ‘else’ the output value is equivalent to input value 0. The if-else statement executes on the processor in a few instructions, because instruction set processors have built-in conditional instructions that are optimized to run quickly. Whereas the circuit model requires 11 2-input gates and 23 wires, which takes significantly more instructions and time to process. The two produce results that are bit-for-bit equivalent.

```
if (select == 0)
  output = input0;
else if (select == 1)
  output = input1;
else if (select == 2)
  output = input2;
else if (select == 3)
  output = input3;
```

In an another example embodiment, component element 300 may implement a floating-point adder. A low-level model may be constructed of boolean gates, flip-flops, and wires assembled into a circuit performing the floating-point adder function. A high-level model may use the floating-point adder operator in the programming language, which is mapped to the custom floating-point adder instruction of the instruction set processor. The high-level model performs the equivalent function as the low-level circuit model, but significantly faster. The high-level model may produce bit-for-bit compatible result compared with the gate-level circuit model.

If simulations options 333a-333n specify fine-grained simulation, a circuit representing component 300 may be constructed of more basic circuits elements, like instances of boolean gates 300, flip-flops 300, and wires 500. The underlying components would provide the netlist implementation and the simulation models for the component.

In example embodiments, Synthesis methods 370 contain methods for synthesizing the component into a netlist. In describing a component within a netlist, there are two primary component references: the component type and the component instance. The type declares the component name and the input and output pins of a component, and it is declared once in the netlist. The component instance declares the instance name, the component type that it references, and the wires connected to the pins of the component. Multiple component instances may be declared against a component type. GetComponent method 374 may accept an input parameter describing the netlist format and a code specifying the physical device for implementing the circuit. Example formats may be EDIF, structured VHDL, and structured Verilog. GetComponent method 374 returns a component type declaration specific to the particular component functionality of 300, formatted for the requested netlist, and using the netlist libraries for the physical device. The component type declaration may be directly inserted into a target netlist. In an example embodiment, the following component type declaration may be returned for an 8-bit integer adder targeting an FPGA device and a structured VHDL net list:

```
component AddInteger_W8
    port (
    clk: IN std_logic;
    a: IN std_logic_vector(7 downto 0);
    b: IN std_logic_vector(7 downto 0);
    q: OUT std_logic_vector(7 downto 0));
end component;
```

GetInstance method 372 accepts an input parameter describing the netlist format and a code specifying the physical device for implementing the circuit, and returns a component instance declaration specific to the particular functionality of component 300, formatted for the requested netlist, and using the netlist libraries for the physical device. The component instance declaration may be directly inserted into a target netlist. In an example embodiment, the following component instance declaration may be returned for an 8-bit integer adder on an FPGA device targeting a structured VHDL netlist:

firstAdder: AddInteger_W8
port map (
clk => clk,
a => input0(7 downto 0),
b => input1(7 downto 0),
q => output(7 downto 0));

firstAdder is the name of the component instance. AddInteger_W8 is the component type of the instance, and input0, input1, and output are wire, or in VHDL terminology, signal, names that are connected to the pins a, b, and q.

If component element 300 has higher-level functionality than the base netlist library elements for the physical device, then the functionality may be described in a separate netlist. GetNetlistFile method 376 takes an input parameter describing the netlist format and another input parameter specifying a code for the physical device. GetNetlistFile method 376 returns a file with the netlist describing the functionality of component element 300. In an example embodiment, GetNetlistFile method 300 may return a file named AddInteger_W8 for an 8-bit integer adder targeting a structured VHDL netlist. That file may describe boolean gates, flip-flops, wires, and ports that are assembled to implement an 8-bit integer adder. For components that map to base netlist elements, like a 2-input and-gate, GetNetlistFile method 376 may not generate a netlist file for the component, because it may not be required.

GetNetlistFile method 376 may provide the netlist file by copying a pre-defined netlist from a library of netlist files. The library may contain netlist implementations of the component for various input parameters, where each unique set of input parameters corresponds to a unique netlist implementation. For a particular component element 300 with many input parameter variations, GetNetlistFile method 376 may provide the netlist file by modifying a pre-defined netlist from a library of netlist files. In example embodiments, the component may support bit-widths between 1 and 64 bits. Rather than storing 64 files for every other parameter combination, one for each bit-width, the library can store one file for every other parameter combination, modify the bit widths within the appropriate netlist, and then return the modified version. In this example embodiment, the library size is reduced by a factor of 64. The library may contain a combination of files that can be copied directly or modified and then copied. Each component type may have a separate netlist library.

These netlist libraries may be stored on a local storage medium or they may be stored at a remote, networked storage medium that may be accessed by multiple circuit designers. Improvements to libraries on remote shared mediums result in improvements for all circuit designers. In example embodiments, the improvements may fix problems, may reduce area, may improve speed, may reduce power consumption, or may offer a combination of these.

Because synthesis methods 342 can accept parameters for various netlist file formats and for various physical devices, and produce corresponding net lists, the components may target various netlists formats and various devices. At run-time they may be synthesized to multiple netlist formats and multiple devices. Some components may support many netlist formats and many devices. Some components may support limited netlist formats and/or devices. Some component functionality may only be available on certain devices. For example, hi-speed serial 10 may be available on only limited physical devices, and therefore components representing that functionality may only target those physical devices.

In example embodiments, GetInstance method 372 and GetNetlistFile method 376 may use the values in StateData 336a-336n to initialize components in the netlist. This allows the implementation netlist to begin operation with the synchronous components of the circuit at a pre-specified state. For example, memories in the circuit may be initialized to a particular state, and the netlist may be written with the memories in the equivalent state at startup. Or, the circuit may be simulated to a particular state, and the netlist may then be written so that upon implementation on a physical device, like an FPGA, the circuit may begin operation with the synchronous components at the last simulated state. This capability may be useful for physical debug.

In example embodiments, Get State methods 352a-352n may be used to query the values of StateData 336a-336n. SetState methods 354a-354n may be used to modify the values of StateData 336a-336n.

In example embodiments, GetInput methods 360a-360n may be used to return pointers to InputWires 334a-334n. GetOutput methods 364a-364n may be used to return pointers to OutputWires 335a-335n. SetInput methods 362a-362n may accept instances of Wire Re-Usable Program elements 500 and replace the corresponding wire instances in Input Wire List 334a-334n. SetOutput methods 366a-366n may accept instances of Wire Re-Usable Program Elements 500 and replace the corresponding wire instance in Output Wire List 335a-335n with it. These four method groups may have names specific to the IO's they represent. For example, an enable input may have getEnable and setEnable methods. These four method groups allow the component to have its connections modified. Upon creation, component 300 has instances of wires 500 attached to each input and output. By replacing a wire from another component, two or more components can share the same wire. Consider the following example embodiment in C++,
integerMultiplier8->setInput1(integerAdder 8->get Output ( ));
   integerAdder8, an 8-bit integer adder instance of component 300, uses it's getOutput( ) method 364a to return and instance of wire 500 on its output, which is then submitted to setInput1 method 362a of integerMultiplier8, an 8-bit integer multiplier instance of component 300, which replaces its existing instance of wire 500 on input1 with the wire from the integerAdder output.

In example embodiments, Test methods 380 allow Component Re-Usable Program Elements to verify it's functionality This is a wider test than the simulation methods 342. TestComponent 382 is the main test method, and it may call user-defined methods to assist. TestComponent method 382 may generate sample input data and state data, or may read sample input data and state data from a file. Method 382 may create an instance of component 300, essentially an instance of itself Method 382 may write the input data to the input wires using methods 3621-362n and 546a-546n, and write state data to the instance using methods 354a-354n. Method 382 may use Simulation Methods 342 to simulate the data through the instance, may sample the outputs using 364a-364n and 532a-532n on the instance, may write the output values to a user interface or to files, may generate expected output values internally or read them from a file, may compare the output values against expected values, and/or may report the errors. Method 382 and user-defined assistance methods may use Synthesis methods 370 to generate component declarations through method 374, instance declarations through 372, and netlist files through 376, may compares these against known good declarations and files, may output the declarations to a user interface or a file, and/or may report errors. Test methods 380 may test for the complete functionality of component 300 and may report errors.

FIG. 3B shows a block diagram of component re-usable program element 300. It illustrates a Wire instances associated with each input and output pin, and methods for modifying and querying the wires also associated with each input and output pin. Wires shared across multiple components and multiple pins connect components. These methods enable wire sharing, and thus enable component connectivity.

### Parameter Re-Usable Program Element

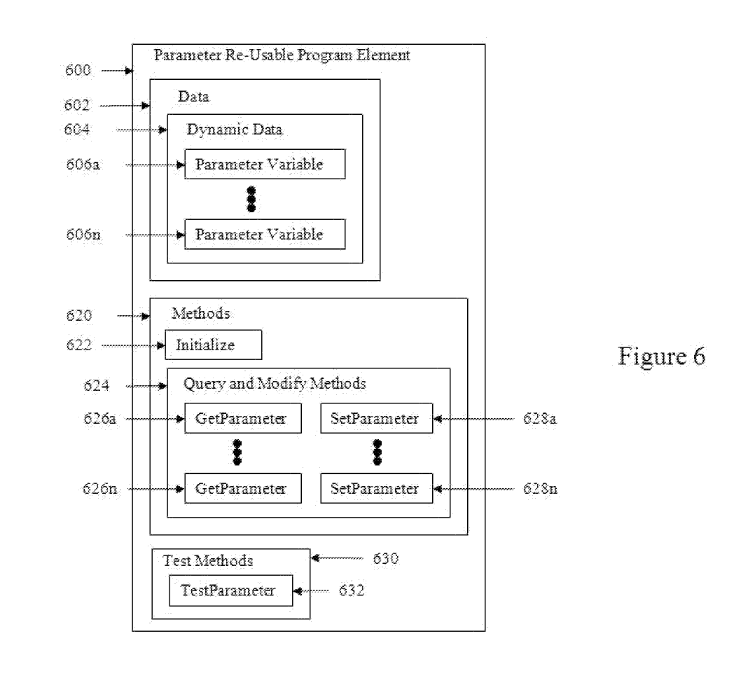

Parameter Re-Usable Program Element 600 shown in FIG. 6 is used to group, store, and retrieve parameter values according to an example embodiment. Some complex components may require more than 20 parameters. Rather than specifying each of the parameter values when creating an instance of component element 300, an instance of Parameter Re-Usable Program Element 600 can be passed instead. Parameter Re-Usable Program Element may also supply default values for the parameters, which means that the circuit designer may only need to specify parameter values that are non-default, which is a smaller subset than the values for all the parameters, thus reducing programming instructions for the circuit designer.

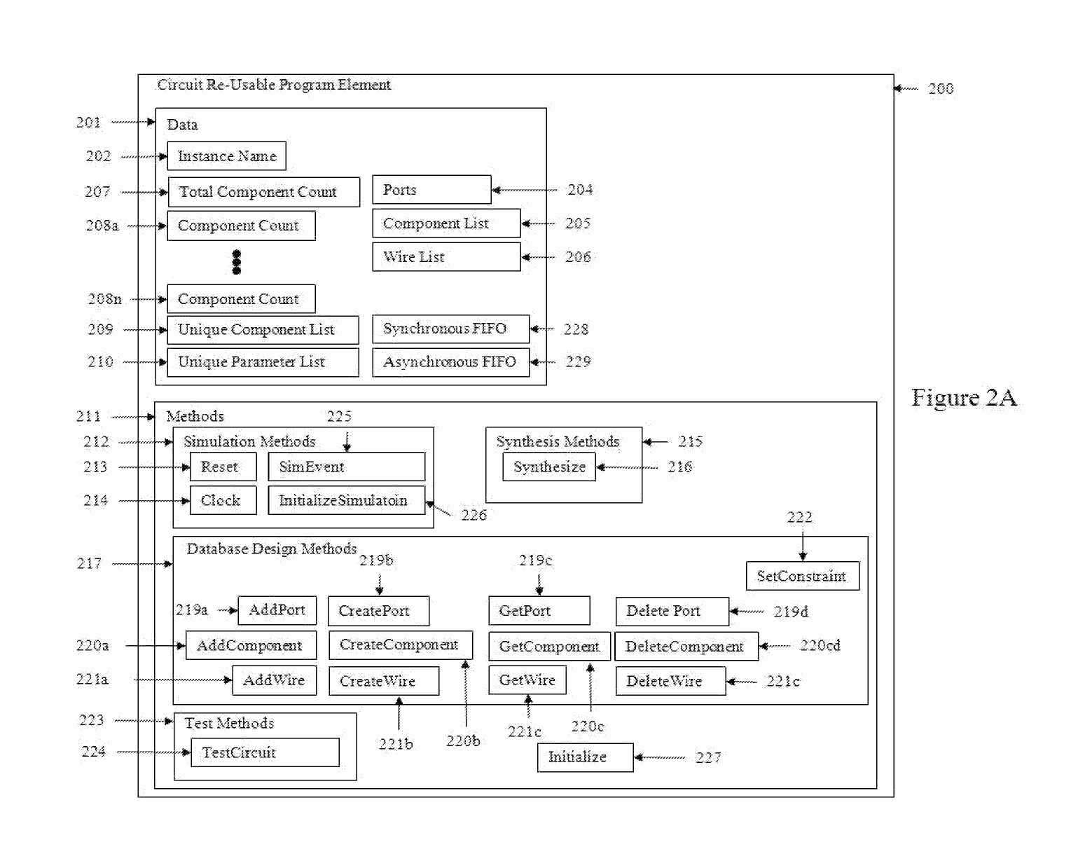

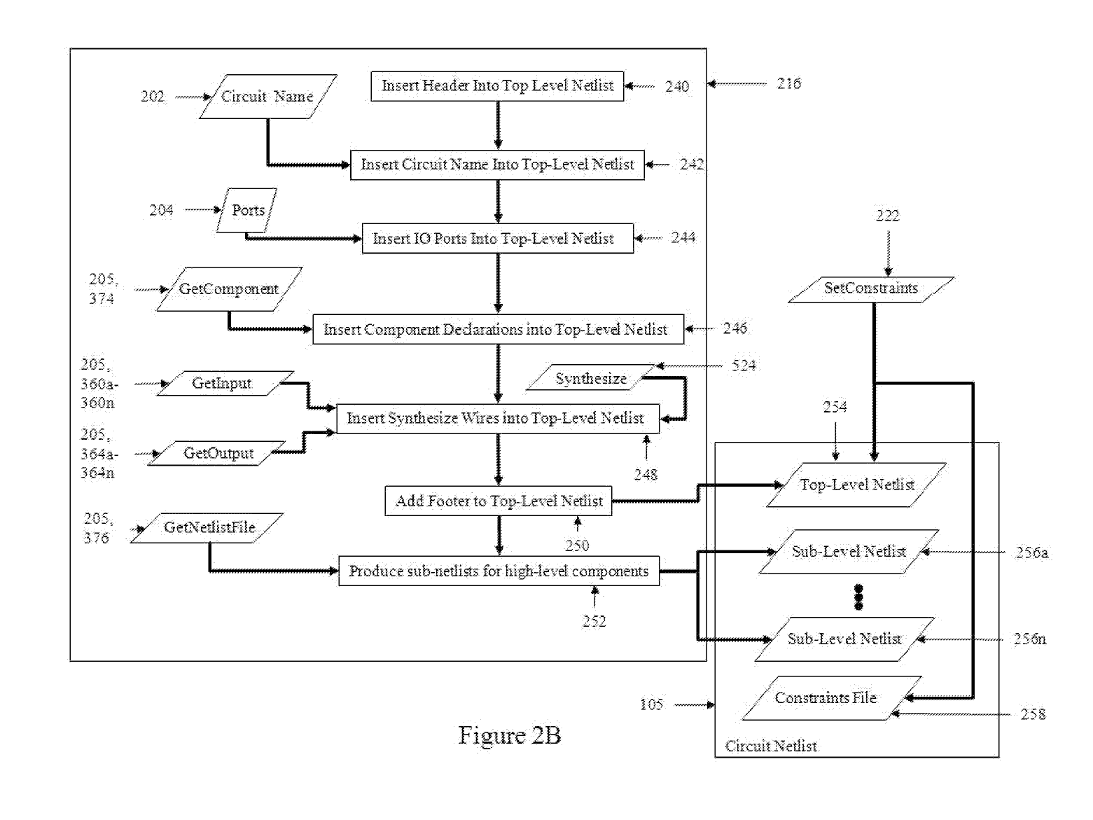

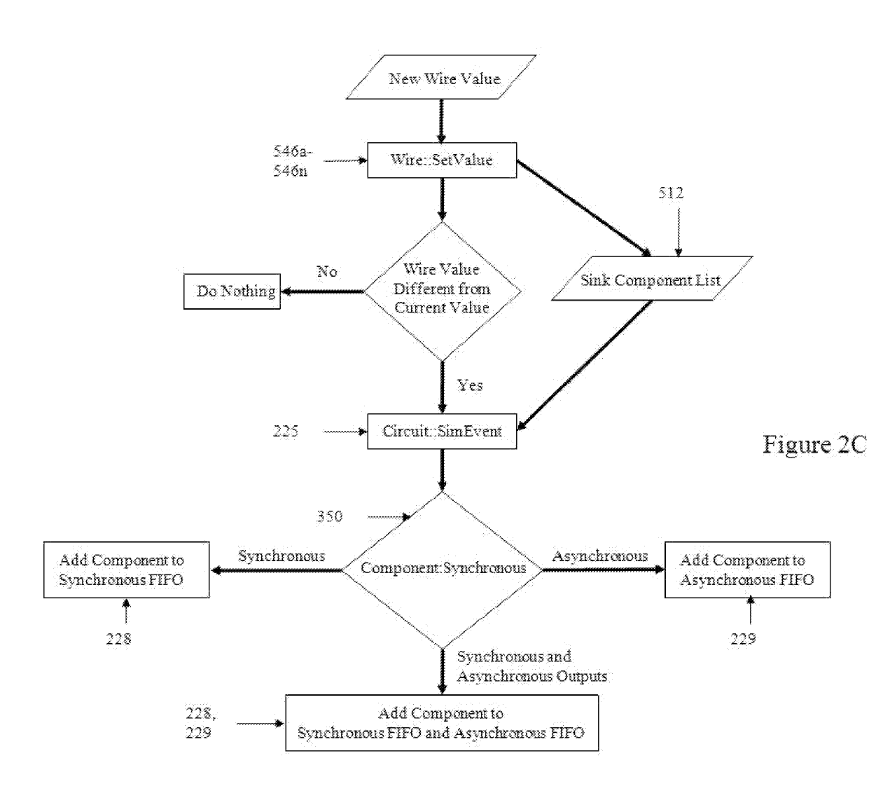

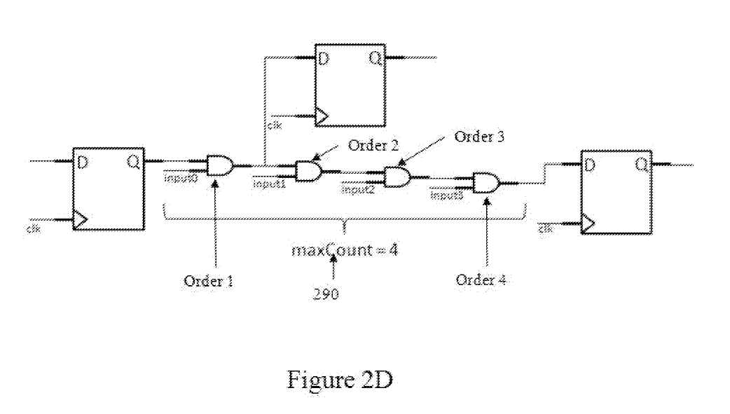

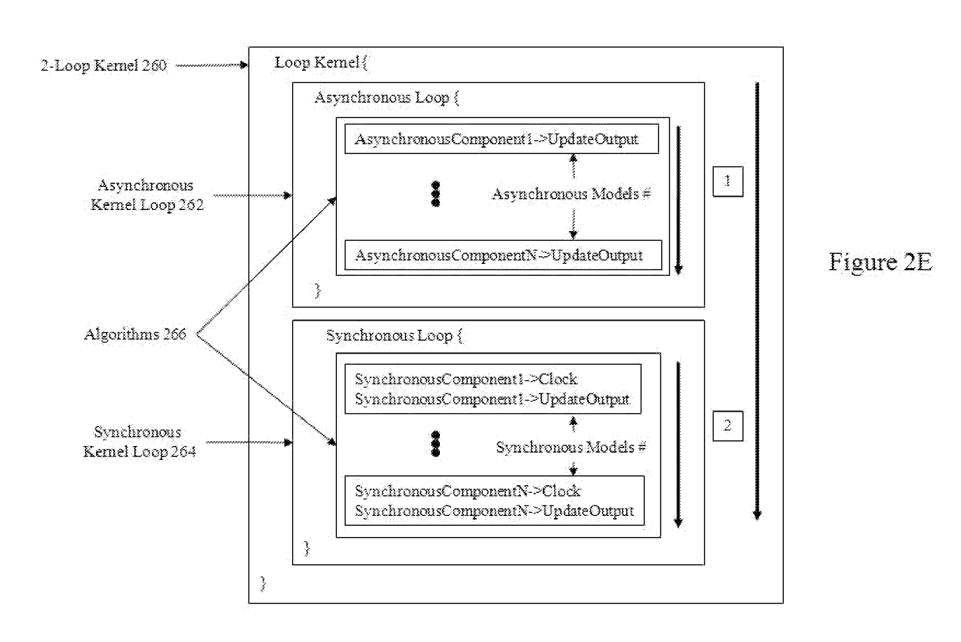

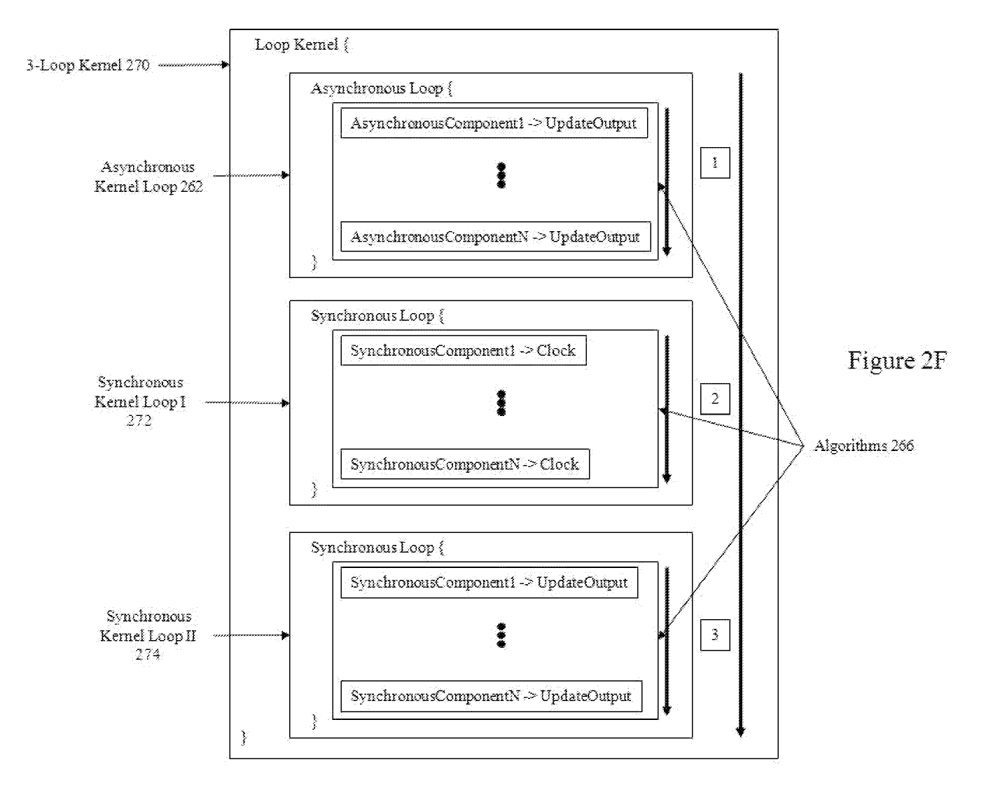

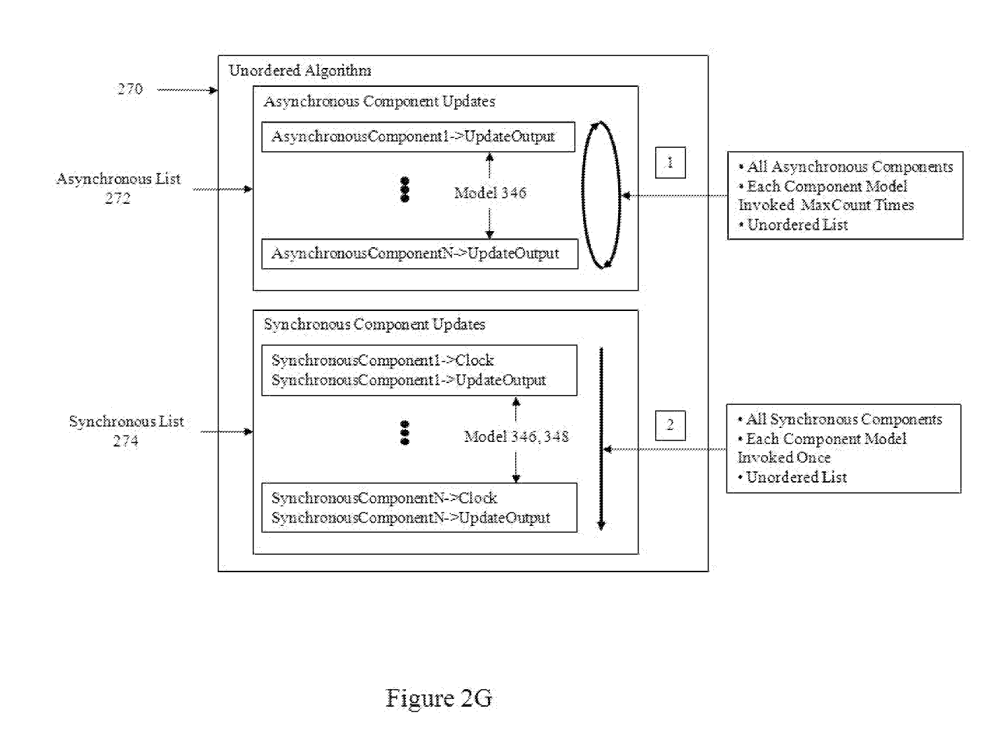

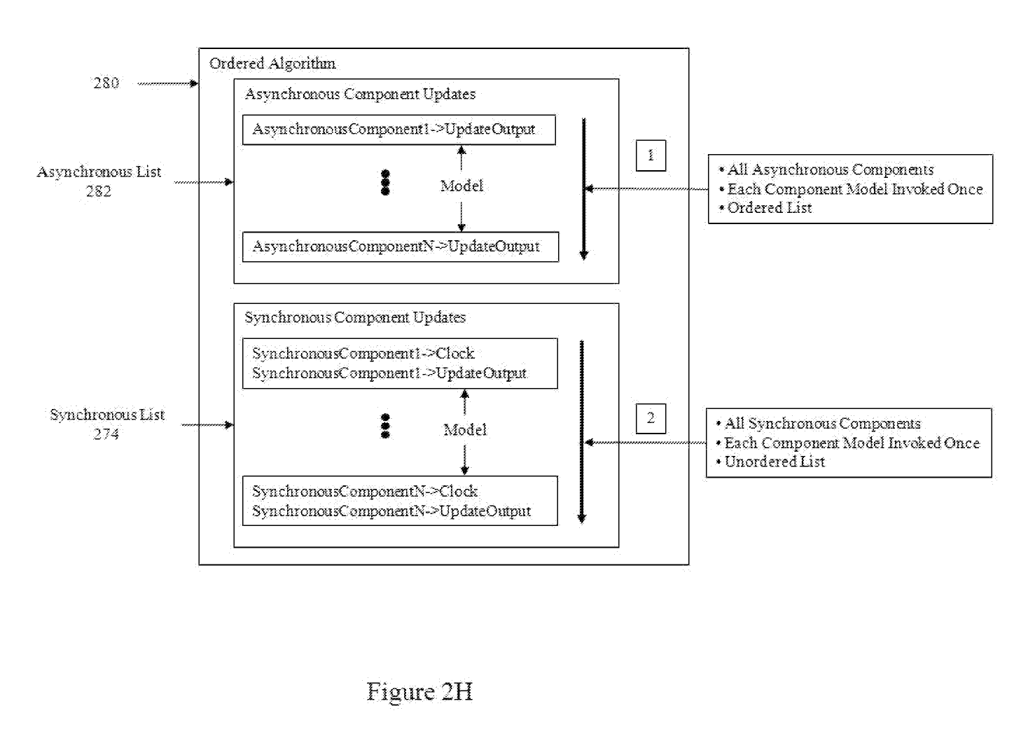

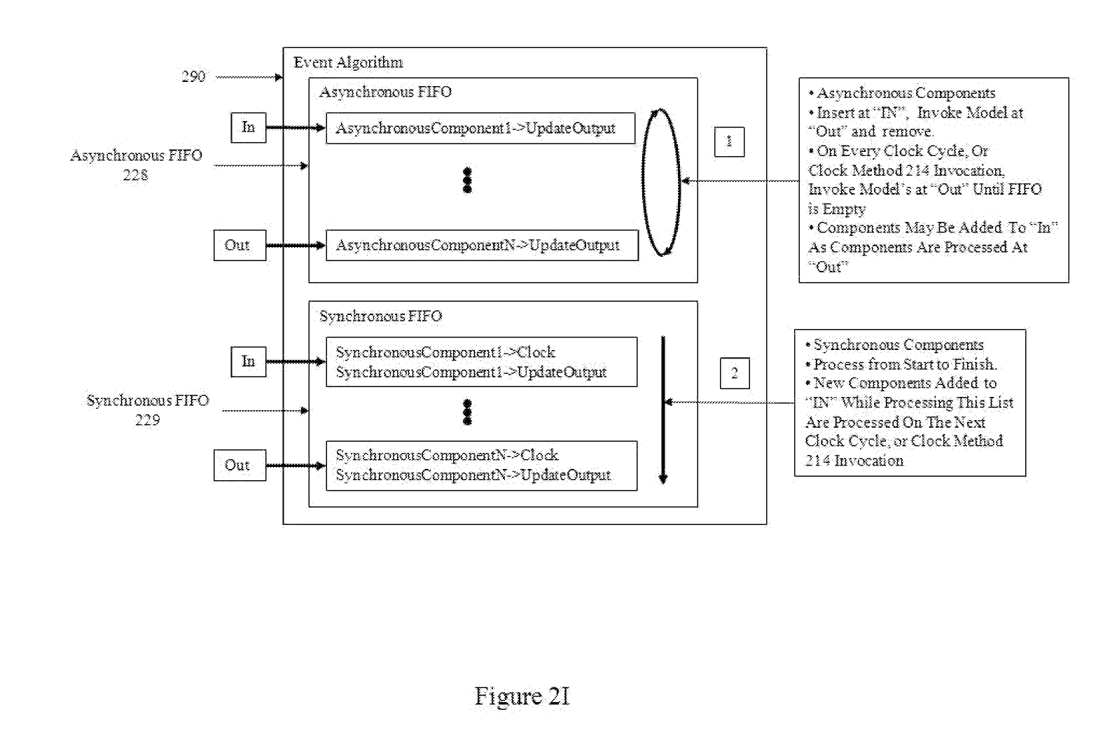

In example embodiments, Parameter Re-Usable Program Element 600 is a base programming element. It's parameter variables, 606a-606n, represent all possible parameters for components 300, ports 400, wires 500, or modules 700 in Circuit API Library. Other Parameter Re-Usable Program Elements 600 may be created with differing default values. In example embodiments, different parameter elements 600 may be created for an 8-bit adder, a 32-bit floating-point multiplier, and 16-bit Up Counter. Upon creation of an instance of parameter element 600, parameter values 606a-606n are initialized with appropriate default values. The circuit designer creates an instance of the particular parameter element 600, and uses that to create an instance of component 300 through CreateComponent method 220b defined in Circuit Re-Usable Program Element (FIG. 2A). In an example embodiment using C++ this may look like the following:
circuit->createComponent(new Parameter8BitAdder( ));
   Parameter8BitAdder is a class 280 defining by default the parameters for an 8-bit adder. ‘new’ creates an instance, or object, of Parameter8 BitAdder class 280, which is used to create the component object through createComponent method 220b for circuit, which is an object of the circuit class 200.

In example embodiments, Parameter Re-Usable Program Element 600 is composed of Data 602 and Methods 620 that operate on Data 602. Upon creation of an instance of parameter element 600, parameter values 606a-606n are initialized to default values. Initialize method 622 may be used to re-initialize the values. GetParameter methods 626a-626n return the corresponding values of Parameter Variables 606a-606n. SetParameter methods 628a-628n accept parameter values and assign them to the corresponding Parameter Variables 606a-606n. TestParameter method 632 and associated helper methods may create instances of parameter elements 600, may write values through the SetParameter methods 628a-628n, may read those values using the GetParameter methods 626a-626n, may compare the read values to the written values, and may report errors. TestParameter method 632 is a self-test of parameter element 600.

In example embodiments, parameter element 600 may have a high-level logical implementation parameter. For example, it may specify a fast implementation, a low-area implementation, or a low power implementation. In an example embodiment, createComponent method 220b examines that specific parameter and may select a set of low-level parameters specific to the component that implement the high-level constraint. The high-level parameter may override other low-level parameters specified in parameter instance 600. This high-level logical implementation parameter can be set for creation particular critical components and/or modules instances. Alternatively, one or a few parameter instances of parameter element 600 may be created and used to create all of circuit's components and/or modules. High-level parameters free the circuit designer from having to understand and implement all component parameters.

### Wire Re-Usable Program Elements

In example embodiments, Wire Re-Usable Program Element 500 is used to connect Component Re-Usable Program Elements 300 to each other, to Port Re-Usable Program Elements 400, and to Module Re-Usable Program Elements 700. The connections specified by the wire elements 500 are valid for simulation and for netlist implementation. If component 300, port 400, or module 700 inputs and outputs contain the same instance of wire 500, then they are connected through that wire instance.

In example embodiments, all instances of wires 500 have the same bit-width, which is a maximum bit-width. When an instance of wire 500 is connected to a component, the component selects the bits on the wire to sink or source depending on whether the connection is to an input or output. This frees the circuit designer from having to specify the bit-widths when declaring a wire or when connecting wires to components. Consider the following example embodiment in C++:
Wire*wire=new Wire( );
integerAdder8->setOutput(wire);
   The maximum bit-width for a wire may be 32-bits. The wire object contains 32-bits to transfer data. But component object integerAdder8 only drives the first 8-bits on the wire object. The upper 24 bits are not driven. The circuit designer is freed from specifying the bit-width at wire creation and also at wire attachment.

In example embodiments, wire 500 is composed of Data 502 and Methods 520. In example embodiments, Data 502 contains Name variable 506 which stores the wire instance name. In a circuit, the instance name must uniquely identify a wire instance. In example embodiments, Value variables 508a-508n contain the same value for the wire but formatted differently. Some Value variables 508aa-508n may in fact occupy the same memory location. In an example embodiment where the maximum wire bit-width is 32-bits, there may be three value variables: a 32-bit integer, a 32-bit signed integer, and a 32-bit floating point. The binary representation may be same for all three, but numerically they may represent different values. In an example C++ embodiment, the three variables may be combined into a union so that they share the same 32-bit memory location. Having the value represented in multiple formats means that instances of wire element 500 may connect to components sourcing and sinking data with different numerical formatting. The wire instances may also report the values in different numerical formats. The format does not need to be explicitly specified for wire instances. Components or other programming instructions may automatically select the appropriate GetValue methods 523a-532n and SetValue methods 546a-546n to exchange data. Instances of wire element 500 may therefore connect to a component of any bit-width (less than the maximum bit width) and sink and source data in any format, without explicitly specifying the width or format.

In example embodiments, Initialize method 522 may accept a name and initial value as an input parameter and use those to initialize Name 506 and Value variables 508a-508n. GetName method 270.23 returns the Name 506 of the wire. SetName method 270.23 accepts a name as an input parameter and modifies Name variable 506 with the input parameter. GetValue methods 532a-532n return the value of the wire specified in Value variables 508a-408n in a particular format. SetValue methods 546a-546n accept parameters in formats corresponding to Value variables 508a-408n, and modifies all Value variables so that they contain the same binary representation. In the example embodiment described above with three 32-bit Value variables, there may be three GetValue methods to return the value in each of the thee formats, and 3 SetValue methods to write the values in each of the three formats: 32-bit integer, 32-bit signed integer, and 32-bit floating-point.

Using the SetValue methods 546a-546n and the Get Value methods 532a-532n, the wires may be used as probes during simulation to drive test values into the circuit and read sample values from the circuit. Because the wire element 500 connects all the components, ports, and modules, it may probe any component, port, or module input and output.

Using the SetValue methods 546a-546n and the Get Value methods 532a-532n, the wires may also implement interface 140 between circuit 100 and a model 104. Models are composed of variables. Wire element 500 interfaces through GetValue methods 532a-532n and SetValue methods 546a-546n using variables. So data may be transferred between the model 104 and circuit 100 using these methods. These methods may also act as an interface between the circuit and other software functionality. In an example embodiment, the circuit 100 may interface with software drivers for a hardware peripheral, like an FPGA, the wires may transfer data between the circuit and the hardware peripheral using the GetValue and Set Value methods as the interface.

Methods 534, 536, 538, 540, 542, 550, 552, and 554 enable the wire to add or remove references to components that source it or it sinks. SetSource method 534 accepts an instance of component element 300 and numerical code referencing a component output pin for a component instance that sources the wire instance. It sets Source Component pointer 510 to the component instance and Source Output variables 514 to the numerical code. Delete Source method 550 removes any instance of component 300 from Source Component pointer 510. AddSink method 536 accepts an instance of component element 300 and a numerical code referencing a component input pin for a component instance. AddSink method 536 adds the component instance to the end of Sink Component List 516 and adds the numerical code to the end of Sink Input List 516. GetSourceComponent method 538 returns the instance of the component 300 pointed to by SourceComponent 510. GetSourceComponentID method 540 returns the numerical code contained in Source Output variable 514. GetSink method 542 returns the list of component instances 300 pointed to by SinkComponentList 512. GetSink method 542 returns the list of numerical codes pointed to by Sink Input List variable 516. When a wire is created or when Initialize method 522 is invoked, variables 510a-510n may be set to null or zero values.

TestWire method may create instances of wire 500, may drive different values through the Set Value 546a-546n methods, may read those values back through GetValue methods 532a-532n, may compare the written values with the read values, and may report the errors. TestWire method 528 may be test completely or partially the functionality of Wire Re-Usable ProgramElement 500.

### Port Re-Usable Program Element

In example embodiments, Port Re-Usable Program Element 400 may be used to define multiple inputs and outputs for Circuit Re-usable Program Element 200. Port element 400 is composed of Data 410 and Methods 440. In example embodiments, Variables In, Out, InOut, 414a-414c have pre-defined, unique values and may specify the direction of a port when it is created. In example embodiments, Name List variable 422 contains a list of names for all the ports. Each name uniquely identifies a single port. In example embodiments, Width List 424 contains a list of values representing the bit-widths for each port. In example embodiments, Direction List 426 contains the codes, 414a-414c, representing the direction for each port. Each port has a wire instance of 500 associated with it. The wire instance connects to a single port, and it may connect to an instance of component element's 300 inputs and outputs. The wire instance connects the ports with components. Wire List 428 contains the wire instances for each port. Lists 422-428 are all the same length. A particular index into the lists may represent the parameters—Name, Width, Direction, and Wire—for a single port.

In example embodiments, Implementation Option variables 430a-430n contain the parameters for implementing the ports on a physical device. If the ports connect to inputs and outputs (IOs) on the physical device, there may be various alternatives in selecting and configuring the device's IOs. In an example embodiment, the IOs may have configurable voltage standards, configurable speed standards, or configurable power standards. Physical device IOs may have different structures. In example embodiments, some physical IOs may be defined as high-speed serial IO, which are very fast analog signaling IOs, and these structures may have many parameters to control their implementation and operation. Other IOs may use digital signaling.

In example embodiments, Initialize method 446 initializes an instance of port element 400. It creates the empty lists 422-428, and sets the Implementation Option variables 430a-430n to their initial state.

In example embodiments, Port 400 has numerous methods, 442 for creating ports of various names, widths, directions, and implementation options. In an example embodiment, createIn32 method may create a 32-bit digital signaling input port, accept the name as an input, and use default implementation options. A method in 442 may accept an instance of a parameter element 600 with all the implementation parameters, name, width, and direction parameters specified within it. The method may extract the parameters from the parameter instance and copy them to the corresponding variables in Data 420. Create methods 442 also create an instance of wire 500 with the Wire name having the Port name appended with ‘Wire’.

In example embodiments, Query methods 460 return information about the ports. GetName method 462 accepts a parameter referencing an index into the Name List 422 and returns the name of the port corresponding to the index. GetWidth method 464 accepts a parameter referencing an index into the Width List 424 and returns the width of the port corresponding to the index. GetDirection method 466 accepts a parameter referencing an index to the Direction List variable 426 and returns the direction code corresponding to the index. GetWire method accepts a parameter indicating an index to the Wire List 428 and returns the corresponding wire element 500 instance. SetWire method 472 accepts a wire instance of wire element 500 as an input parameter and an index referencing the port on the Wire List 428, and replaces the wire instance on the list with the wire instance from the parameter. This method is useful if the circuit designer needs to connect a wire from an instance of component element 300 to a port. GetPortCount method 468 returns the total number of ports defined in an instance of port element 400.

In example embodiments, Synthesis methods 474 return net list declarations. GetPortDeclaration method 476 accepts a parameter indicating the netlist format and another parameter indicating the circuit name, and returns a declaration for the port in the requested format with the name. In an example embodiment the following port-netlist declaration for structured VHDL may be returned:

```
entity DataPath is
    Port ( clk : in std_logic;
        input0: in std_logic_vector(31 downto 0);
        input1: in std_logic_vector(31 downto 0);
        output: in std_logic_vector(31 downto 0));
end DataPath;
```

GetWireDeclaration method 478 accepts a parameter indicating the netlist format, and returns a declaration for Wire List 428 in the requested format. In an example embodiment, the following netlist declaration for structured VHDL may be returned:
SIGNAL ckWire: std_logic:=‘0’;
SIGNAL input0Wire: std_logic_vector(31 down to 0):=X“00000000”;
SIGNAL input1Wire: std_logic_vector(31 down to 0):=X“00000000”;
SIGNAL outputWire: std_logic_vector(31 down to 0):=X“00000000”;

The value for the wires are also the values for the ports, and are also the startup or initial values for the port-wire combination in the netlist. GetConnectionDeclaration method 480 accepts a parameter indicating the netlist format and returns a declaration connecting the ports to its wires in the requested format. In an example embodiment the following declarations for structured VHDL may be returned connecting the input ports to the input wires and the output ports to the output wires:
clkWire<=clk;
input0Wire<=input0;
input1Wire<=input1;
output<=outputWire;

### Circuit Re-Usable Program Element

### Circuit Database Design

FIG. 2A shows Circuit Re-Usable Program Element 200 which may programmatically perform synthesis 102, simulation 103, and test the circuit and its own implementation for correctness according to an example embodiment.

Circuit element 200 contains Data 201 and Methods 211 for operating on that data In an example embodiment using the C++ language, Circuit Re-Usable Program Element 200 may be implemented as a class. Data 201 contains the same information as generic Circuit Database 100 and is its programmatic equivalent. It contains a list of ports 204, a list of components 205, and a list of wires 206. Ports 204 is a variable that points to an instance of Port Re-Usable Program Elements 400, and is the programmatic implementation of generic ports 120. Component List variable 205 points to instances of Component Re-Usable Program Elements 300, and are programmatic implementations of generic components 124. Components 205 are the functional building blocks for programmatic circuit construction. Wire List variable 206 points to instances of Wire Re-Usable Program Elements 500, and are the programmatic implementations of generic wires 126. In sample embodiments, ports 204, components 205, and wires 206 may be implemented as a list of objects in object-oriented languages like C++.

Instance Name variable 202 contains a name that uniquely identifies the circuit instance. Total Component Count variable 207 contains a value representing the total number of components in the circuit. Component Count 208a-208n are variables with separate counts for each component type. Unique Component List 209 is a list of the unique components in the circuit database, and Unique Parameter List 210 holds the parameter instances of 600 for each unique component in List 209. Unique Component List 209 and Unique Parameter List 210 are useful in generating netlists, where a component type may be declared once and where multiple component instances with differing parameters may be declared against the type.

Taken together, the elements of 201 form a programmatic version of circuit database 100.

Initialize method 227 initializes all the variables described in 201 to their initial state when an instance of circuit element 200 is created. This method may accept a name as a parameter to name the circuit instance. The name is stored in Instance Name variable 202. Method 227 creates Component List 205, Wire List 206, Unique Component List 209, and Unique Parameter List 210 in empty states. Total Component Count 207 and Component Count 208a-208n are set to zero. The net result is an empty circuit description available for circuit construction.

Database Design Methods 217 provide the capabilities to construct a circuit in database 201.

AddPort method 219a accepts as a parameter an instance of Port Re-Usable Program Element 400 and assigns it to Ports variable 204. CreatePort method 219b takes in an instance of Parameter Re-Usable Program Element 600, extracts the parameters defining the ports, creates an instance of Port Element 400, and adds that instance to Port variable 204. GetPort method 219c returns the port instance pointed to by Ports variable list 204 if it is defined, otherwise it returns a null pointer. DeletePort method 219d removes the port instance from Ports variable 204 if it is defined.

AddComponent method 220a accepts as a parameter an instance of a Component Re-Usable Program Element 300 and a corresponding instance of a Parameter Re-Usable Program Element 600 that describes the parameters for the component. Using the GetParameter methods 626a-626n on the parameter instance, it extracts the component type from the parameter instance, and extracts the parameters particular to the component type. If the extracted parameters form a unique set that do not match the parameters stored in Unique Parameter List 210, then the parameter instance is added to Unique Parameter List 210, and the component instance is added to Unique Component List 209. The component instance is added to Component List 205.

CreateComponent method 220b accepts as a parameter an instance of Parameter Re-Usable Program Element 600. Using the GetParameter methods 626a-626n on the parameter instance, method 220b extracts the component type. Using the component type, it creates an instance of the Component Re-Usable Program Element 300 corresponding to the type. Method 220b extracts from the parameter instance the parameters particular to the component type. If the extracted parameters form a unique set that do not match the parameters stored in Unique Parameter List 210, then the parameter instance is added to Unique Parameter List 210, and the component instance is added to Unique Component List 209. The component instance is added to Component List 205. CreateComponent method 220b returns a pointer to the component instance it created so that instance may be referenced in other parts of the program instructions.

GetComponent method 220c accepts as a parameter a unique name identifying a component instance and if it exists in Component List 205, it returns a pointer to the component instance, otherwise it returns a null pointer. DeleteComponent method 220d accepts as a parameter a unique component name, and removes the component instance from Component List 205.

AddWire method 221a accepts as a parameter an instance of a Wire Re-Usable Program Element 500 and adds it to Wire List 206. CreateWire method 221b accepts as parameters specifying a wire name and initial value, creates the wire internally and adds it to Wire List 206. GetWire method 221c accepts as a wire name as input, and if a wire instance with that name exists in list 206, it returns a pointer to the wire instance, otherwise it returns a null pointer. DeleteWire method 221d accepts a name as input and removes the wire instance with the same name from wire list 206 if it is defined.

Taken together, database design methods 217 enable a circuit designer to build and modify a circuit description

### Circuit Synthesis

Once a circuit has been built into database 201 representing circuit database 100, it may be synthesized to a netlist 105 using Synthesize method 216. Synthesize method 216 takes in three parameters: name, netlist format, and physical device. The name identifies the name of the top-level netlist file to generate. Netlist format is a code that identifies which file format to write the netlist to. In example embodiments, formats may be EDIF, structured VHDL, or structured Verilog. The physical device code or physical device name uniquely identifies a physical device to implement the circuit. In example embodiments, the physical device may be a semiconductor chip. In some embodiments the physical device may be an Application Specific Integrated Circuit (ASIC) and in other embodiments the physical device may be a Field Programmable Gate Array (FPGA).

In example embodiments, Synthesize method 216 may return a single top-level netlist file or may return a top-level netlist file that references other netlist files. Other netlist files may describe functionality for components with higher-level functionality For example, a floating-point adder component may generate a netlist file to describe it's functionality, and 2-input AND-gate may be recognized by default in the netlist without a reference to a separate netlist description.

The functionality for component elements 300 may be device independent and netlist independent. For example, an integer adder component may be implemented in both an ASIC and an FPGA. And the integer adder may be implemented in EDIF, structured VHDL, and/or structured Verilog netlists. Component elements 300 may be instructed to implement their functionality for particular netlists and for a particular physical devices. Synthesize method 216 may accept a netlist format and device code as a format, and assemble a top-level netlist in the requested format and using net list libraries corresponding to the physical device. Synthesize method 216 may pass the netlist and device parameters to component methods 370 to help it assemble the top level netlist and produce the lower-level sub-netlist files in the required format and using the corresponding device libraries. The circuit designer may therefore use a single programmatic circuit specification to target various netlists and/or various devices.

If some components in the circuit database are netlist or device independent, their Synthesis methods 370 may return an error codes if they do not support the request netlist format or device. The error codes and their associated component types and instance names may be reported by Synthesize method 216 to the circuit designer. The circuit designer may then modify only the device specific components reporting errors in the database. They may use other components that support the required device and netlist or may use generic components that support all netlists and devices.

As illustrated in FIG. 2B, Synthesize method 216 builds the netlist file in several steps. The steps may be similar for different netlist formats. Particular netlist syntaxes may vary the process. Method 216 first inserts a header 240 which may include library descriptions, which may be specific to the physical device specified. It then inserts 242 the circuit's name and the 10 ports into Top-Level Netlist 254. Next 244, component instances in Unique Component List 209 have their GetComponent methods 374 called to return their component declarations, which are added to the netlist 254. All the component's in Component List 205 are then scanned and the wires instances on their IOs are read using GetInput methods 360a-360n and GetOutput methods 364a-364n. With the list of components and wires, the wires are updated with their component sources and sinks using SetSource method 534 and AddSink method 536 in Wires 500. All the unique wire instances are temporarily stored, and their Synthesize method 524 is invoked with the target netlist as an input parameter, which returns the equivalent declarations for the Wires in the target netlist. The wire declarations are then inserted 248 into the netlist 254. In an example embodiment targeting structured VHDL, the Wires may be specified as SIGNAL declarations. The GetInstance methods 376 for all the component instances in Component List 205 are called, and the all the component instances are inserted into the netlist 254. The Wire 500 instance attached to the IOs of components may have their instance names, retrieved through GetName method 530, attached to the ports of the netlist component instances. The tools that map the netlist to a physical device may trim the unused signals or may tie them to Vcc, Gnd, or their default values. A footer is inserted into the netlist. Finally GetNetlistFile methods 376 for all the component instances in Unique Component List 209 are invoked, which creates sub-netlist files 256a-256n for high-level components. These net list files are referenced by name through their component declarations. Low-level components that are defined in the net list library, do not return files when their GetNetlistFile method 376 is invoked. The end-result is a Top-Level Netlist File 254 constructed from the instances of components 300, ports 400, and wires 500, in Data 201, and Sub-Level Netlist Files 256a-256n for high-level components.

SetConstraint method 222 accepts physical implementation constraints and either embeds the constraints in the implementation net list 254, or creates a separate constraints file 258 for implementation. In example embodiments the input constraints may be strings. In example embodiments, the input constraints may be specified in exactly the same format that they appear in the netlist or in the constraints file. In other example embodiments, the input constraints may be a simplified constraints that apply to all architectures. When Synthesize method 216 is invoked, the simplified universal constraints are translated into the architecture-specific constraint syntax before being embedded in the netlist or in the constraints file. Example constraints may be placement constraints tying components to chip locations, chip areas, or ports to pin locations. Example constraints may be timing constraints that specify clock speeds.

The netlists 105 generated from Synthesize method 216 may be simulated in another simulation tools. In example embodiments, a structured VHDL or structured Verilog netlist may be simulated in VHDL or Verilog simulators. In example embodiments, the circuit netlists 105 may be co-simulated in VHDL or Verilog simulators with netlists created by other tools. Because netlists are a common interface among many circuit design tools, the circuit designer can use example embodiments to design, verify, and synthesize parts of circuits and integrate those designs with designs generated and verified with other tools.

The netlists generated from Synthesize method 216 may be used to implement the design using other tools that map the net list onto a physical device. The netlist may specify the complete design for the physical device. The netlists may specify part of a design, and it may be integrated with other netlists from other tools specifying the rest of the design. The combination of netlists generated from Synthesize method 216 and netlists from other tools may form a unified netlist for the complete design that is mapped onto a physical device. In example embodiments, designs specified in VHDL or Verilog may create black-boxes for sub-circuits. The black-boxes specify the sub-circuit's 10 and reference the sub-circuit's functionality by netlist name. Circuit instances of 200 may generate netlists using Synthesize methods 216 with the same IOs and the same name. The netlists from other tools then reference the netlist files generated by Synthesize method 216, forming a unified netlist.

Because Synthesize method 216 is called as part of programming instructions 300 it may be executed from within the compiled executable 884. It may be explicitly executed, or it may be executed depending on run-time parameters from the user interface. It may be executed more than once. In example embodiments, the Synthesize method 216 may be executed for different physical devices and/or for different netlist formats. In example embodiments, Synthesize method 216 may be called between simulation methods, and numerous times, to produce netlists with the synchronous components and the wires reflecting particular simulated states. These custom initialized netlists may be further tested with other simulations tools or on a physical device. In example embodiments, a re-programmable device like an FPGA may be suitable for testing

Because the top netlist is assembled, and sub-netlist files may be assembled, pre-defined, or modifications of pre-defined netlists, synthesis time for method 216 to convert the circuit database into a netlist is less than one second. Compilers also compile programming instructions into an executable in a few seconds. With these two quick processes, the circuit designer can make design modifications in the programming instructions, and the program may be compiled and executed to produce a netlist in a few seconds.

The circuit designer may examine the net list to see how the circuits are implemented and may make design modifications. The circuit designer may therefore iterate through design modification, compile, perform netlist synthesis, and examine the resulting netlist in a few seconds. The circuit designer can repeat these iterations to quickly converge on the required implementation.

### Cross Targeting Physical Devices

In designing a circuit, often times the circuit may be targeted towards different physical devices. For example, a design might target an FPGA device in the early stages of production and in later stages of production it may target a high-volume ASIC. Or as the design is improved over time, it may target newer device architectures. Being able to target the same circuit design and test code for multiple architectures without having to modify or redesign the circuit for new architectures is important.

Example embodiments can automatically target multiple devices from the same circuit specification. In example embodiments, SetDevice method 228 in the circuit re-usable program element specifies the physical device for the circuit. It sets Device variable 203. When synthesize method 216 is invoked, it first passes the value of the device variable to all of the component instances 205 in the database by invoking SetDevice method 379 for each of the components, which sets their internal Device 337 variable. When synthesize methods 216 is invoked, it in turn invokes Synthesis methods 370 for all of the components in list 205. Synthesis methods 370, produce results specifically for the device specified by variable 337. GetInstance method 372 returns an instantiation using netlist libraries, and formatted appropriately, that correspond to the device specified in variable 337. GetComponent method 374 returns a component declaration using netlist libraries, and formatted appropriately, that correspond to the device specified in variable 337. GetNet list method 376 returns a netlist file using a netlist library, and formatted appropriately, that correspond to the device specified in variable 337.

By specifying a device circuit re-usable program element, all of the components may then target the specified device and the same circuit specification may therefore target multiple architectures in example embodiments. The same test, simulation, and evaluation code may therefore also apply to circuits for different devices. The cross-target-ability arises because the circuit, component, test, and evaluation specifications are device agnostic. They represent abstract circuits, components, tests, and evaluations. Once a physical device is specified, the circuit and components can produce a netlist specifically for the device. Because the test and evaluation codes target the agnostic descriptions, they can test and evaluate circuits targeting multiple physical devices.

Some components may target only a limited number of devices, which reflects architectural features that may only exist on limited physical devices. For example, some physical devices may have custom Digital Signal Processing blocks that may be used by some components. During synthesis, the system generates an error for each component that cannot generate a netlist for the target architecture. The user may then modify the design using other components, and may need to modify the test and evaluation code to accommodate the design modifications.

### Circuit Simulation

In example embodiments, Simulation methods 212 simulates the circuit described in Data variables 201, and provide a means of verifying its functionality. Reset method 213 initializes the state of the circuit. It may be called at the beginning of simulation, and/or it may be called during simulation to force the circuit back to its initial state. Reset method 213 invokes the Reset methods 344 for each component instance in Component List 205, which collectively resets the circuit. Clock method 214 advances the state of the circuit. It may take a parameter specifying the number state cycles to increment. Clock method 214 invokes Clock method 346 and the UpdateOutput method 348 for synchronous for the component instances in Component List 205. The order in which methods 346 and 348 are invoked for the various component instances, or the simulation algorithm, may have multiple versions. InitializeSimulation method 226 examines Ports 204, Component List 205, and Wire List 206, and depending on the simulation algorithm, builds data structures to assist with simulation.

The simulation process is composed of three entities in an example embodiment: the simulation kernel 260, 270, the simulation algorithm 266, and the simulation models 346, 348 (see FIG. 2E). The simulation kernel is the primary point of execution. In an example embodiment, the simulation kernel provides a loop or collection of loops that update the components in the circuits. The simulation algorithm defines which and how many components are updated in the simulation kernel. The simulation model defines the calculations that implement component functionality. For every clock cycle of simulation, Clock method 214 invokes a simulation kernel once, which uses the simulation algorithm to determine which components are updated and how often, which invokes execution of the component models.

The simulation kernel, shown in FIG. 2E, is implemented in Clock method 214. In an example embodiment, the simulation kernel 260 uses two small, simple loops 262, 264 (see FIG. 2E). The first loop, the Asynchronous Kernel Loop 262, cycles through all the asynchronous components and for each component it invokes UpdateOutput method 348. The second loop, Synchronous Kernel Loop 264, cycles through all of the synchronous components, and for each synchronous component it first calls Clock method 346 and then UpdateOutput method 348. No parameters are passed into or out of the methods. Examining the only the simulation kernel shows that it is simply two loops. The first loop has one method invocation per iteration, and the second has two method invocations per iteration. The method invocations in both loops do not pass in or return parameters. Modern instruction set processors are specifically designed to execute loops quickly and efficiently. Method call invocations on instruction set processors are simply changes in execution address, which are also very fast operations. Because no parameters are passed to or from the methods, their invocation times are minimized. Overall, the simulation kernel executes quickly and efficiently.

In another example embodiment, the simulation kernel 270 uses three small, simple loops (see FIG. 2F). The first loop, Asynchronous Kernel Loop 262, cycles through the asynchronous components, and for each component only invokes UpdateOutput method 348. The second loop, Synchronous Kernel Loop 1272, cycles through the synchronous components and for each synchronous component only invokes Clock method 346. The third loop, Synchronous Kernel Loop II 274, cycles through the synchronous components and for each synchronous component only invokes UpdateOutput method 348. This kernel also operates very quickly and efficiently.

In an example embodiment, a simulation algorithm selects which and how many components are inserted into the simulation loop kernels. An example algorithm, see FIG. 2G, may perform an exhaustive update of all the component instances in Component List 205 every clock cycle, with asynchronous component instances having methods UpdateOutput 348 invoked repeatedly to guarantee correct circuit simulation. In this embodiment, InitializeSimulation method 226 scans the circuit described in 201 completely and counts the number of asynchronous components in feed-forward chains between synchronous components, see FIG. 2D. This includes counting the number of asynchronous components from the inputs to the synchronous components, and the number of asynchronous components from the synchronous components to the outputs. The maximum number of asynchronous components in a single chain is saved, and referred to as maxCount 290. If InitializeSimulation method 226 detects asynchronous feedback loops, those loops are noted as errors and reported to the user interface and the simulation is stopped. Within Clock method 214, all asynchronous components instances in Component List 205 are inserted into the asynchronous loop. The asynchronous components may be ordered in any manner. The asynchronous loop is repeated with the loop count equal to the maxCount 290. Each asynchronous component has their UpdateOutput method 346 invoked on each iteration. The repetition ensures that data at the inputs of asynchronous component chains are propagated to the outputs of the chains After the data is propagated through the asynchronous components, data is propagated through the synchronous components. With the 2-loop kernel implementation, all of the synchronous components are listed in the synchronous loop 264. Each component has it's Clock method 346 invoked and then it's UpdateOutput method 348 invoked. The components are updated only once in the loop. The components may be ordered within the loop in any manner. With the 3-loop kernel implementation, all of the synchronous components are listed in Synchronous Kernel Loop 1272 and Synchronous Kernel Loop II 274, with them ordered in any manner In Synchronous Kernel Loop 1272, Clock method 346 is invoked once for all synchronous components. In Synchronous Kernel Loop II, UpdateOutput method 348 is invoked once for all synchronous components.

In an example embodiment, a second simulation algorithm (see FIG. 2H) updates the components more efficiently. InitializeSimulation method 226 scans the instances in Component List 205 and builds an ordered list of the asynchronous components (see FIG. 2D). Asynchronous components sourced by synchronous components or by input ports are ordered first. Asynchronous components sourced directly by the first asynchronous components on the list are ordered next. The ordered list continues in this manner until the asynchronous components at the end of asynchronous chains are placed at the end of the ordered list. This ordered list of asynchronous components therefore specifies the update order so that data propagates forward through the asynchronous circuits. If InitializeSimulation method 226 detects asynchronous feedback loops, those loops are noted as errors and reported to the user interface and the simulation is stopped. This ordered list is inserted into Asynchronous Kernel Loop 262. Each asynchronous component has their UpdateOutput method 348 invoked only once each time the loop is invoked. The synchronous loops are executed the same as the previous algorithm. This simulation algorithm is faster and more efficient than the previous algorithm since UpdateOutput method 348 is invoked only once for the asynchronous components per Clock method 214 invocation.

A third example simulation algorithm (see FIG. 2I) uses an even more efficient event-driven algorithm Only components with changing IO values are updated. InitializeSimulation method 226 scans the instances in Component List 205 and it examines the wires on the component IOs. If a wire's source or sink is not set, the method uses SetSource method 534 and Add Sink 536 methods on the instance of wire element 500 to set its component source and sinks. In this algorithm, Data 201 uses two additional data structures: a FIFO for asynchronous components 229 and a FIFO for synchronous components 228. A FIFO is a list where elements are processed in the order that they are added. When Reset method 213 is invoked to start or re-initialize simulation, all of the asynchronous components in Component List 205 are added to Asynchronous FIFO 229 and all of the synchronous components in Component List 205 are added to Synchronous FIFO 228. Synchronous method 350 accepts a value representing an input pin and returns a value indicating whether that input has a synchronous or asynchronous path to the output. If a component has both synchronous and asynchronous paths, like a flip-flop with an asynchronous reset, then the component is added to both the Synchronous 228 and Asynchronous FIFOs 229. Circuit Clock method 214 invokes UpdateOutput method 348 for all the components listed in Asynchronous FIFO 229 at the start of Clock methods 214 invocation. The component instances are removed from Asynchronous FIFO 229 after their UpdateOutput method 348 is invoked. Circuit Clock method 214 then invokes Clock method 346 for all the components listed in Synchronous FIFO 228. Clock method 214 then invokes the UpdateOutput method 348 for all the component instances listed in Synchronous FIFO 228 at the start of Clock method's 214 invocation. The component instances are removed from Synchronous FIFO 228 after their UpdateOutput method 348 is invoked.

The process of invoking the components' Clock method 346 and UpdateOutput method 348 causes data to be propagated through the circuit. The components have data on their IO updated through the Wire Re-Usable Program Element SetValue methods 546a-546n. As illustrated in FIG. 2C, if the SetValue methods 546a-546n detect that a new value differs from it's existing value, they invoke SimEvent method 225 with a pointer to Sink Input List 512, which lists all the component instances that are driven by the wire. SimEvent method 225 uses GetSynchronous method 350 on each component instance in Sink Input List 512 to return whether the component is synchronous, asynchronous, or has both asynchronous and synchronous outputs. Asynchronous component instances are added to Asynchronous FIFO 228 so that they form an ordered, non-repeating list, and synchronous component instances are added to Synchronous FIFO 229 so that they form an ordered, non-repeating list. Components that have synchronous and asynchronous outputs are added to both FIFO lists.

With this algorithm, as Clock method 214 executes the UpdateOutput method 348 for the component instances in Asynchronous FIFO 229, more components get added to the Asynchronous FIFO 229. Clock method 214 keeps processing the Asynchronous FIFO list until it is empty. This indicates that all the data has been propagated through the asynchronous components. As Clock method 214 executes the UpdateOutput method 348 for the component instances in Synchronous FIFO 228, more components are added to Synchronous FIFO 228. Clock method 214 only process components on Synchronous FIFO 228 that are present at the start of its invocation. Components added after the start represent instances for updating on the next cycle of operation. Similarly, the component instances added to Asynchronous FIFO 229 by the invocation of UpdateOutput methods 348 on Synchronous FIFO 228 represent asynchronous updates for the next cycle.

Component instance additions to Synchronous FIFO 228 may be rejected if the component instance is already specified for the current clock cycle. Synchronous components only need to be updated once during a cycle and therefore having a non-repeating component list reduces the computational time. Synchronous FIFO 228 may be ordered reduce the scan time for identifying repeated additions.

The event-driven algorithm reduces the number of component updates. Only the components that have changing 10 are updated, which on average is a smaller set than all the components.

### Simulation Models

In example embodiments, every component has a Reset 344, Clk 346 and UpdateOutput 348 method. The Reset 344 method sets the component at its initial state. The Clk 346 method uses the values on the inputs and the values of the current internal state to update the internal state. It is a synchronous update. UpdateOutput 348 method uses the values on the inputs and the values on the internal state to update the outputs. It is an asynchronous update. The two methods together form the simulation model for the component.

In example embodiments, the simulation model may be described at a Boolean gate and flip-flop level. For example, a floating-point multiplier may be composed of thousands of Boolean gates, flips-flops, and wires This model may reflect the actual implementation of the floating-point multiplier on a physical device. The same functionality however, may be replicated by using the floating-point multiply instruction in the programming language in example embodiments, which maps directly to the floating-point multiply instruction on the processor. This high-level model performs the equivalent function as the low-level circuit model, but significantly faster. The high-level model may produce bit-for-bit compatible result compared with the gate-level circuit model.

As Table 1 shows an example base-set of component building blocks for circuit constructions and their mapping to fast, high-level software simulation models. This base set may be expanded. A multiplexer can be mapped to an if-else conditional statement, switch-case statement, or an array holding the input values. A counter, which controls loops, can be mapped to an incrementer, or integer add instruction. A register can be mapped to a variable.

Table 1 shows that circuit structures can be mapped to programmatic equivalents that simulate significantly faster than boolean gate, flip-flop, and wire equivalents in example embodiments. Programs for instructions set-processors are compiled into serial instructions, and circuits are designed into parallel networks, but the building blocks for both design paradigms have equivalences and serial program may be used to construct a parallel circuit network and simulate it with equivalent functionality.

### Multi-Processor Simulation

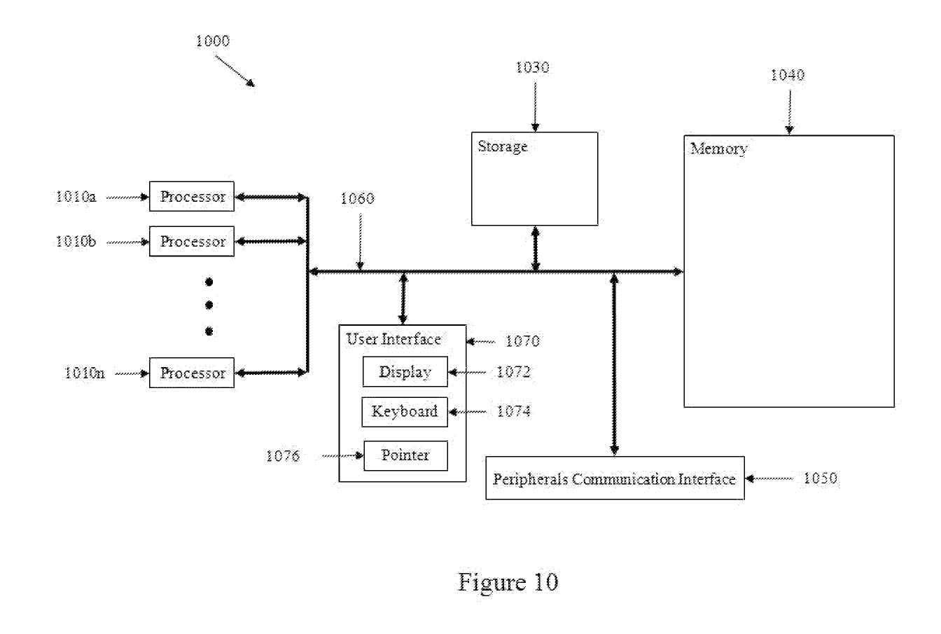

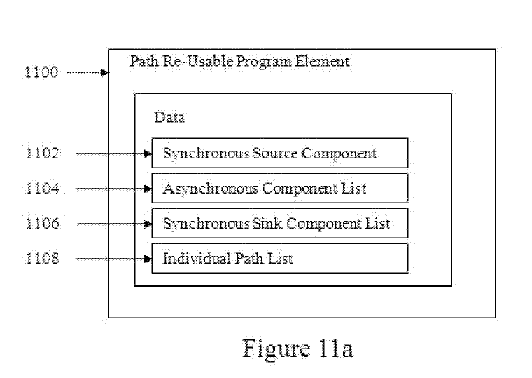

If the speed of the simulation's execution is bounded by the speed of the processor, and not by speed of the connection to memory, the simulator may be accelerated further by using a processor with multiple instruction set processors, or cores, or a system with multiple processors accessing the same, shared memory. FIG. 10 shows a multi-processor system. It is composed of processors 1010a-1010n, which may or may not be on the same physical device, a network for processor communication 1060, which provides communication access to memory, storage, peripherals, and user interface.

Each processor operates independently which allows for multiple, concurrent instruction executions. The flow of instructions through a core is referred to as a thread. The cores execute the threads independently and concurrently.

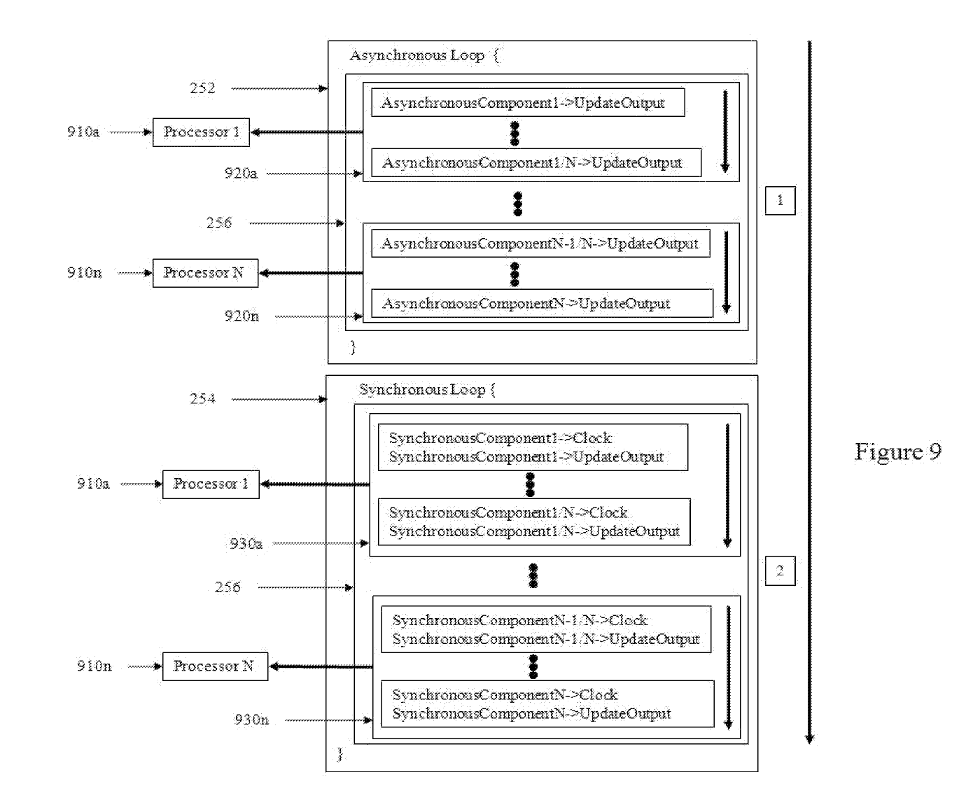

The simulation kernel in Clock method 214 may be split into multiple threads that execute concurrently on multiple processors. Component updates occur independently, so their updates can be split into independent, concurrent threads. As shown in FIG. 9, given N processing cores operating on N concurrent threads, each thread may process 1/N components in each of the two Kernel Loops. In the 2-loop kernel embodiment 260, each processor/thread first updates a group of asynchronous components and then a group of synchronous components. Each processor/thread only executes 1/Nth of the components. Before completing the asynchronous loop and proceeding to the synchronous loop, the threads must wait until all threads complete the loop. This is referred to as synchronization The components may be randomly grouped, which on average will result in a roughly equal distribution of computational time among the processors.

An algorithm may be used to assign the components to the processor/threads in order to balance the computation across the threads. The components may have a variable containing a relative score between 0 and 1, indicating the computation time for the component simulation model. The algorithm may group the components such that the sum of the relative scores across the processor/threads are equal within a tolerance. This may reduce occurrences where one or a few threads spend significantly more time processing, requiring the remaining threads to wait.

In general, the components only occur in each of the main loops once, so their internal variables can be accessed independently. If event-driven simulation algorithms are used, asynchronous components may occur multiple times in the first main loop 262, which means that the same component may be accessed by multiple processor/threads at the same time. In this embodiment, the component must be locked by the first processor/thread that updates it. If another thread detects that a component is locked, it may either wait until it is unlocked or it may skip it and place it in a temporary list. After updating other components, the processor/thread may check the components on the temporary list to see if they are unlocked so they can be updated. Although wires are shared between multiple components, they are only driven by one component output, so wire data may be locked as part of a lock on the component that drives them, but they may remain unlocked too.

### Dynamic Simulation

In example embodiments, Database 100 is a dynamic database. During run-time, instances of component re-usable program elements 300 can be added and removed. Component instances can also be enabled or disabled/bypassed during run-time.

A design may include components and modules organized into multiple blocks. When a block or a subset of blocks are simulated and tested, it may not be necessary to include the other blocks in the simulation. Removing them from the simulation, reduces the number of components to update and therefore speeds up the overall simulation times. One method to remove the components from the simulation is to not add them to the design database. For example, the user code that adds these components to the database may be temporarily commented so that the components are not added.

Similarly, each component instance and module instance may have a simulation option 333a-333n or implementation option 332a-332n that disables or bypasses the component instance for simulation. By setting or unsetting this “simulation enable” variable, the component instance may be disabled or bypassed for simulation. In a disabled component, the Clock method 346 and UpdateOutput method 348 may first examine the simulation enable variable, if it is set, execute the code for the simulation model, and if it is unset, it may skip the execution of the code. This method skips the execution of the model's internal code, but the Clock and UpdateOutput methods are still invoked and returned. To improve time even further, InitializeSimulation method 226 may implement algorithms 266 such that only components with their simulation enable variables set are included in Asynchronous Kernel Loop 262, Synchronous Kernel Loop 1272, and Synchronous Kernel Loop II 274. Component instances with their simulation enable variables unset are excluded or bypassed from loops 262, 272, and 274, and therefore their Clock and UpdateOutput methods are not executed.

The components may have setSimulationEnable and getSimulationEnable methods to facilitate writing and reading the simulation enable variables, respectively. Or the component may make the simulation enable variables publicly accessible so that a user may directly read and modify those variables.

Using the mechanism described above, two example use cases are as follows.

The first use case, the design team may be implementing multiple sections of the design at the same time. They may however want to simulate and test parts of the design in isolation. Rather than temporarily commenting out the code that defines the component instances that are not part of the isolated design sections, the designer may add code that unsets the simulation enable variables for these component instances before simulation This code may be collected into a user-defined function, method, or procedure so that the components may be enabled or disabled with one function call. In this use case, the simulation executes faster and the design sections under test are isolated from other parts of the design.

The second use case dynamically enables and disables component instances during simulation. The user-defined code may sample certain data states or control states within the circuit, for example by sampling the internal states of component re-usable program elements or the values of wire-re-usable program elements, and based on their values, enable or disable groups of components. There are time periods within a simulation where certain components may not affect the simulated functionality of the circuit. In that case, those components may be disabled or bypassed simulation, and thereby saving simulation time. They may be re-enabled if they are required for later simulation time periods. Groups of components may be enabled and disabled repeatedly during simulation in order to save simulation time, while still providing simulated functionality. The circuit tester must ensure that the disabled components in fact have no effect on the simulation, otherwise the results of the simulation may be compromised. The user-defined calls that set and unset the component instance variables may be grouped into a user-defined function, method, or procedure. After enabling or disabling components, the InitializeSimulation method 226 must be invoked before continuing simulation to ensure that the appropriate component instances are included and excluded from simulation kernel loops 262, 272, and 274.

### Simulator Speed

In example embodiments, the simulator operates quickly and efficiently in terms of load times and execution times.

In example embodiments, the circuit description is specified through program instructions referencing elements in the Circuit API 800. Circuit API 800 may also contain the simulator, which is embedded in Simulation Methods 212. The program instructions for the circuit description, the component models, and the simulator may be compiled together into the same Binary Instructions and Static Data 886. The unused components and other unused elements in API library 800 are excluded from the compiled binary instruction set 886. When the binary instruction set is executed, the components and the simulator are loaded directly into memory together from the compiled instruction set file. The simulation kernel and the component models compile to one set instruction set file. Small kernels, small models, and models coupled with kernels enable exceptionally fast load times of the simulator and models. Models for multi-million gate circuit designs load with the simulator in less than a second.

In example embodiments, fast simulation execution times are achieved through numerous means: high-level behavioral models that reduce the instructions required to calculate component functionality, small and simple simulation kernels, event-driven simulation algorithms that reduce the number of component updates, and multi-threaded, multi-processor execution.

### Circuit Test

In example embodiments, TestCircuit method 224 is a stub method with a defined interface and an implementation that is empty for the circuit designer to implement. In implementing TestCircuit method 224, the circuit designer may test the circuit 200 that they have constructed. TestCircuit method 224 may also user-defined test methods that assist in circuit modeling, construction, synthesis, simulation, and evaluation. In example embodiments, TestCircuit method 224 may test test-vector generation methods and/or may test test-vector evaluation methods. TestCircuit may contain all the programming instructions for testing, or may invoke other user-defined methods to assist with testing tasks. In example embodiments, testing functions may generate test-vectors or evaluate test-vectors for VHDL or Verilog simulators simulating the circuit net list.

TestCircuit method 224 may accept run-time parameters to guide the testing process for the circuit's functionality Method 224 may generate sample input data and state data, or may read sample input data and state data from a file. Method 224 may create an instance of circuit 200, essentially an instance of itself Method 224 may write the input data to the input ports using GetPort method 219c and GetWire method 470 to extract the appropriate Wire and then using Wire SetValue methods 546a-546n to write values to the IOs. Method 224 may write state data directly to the components in the circuit using SetState methods 354a-354n. Method 224 may use Simulation Methods 212 to calculate data through the circuit instance. Method 224 may sample data flowing through internal wires using GetValue methods 532a-532n. Method 224 may sample the outputs using Circuit GetPort method 219c, Port GetWire method 470, and Wire GetValue method 532a-532n. Method 224 may write the output values to user interface 1070 or to files in storage 1030. Method 224 may generate expected output values program instructions or read them from a file in storage 1030. Method 224 may compare the output values against expected output values, and may report the errors. Method 224 may use SetConstraint method 222 to pass implementation constraints to the netlist or constraints file. Method 224 may use Synthesize method 216 to generate implementation netlists. Test methods 254 may test for the complete functionality of circuit element 200 and report errors.

In summary, in example embodiments, Circuit Re-Usable Program Element 200 provides the means to define a circuit, synthesize the circuit into a implementation netlist, simulate the circuit, test the simulation for correctness, and test its own programming instructions for correctness.

### Module

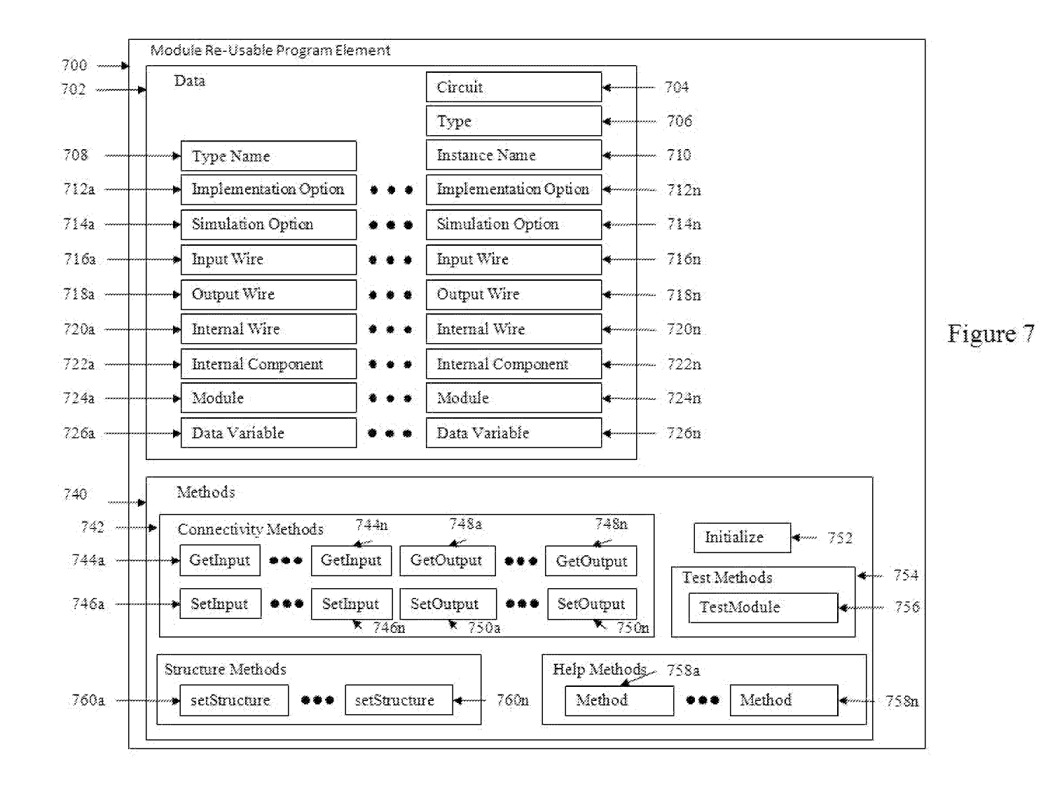

FIG. 7 shows a diagram of a Module Re-Usable Program Element 700 according to an example embodiment. A module is similar to a component in that it defines particular functionality for circuit element 200. It creates its functionality, however, by creating components and wires and inserting them into circuit 200. Modules may also use other modules to insert functionality into circuit element 200. A module uses components, wires, and other modules as building blocks to create particular functionality in circuit element 200.

In example embodiments, Data 702 contains Circuit variable 704, which is a pointer to an instance of circuit element 200. The module keeps an access point to the circuit to the programmable circuit database. Type variable 706 contains a code specifying the functionality of the module and uniquely identifying the module. Type name variable 706 contains a unique name identifying the module type. Instance name variable 710 contains a unique name that identifies each instance of the module. Implementation option variables 712a-712n contain parameters specifying circuit implementation. Simulation option variables 714a-714n contain parameters specifying simulation models for underlying components. Input wire variables 716a-716n are pointers to instances of Wire Re-Usable Program Elements 500 that are attached to the module's input pins. Output Wires variable 718a-718n are pointers to instances of Wire Re-Usable Program Elements 500 that are attached to the module's output pins. Internal Wire variables 720a-720n point to instances of Wire Re-Usable Program Elements 500 that connect internal components and internal modules. Internal component variables 722a-722n are pointers to instances of Component Re-Usable Program Elements 300. These components are the internal base building blocks for the circuit. Module 724a-724n are pointers to other modules implementing sub-functionality of the current module. Data variables 726a-726n are variables containing data, like implementation or simulation data or perhaps state data, that are specific to a module's functionality.

In example embodiments, initialize method 752 creates and initializes Data 702. This includes creating instances for the wires 716a-716n, 718a-718n, 720a-720n, instances for the components 722a-722n, and instances for the sub-modules 724-724n. It may take as input, values for implementation options 712a-712n and values for simulation options 714a-714n. It may also take an instance of a Parameter Re-usable Program Elements 600 as a container for initialized parameters. It may then extract the parameters from the parameter instance. Initialize method 752 may accept as a parameter an instance of circuit element 200, and assigns it to circuit variable 704. It may optionally also accept a name for the module instance to create. It then uses circuit methods AddComponent 220a, CreateComponent 220b, AddWire 221a, and CreateWire 221b to insert components and wires into, or create components and wires directly in the circuit. Initialize method 752 may also use module variables 724a-724n to insert sub-circuits into the circuit.

In example embodiments, connectivity methods 742 contain methods for setting and getting the wires associated with the IO. GetInput methods 744a-744n return the wire instance on the module's input pins. GetOutput method 748a-748n returns the wire instances on the module's output pins. SetInput methods 746a-746n and SetOutput methods 750a-750n accept an instance of wire element 500 as an input and replace the corresponding wire variable 716a-716n or 718a-718n with it. They also replaces all wires on instances on internal components and modules that have the previous version of the wire with the new wire. All of these method types have names specific to their module's 10. For example, GetEnable method may return the wire associated with the module's enable input, and SetDataOutput may set the wire on the module's data output.

In example embodiments, structure methods 760a-760n may be included to specify the structure of the module. In an example embodiment, an Equation module may use one of these methods to specify a boolean equation as an input. The module parses the boolean equation into a boolean equation tree, which is then translated into a boolean components, like and, or, not, xor gates, and wires. These components are then inserted into circuit pointed to by variable 704. The Equation module may use one of these methods to specify an integer equation, which gets translated internally into an integer equation tree, which is then translated into components, like integer adders, subtractors, multipliers, and dividers, and wires that are inserted into the circuit pointed to by variable 704. The Equation module may use one of these methods to specify a floating-point equation, which gets translated internally into an floating-point equation tree, which is then translated into floating-point components, like floating-point adders, multipliers, subtractors, and dividers, and wires that are inserted into the circuit pointed to by variable 704.

In example embodiments, names for the components, wires, and sub-modules of the module may be constructed hierarchically. For component creation, their names may be built by appending the component's instance name to the modules instance name with a separator between them. For example, given a module instance named BoolEquation with an and-gate component instance named InputAnd, the hierarchical name for the and-gate component may be BoolEquation/InputAnd. The same technique may be applied to the wires and sub-modules—appending a separator and their instance names to the wires or module's instance name. This technique results in all components and wires in the circuit database having hierarchical names.

In example embodiments, the circuit pointed to by variable 704 has the modules functionality defined using only components and wires. Even a modules sub-modules are translated into components and wires. The components and wires have simulation models associated with them. The simulation model for the module is therefore implicitly created by assembling the components and wires. When the circuit is simulated, the underlying components and wires create the simulated functionality for the module.

In example embodiments, netlist generation for the module is provided in a similar way. Since it is composed of components and wires in the circuit, when the circuit is synthesized to a netlist, it automatically synthesizes the functionality for the module.

In example embodiments, having modules within modules allows circuits to be constructed with multiple levels of hierarchically. Modules append their names to sub-modules, components, and wires, which results in the final components and wires having full hierarchical names. Having hierarchical names for the components and wires in the database allows them to be grouped hierarchically. In an example embodiment, the hierarchical names may be passed to the synthesized netlist 105. The synthesis tool may group components and wires based on names and perform circuit optimizations on them. Or a schematics viewer may read the netlist and create a graphical, hierarchical schematic view of the net list. In an example embodiment, the hierarchical names may be passed from the netlist to the to the physical floor planning, mapping, placement, routing, and timing tools. Having hierarchical names for the components and wires in the physical tools enables the circuit designer to cross-reference hierarchical physical information relayed by these tools with the components and wires specified in the circuit design's programming instructions 860.

In example embodiments, instance names may be assigned automatically. For example, a random number generator may generate random alpha-numeric codes for the instance names. The components and wire may all be given random alpha-numeric names. Those random alpha-numeric names may be flat and not hierarchical. This would obfuscate the implementation in the netlist file. For further obfuscation, the circuit designer could target low-level components, like boolean gates and flip-flops. For sufficiently large modules or circuits, flat, random names with low-level components may make it difficult to reverse engineer the circuit's implementation. For circuit designers that may want to distribute circuit functionality widely but protect their circuit construction techniques, this may sufficiently obfuscate the implementation. Automatic names may save the circuit designer from creating names for the components, wires, and modules.

In an example embodiment, the base building blocks for specifying a circuit are component re-usable program elements 300 that represent circuit components (for example, synchronous or asynchronous circuit logic elements). Example circuit components may include:
Logic Gates (AND, OR, XOR, NOT) Asynchronous Logic
Flip-Flops (D-Type, Registers, Shift Registers) Synchronous Logic
Memories (Distributed-Fine-Grained, Block Memories) Storage
Clocks (Clock Buffers, Delay Locked-Loops, Frequency Controllers, Phase Shifters)
Routing Buffers (Hi-Drive, Low Latency Buffers)
Input/Output (Registered IO, Unregistered IO, Tri-State IO, Double Data-Rate IO)
Vcc, Gnd (Zero and One sources)

In example embodiments, functionally higher-level components or modules may be built from these lower-level components. These components may be included as another API/library or may be built into the base API and library. Examples include but are not limited to:

Counters
Multiplexers
Decoders
Floating-Point Add, Subtract, Multiply, Divide
State Machines
Comparators
Digital Switches
Integer Add, Subtract, Multiply, Divide

In example embodiments, these in turn may be used to build functionally higher-level components or modules. Examples include but are not limited to:

FIR Filters
Complex Arithmetic Operators
Buses
IO interfaces
IIR Filters
Processors
Bus Interfaces

In example embodiments, TestModule method 756 may accept run-time parameters to guide the testing process for the module's functionality Method 756 may generate sample input data and/or state data, or may read sample input data and/or state data from a file. Method 756 may create an instance of module element 700, essentially an instance of itself and may create an instance circuit element 200. Method 756 may invoke initialize method 752 on the module instance, passing it the instance of circuit element 200. Method may write the input data to the module's inputs using GetInput methods 744a-744n to extract the appropriate wire instance and then using wire element 200 Set Value methods 546a-546n to write the values. Method 756 may write state data directly to the components in the circuit using help methods 758a-758n. Method 756 may use circuit element's Simulation Methods 212 to calculate data through the circuit instance. Method 756 may sample data flowing through internal wires 720a-720n using GetValue methods 532a-532n. Method 756 may sample the outputs using Get Output methods 748a-748n and Wire GetValue methods 532a-532n. Method 756 may write the output values to a user interface 1070 or to files in Storage 1030. Method 756 may generate expected output values internally or read them from a file in Storage 1030. Method 756 may compare the output values against expected values, and may report the errors. Method 756 may use SetConstraint method 222 to pass implementation constraints to netlist 105. Method 756 may use Synthesis method 216 to generate implementation netlists. Test methods 756 may test for the complete functionality of module re-usable program element 700 and report errors.

### Timing Analysis

In designing circuits, maximizing clock speed may be critical Typically, accurate clock speeds and bottlenecks are not known until after place-and-route, when the wire delays are known. But place-and-route is time consuming. The system and methodology described here significantly reduces the time for identifying and fixing timing bottlenecks.

To analyze timing quickly, the system performs two scans in an example embodiment.

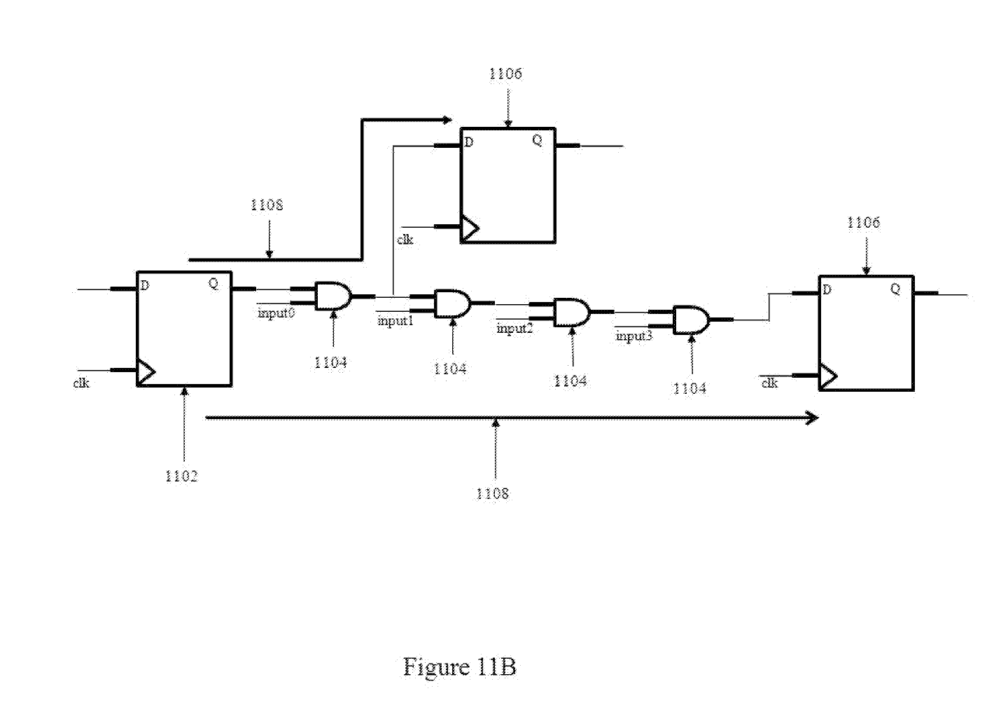

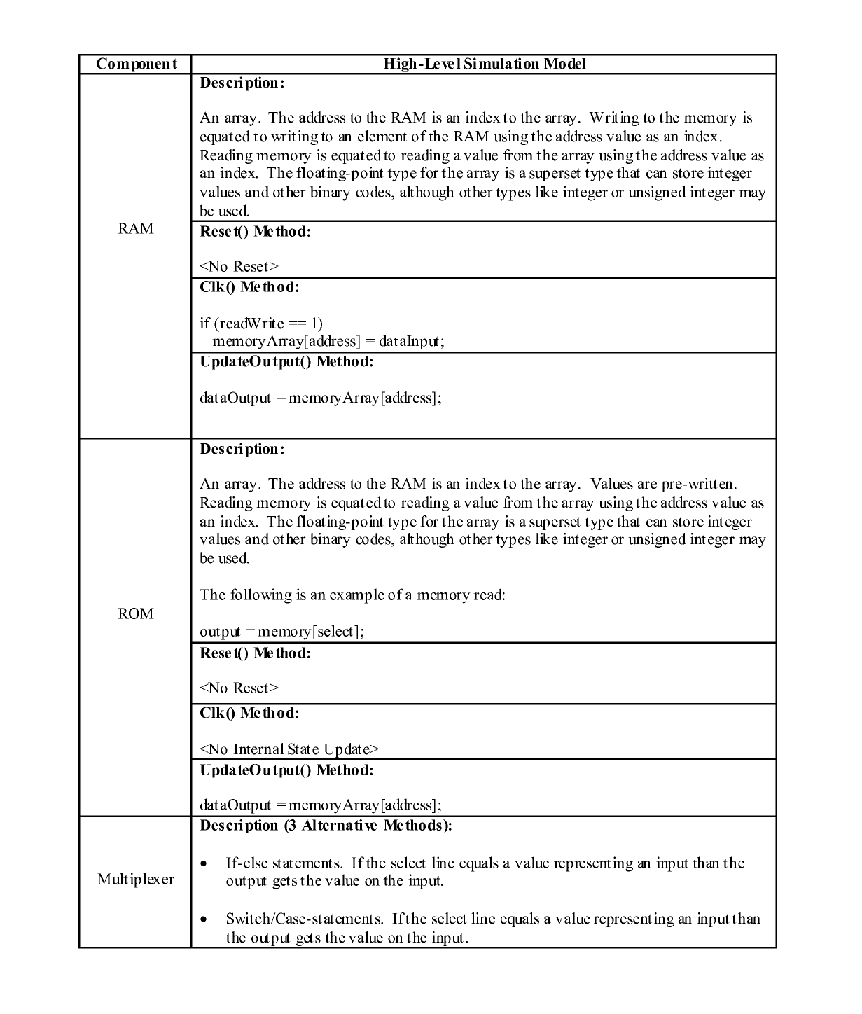

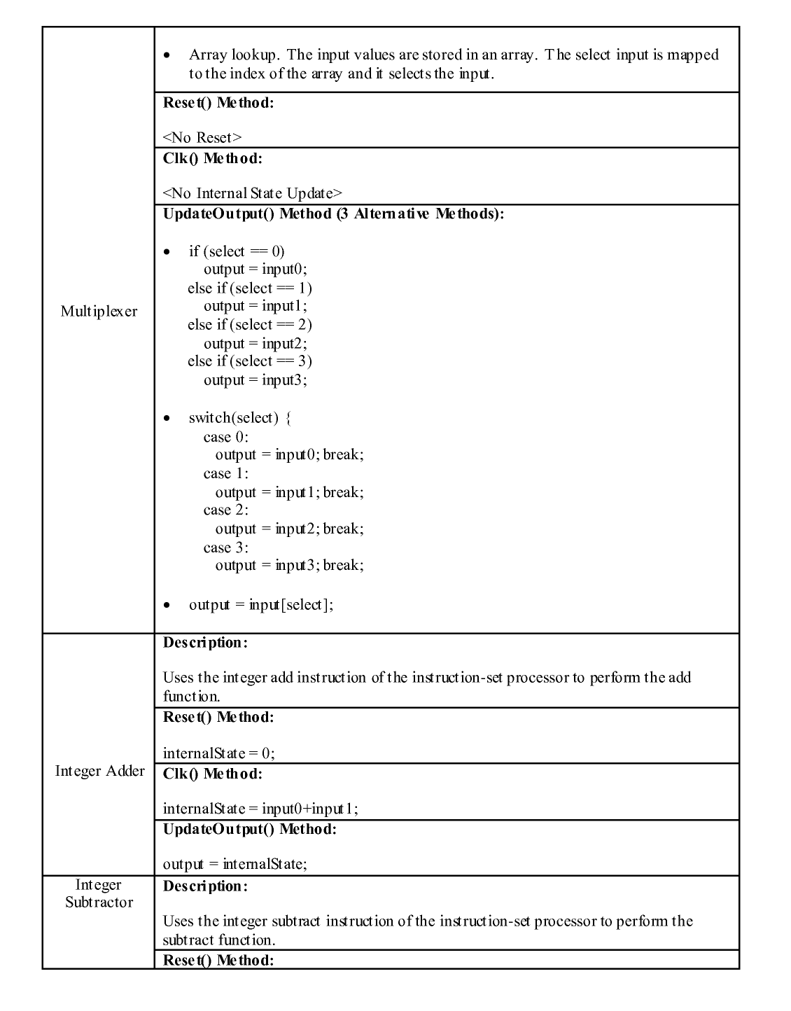

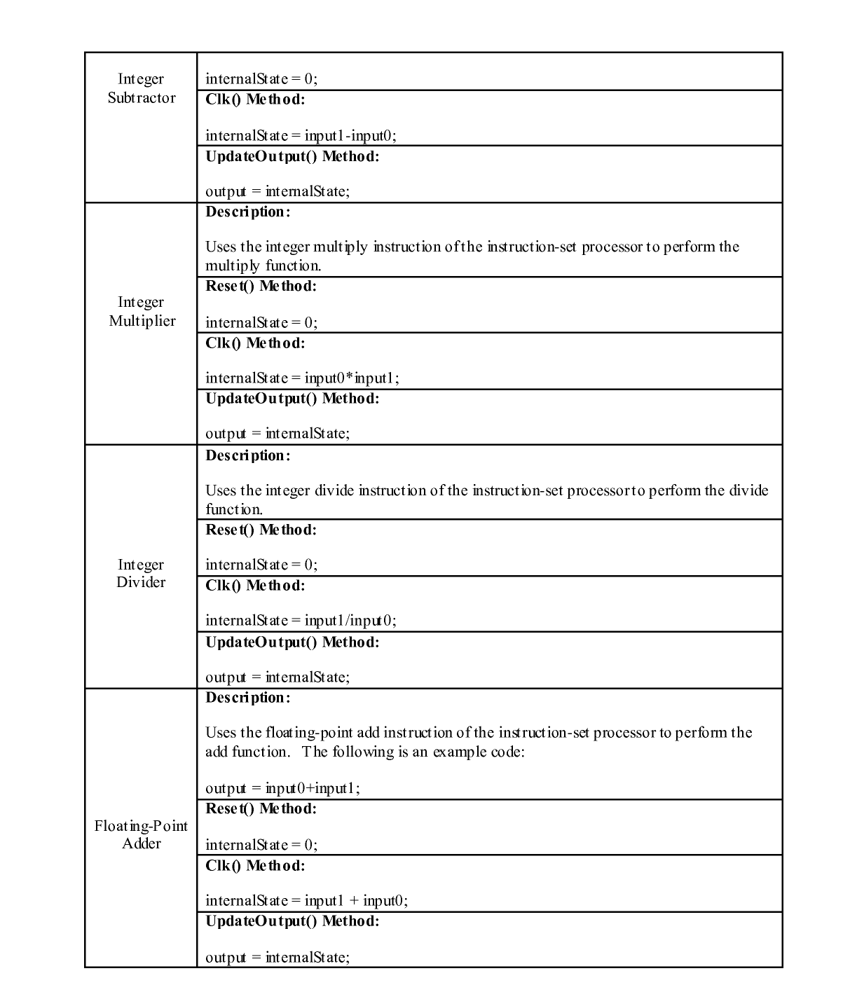

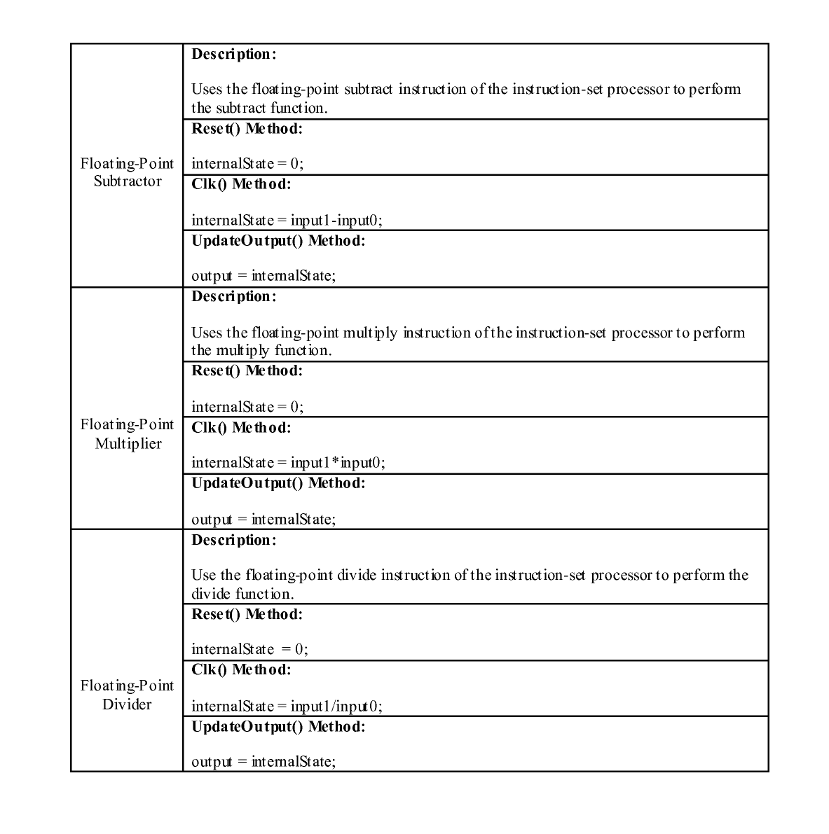

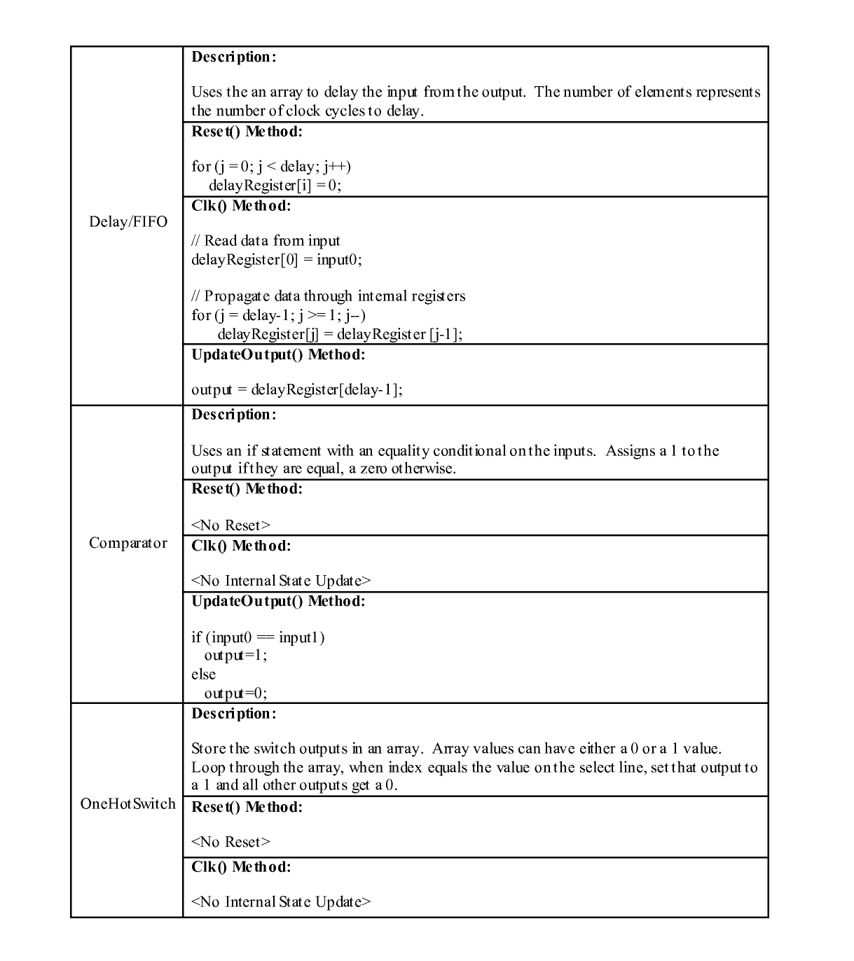

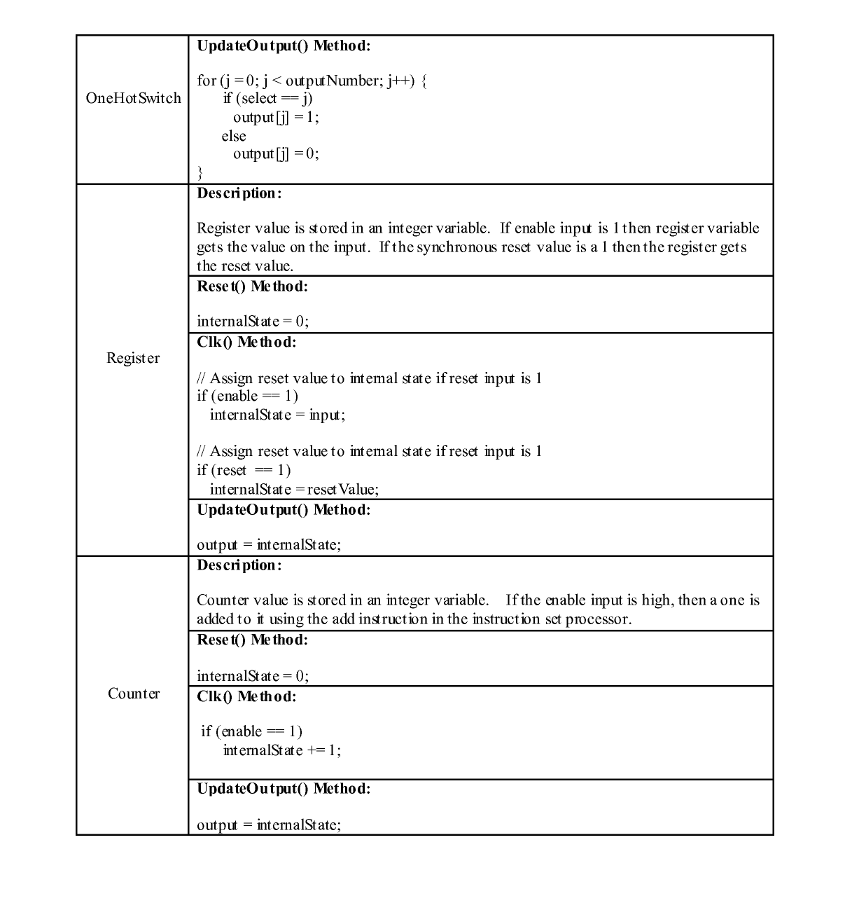

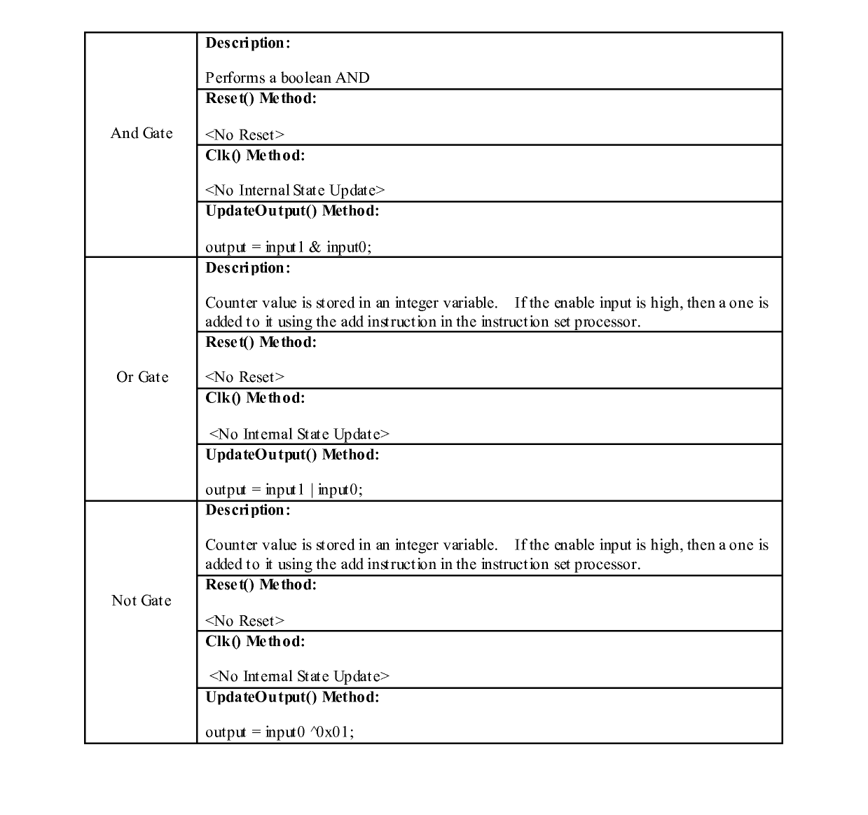

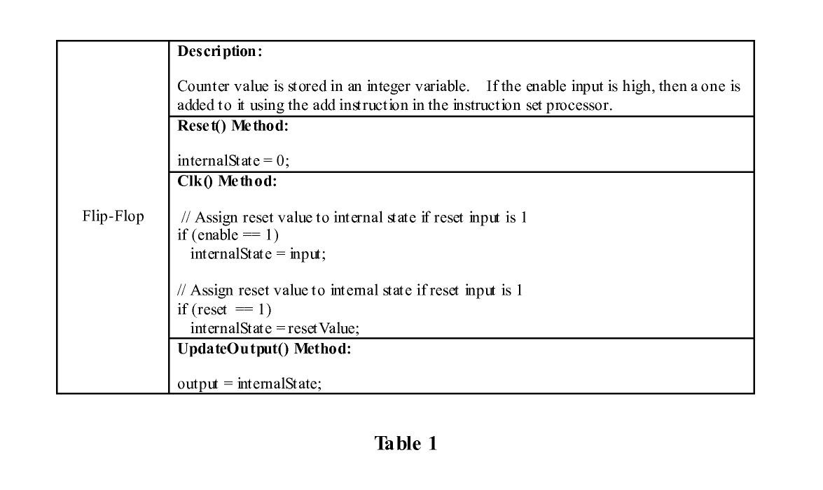

The first scan builds a instance list of path re-usable program elements 1100, with each path instance representing a tree of components (see FIG. 11B). The synchronous source component 1102 is the root of the tree, the first synchronous components following after synchronous source component, the sink synchronous components 1106, represent the end-nodes of the tree, and the collection of asynchronous components 1104 between the synchronous source component and the synchronous sink component represent branches or paths. AnalyzeTiming method 230 scans all of the components in list 205, and for each synchronous component, creates an instance of a path re-usable program element 1100, with the synchronous component as the source 1102. The collection of path re-usable program element instances is stored in a list 207. For each path instance, which at this point populated with just a synchronous source component, the system examines the instances of the wire re-usable program element on each output of the synchronous source component. It identifies the sink components using Sink Component List 512. If a sink component is asynchronous, it is added to Asynchronous Components List 1104. If the sink is synchronous, it is added to Synchronous Sinks List 1106. For each asynchronous component added to Asynchronous Component List 1104, the system examines the instance of the wire re-usable program element on each of it's outputs. It identifies the sink components using Sink Component List 512. If a sink component is asynchronous, it is added to Asynchronous Component List 1104. If the sink is synchronous, it is added to Synchronous Sinks List 1106. This process continues until all the asynchronous components lead to synchronous components, to ports, or to unconnected outputs. The end result, is that each path instance has a synchronous source component, a list of synchronous sink components, and a list of intermediate asynchronous components between the synchronous source component and the synchronous sink components. The system performs this algorithm for each path instance so that the Synchronous Sink List 1106 and Asynchronous Component List 1104 are fully populated to reflect the actual synchronous sinks for the synchronous source and the actual asynchronous components between the synchronous source and the synchronous sink.

The first scan builds the timing trees, but the components are not organized into individual paths. The second scan assembles data structures to represent the individual paths between each synchronous source component and synchronous sink component. Each path instance contains a list of path instances 1108 within it. These path instances 1108 have one synchronous source, one synchronous sink, and list of asynchronous components ordered in succession as they actually appear from the synchronous sink to the synchronous source. These internal path instances 1108 represent the individual paths between synchronous sources and synchronous sinks For every synchronous sink 1106 in every path 1108, the system traces backwards creating a path instance within path instance list 207. A recursive algorithm may be used to perform the traceback. At the end of this scan, each path instance in 207 has a synchronous source component, synchronous sink components, asynchronous components, and a list of path instances each with a single synchronous source component, a single sink component, and a successive list of asynchronous components between them, that describe all of the paths between the synchronous source component and the synchronous sinks.

With the path instances fully populated with data representing the actual paths in the circuit, the system can analyze and compare them. There are two methods the system can use to analyze the timing.

In first method, each component is assumed to have the same unit-delay. For each path instance in 1108, the system counts the number of asynchronous components between synchronous components or between IO and synchronous components. The paths are then ranked based on their asynchronous component counts Asynchronous paths with the highest component count are ranked first, and asynchronous paths with the lowest component count are ranked last. A timing report file is generated listing the paths in ranked order from worst to best. Each path in the report lists the clock source, synchronous or IO source name, synchronous or IO sink name, the names of the asynchronous components, and the asynchronous component count.

In the second method, each component is given measured average delay. For a given physical device architecture, a suite of designs is placed and routed, with each design placed and routed into different physical configurations. And a timing analysis is performed on each placed and routed design. The components are identified within each design in this physically placed and routed state. For each component within each placed and routed design, the delays from the components to their sinks are measured. These times include the setups times at the sinks. Each component therefore has a delay measurement from each input to each sink, which includes the block, wire, and setup delays. For each component, these delays are summed and then averaged providing a single overall delay for each component, and an average delay from each input. For each physical device architecture, or each speed grade, this process is repeated, so that each component has average delays per physical device architecture and per speed grade. These values are stored within the component re-usable program elements as static variables or static arrays. For each path instance in 207, the system counts the number of asynchronous components between synchronous components or between IO and synchronous components, and sums the average delays between them. The system may either use the average measured delay for the component, or the average measured delay per component input. The paths are then ranked based on their total average delays. Asynchronous paths with the highest delays are ranked first, and asynchronous paths with the lowest delays are ranked last. A timing report file is generated listing the paths in ranked order from worst to best, listing the total delay for each path and the average delay per component. Each path in the report lists the clock source, synchronous or IO source name, synchronous or IO sink name, the names of the asynchronous components, and the asynchronous component count.

### Circuit API

In an example embodiment, an Application Programming Interface (API) may be provided for a library with pre-built, pre-verified re-usable program elements. The re-usable program elements provide pre-built, pre-verified high-level programming functionality. The re-usable program elements in API library may be composed of pre-defined program instructions and program instructions referencing other APIs. In example embodiments, built-in program instructions may consist of loops, conditional statements, like if-else, and variables. These program instructions may be parsed and compiled directly by the compiler. In example embodiments, APIs may include high-level functionality for file access, network access, graphical access, or high-level data structure access. Program instructions may be used to create instances of re-usable program elements within APIs. Multiple instances of each re-usable program element may be created, with each one customized with particular data. In an example C++ embodiment, an API may be composed of classes, which represent the re-usable program elements. In the example C++ embodiment, the classes may be instantiated into objects, with each object customized with particular data values.

In an example embodiment, Circuit Application Programming Interface 800 in FIG. 8A, or Circuit API, contains pre-built, pre-verified re-usable program elements 802 for creating circuits, synthesizing them to netlists, simulating them, testing then, and interfacing and testing them with circuit models. It is composed of Circuit Re-Usable Program Elements 200, multiple Component Re-Usable Program Elements 300a-300n (each one defining a separate circuit function), Port-Reusable Program Element 400, Wire Re-Usable Program Element 500, Parameter Re-Usable Program Elements 600a-600n, and multiple Module Re-Usable Program Elements 700a-700n (each one defining a separate higher-level circuit function). Component Re-Usable Program Elements 300a-300n may represent basic functional building elements for circuits. Module Re-Usable Program Elements 700a-700n may represent higher-level functional elements composed of component elements.

In example embodiments, program Instructions 850, and specifically Circuit Program Instructions 860, may create one or more instances of Re-Usable Program Elements 802. Circuit Program Instructions 860 may create one or more Circuit Re-Usable Program Element Instances 830 by referencing Circuit Re-Usable Program Element 200 in Circuit API 800. Circuit Program Instructions 860 may create one or more Component Re-Usable Program Element Instances 820a-820n by referencing Component Re-Usable Program Elements 300a-300n in Circuit API 800. Circuit Program Instructions 860 may create one or more Wire Re-Usable Program Element Instances 822a-822n by referencing Wire Re-Usable Program Element 500 in Circuit API 800. Circuit Program Instructions 860 may create one or more Parameter Re-Usable Program Element Instances 824a-824n by referencing Parameter Re-Usable Program Elements 600a-600n in Circuit API 800. Circuit Program Instructions 860 may create one or more Port Re-Usable Program Element Instances 826 by referencing Port Re-Usable Program Element 400 in Circuit API 800. Program Instructions 850 may create one or more Module Re-Usable Program Element Instances 828a-828n by referencing Module Re-Usable Program Elements 700a-700n in Circuit API 800.

In example embodiments, Circuit Program Instructions 860 may contain one or more Circuit Re-Usable Program Element Instances 830. Each Circuit Instance 830 may contain one or more Component Re-Usable Program Element Instances 820a-820n, one or more Wire Re-Usable Program Elements 822a-822n, and one or more Parameter Re-Usable Program Element Instances 824a-824n. One or more Module Re-Usable Program Element Instances 828a-828n may be created in Program Instructions 850, which may accept one or more Circuit Instances 830 as an input and insert their functionality into the Circuit Instances 830.

As illustrated in FIG. 8B, Program Instructions 850 may be used to create a program implementation of circuit design, modeling, synthesis, simulation, test, and evaluation processes show in FIG. 1B. Model 104, Circuit Program Instructions 860, and Test Program Instructions 870 may be implemented and specified in Program Instructions 850. Program Instructions 850 may be specified in a singular programming language, unifying the model, circuit, and test specifications. In example embodiments, Program Instructions 850 may be specified in the C++ programming language, with Model 104, Circuit Program Instructions 860, and Test Program Instructions 870 in a single, unified C++ specification.

As illustrated in FIG. 8B, Circuit Program Instructions 850 may include both the circuit database, and the synthesis and simulation processes. In an example embodiment, Circuit Database 100 may be implemented as a Circuit Re-Usable Program Element Instance 830. Ports 123 within Circuit Database 100, 830 may be implemented as Port Re-Usable Program Instance 826. Components 125 within Circuit Database 100, 830 may be implemented as Component Re-Usable Program Element Instances 820. Wires 126 within Circuit Database 100, 830 may be implemented as Wire Re-Usable Program Element Instances 822. Simulation Probes 122 may be implemented as Wire Re-Usable Program Element Instances 822. Model-Circuit interface 140 may be implemented as Wire Re-Usable Program Element Instances 822. Synthesis process 102 may be implemented as Circuit Re-Usable Program Element methods 215. Simulation process 103 may be implemented as Circuit Re-Usable Program Element methods 212.

As illustrated in FIG. 8C, Simulation 103,212 may be implemented as Circuit Program Instructions 860 and Test Program Instructions 870 may programmatically implement Simulation Input Data 106, Simulation Output Data 107, Expected Output Data 108, and Evaluation 109. Input data may be read from Input Data File 892 or may be generated with Test Program Instructions 870. Simulation Output Data 107 may be formatted and presented to a User Interface 1070 as user Simulation Output Data 890 or it may be saved to a file. Evaluation 109 may be constructed with programming instructions to examine Simulation Output Data 107 and produce Error Count 121, Correct Output List 110, or Incorrect Output List 111 which may be saved to a file in Storage 1030 or presented to User Interface 1070. Based on these results a circuit designer may redesign Circuit database 100,830, Simulation Probes 120,822, Input Data 106,892, and/or Expected Output Data 108,894.

As illustrated in FIG. 8D, Synthesis 102,215 may be implemented as Circuit Program Instructions 860 which generates Netlist file 105 that may be stored in Storage 1030. Upon Evaluation 140 of Netlist 105, which may include reading Netlist 105 or viewing it graphically using a schematic viewer, the circuit designer programmatically may Re-Design Circuit Database 100, 830.

Circuit program instructions 860 may interact with other Program Instructions 850, including pre-defined program instructions, and program instructions referencing other APIs. In example embodiments, the Circuit Program Instructions 860 may interact with Program Instructions 850 specifying file interactions, network interactions, graphic interactions, or interactions with high-level data structures.

Circuit API 800 may have several forms, with each form having internally equivalent functionality. Circuit API 800 may be defined as source code. In this form the programming instructions are readable and they can be compiled and linked with Circuit Program Instructions 860. Circuit API 800 may be defined as a compile-time library. A compile-time library is a binary, compiled version of the Circuit API 800. It may be linked at compile-time with the Circuit Programming Instructions 860. The compile-time library is specifically compiled from source code by a compiler into compile-time library form. Circuit API 800 may be defined as a run-time library. A run-time library is a binary, compiled version of Circuit API 800 which may be linked at run-time with the compiled Binary Instructions and Static Data 886. The run-time library is specifically compiled from source code by the compiler into run-time library form. Circuit API 800 may be a combination of these, with some parts of the library defined as source, other parts defined as compile-time libraries, and/or other parts defined as run-time libraries.

As illustrated in FIG. 8E, Program Instructions 850 may be compiled with Circuit API in compile-time library form using a compiler 882 which produces Binary Instructions and Static Data 886. Binary Instructions and Static Data 886 contains instructions and data formatted for a physical or virtual instruction set processor. In example embodiments, Binary Instructions and Static Data 886 may be referred to as an executable. Binary Instructions and Static Data may be stored in computer storage 1030 and may be loaded into computer Memory 1040. During execution by one or more processors 1010a-1010n, which may be physical or virtual processors, Run-Time Data 888 may be generated in Memory 1040. Run-Time Data may represent in part Circuit Re-Usable Program Element Instances 830.

In example embodiments, multi-million gate designs implementing custom co-processors have been constructed using 20 component types instantiated into more than 2,000 component instances and more than 10,000 wire instances. Some component types have been instantiated once or a few times, while others have been instantiated over 100 times. The resulting synthesized VHDL is over 50,000 lines in length. The full simulation of that VHDL takes 1 hour and 10 minutes to complete, whereas the equivalent simulation of the circuit database, which is bit-for-bit identical for every component instance IO on every clock cycle, takes 27 seconds to complete. Simulation and evaluation of 90% of the design in the circuit database form, representing the heart of the design, takes less than 1 second.

### Computer System

FIG. 10 shows a block diagram illustrating a computer system 1000 in accordance with an embodiment of the present invention. The computer system 1000 includes one or more processors 1010a-1010n, storage 1030, memory 1040, peripherals communications interface 1050, user interface 1070, and one or more signal lines 1060 coupling these components together. Note that one or more processing units 1010a-1010n may support parallel processing and/or multi-threaded operation, and that one or more signal lines 1060 may constitute a communication bus. Moreover, the user interface 1070 may include a display 1072, a keyboard 1074, and/or a pointer 1076, such as a mouse. Display 1072, keyboard 1074, and/or pointer 1076 may be combined into a touch display.

Memory 1040 in computer system 1000 may include volatile memory like RAM, DRAM or SRAM. Storage 1030 may include non-volatile memory like ROM, EPROM, EEPROM, FLASH, one or more smart cards, one or more magnetic disc storage devices, and/or one or more optical storage devices.

Memory 1040 may contain binary instructions & data 884, which represent the compiled binary instructions & static data 298 from program instructions 850 and the run-time data 888 generated as a result of executing 884 on computer system 1000. Binary instructions & data 884 may be stored in storage 1030 and may be loaded into memory 1040 for run-time execution. If Circuit API 800 is in source code form or compile-time library form, it may be used by compiler 882 to couple it with programming instructions 850 to produce binary instructions & data 884. If Circuit API 800 is in run-time library form, it may be loaded into memory 1040 and linked with binary instructions & data 884 during binary instructions & data 884 execution.

Although the computer system 1000 is illustrated as having a number of discrete components, FIG. 10 is intended to be a functional description of the various features that may be present in the computer system 1000 rather than as a structural schematic of the embodiments described herein. In practice, and as recognized by those of ordinary skill in the art, the functions of the computer system 1000 may be distributed over a large number of servers or computers, with various groups of the servers or computers performing particular subsets of the functions.

Computer system 1000 may include fewer components or additional components, two or more components may be combined into a single component, and/or a position of one or more components may be changed. In some embodiments the functionality of computer system 1000 may be implemented more in hardware and less in software, or less in hardware and more in software, as is known in the art.

1.-53. (canceled)

54. A computer implemented method for simulating a circuit design comprising a plurality of circuit components, the method comprising:
providing a simulation kernel comprises object code for execution on a processor, including instructions for performing circuit simulation functionality;
providing a plurality of component re-usable program elements, wherein each component re-usable program element is associated with a type of circuit component, wherein each of the component re-usable program elements comprises object code for execution on the processor including:
wire re-usable program elements with a maximum bit-width on each input and output; and
instructions for simulating the functional behavior of the respective circuit component;
providing computer program instructions representing the circuit design, including a plurality of instances of the component re-usable program elements;
compiling together the computer program instructions, the component re-usable program elements and the simulation kernel to generate an executable computer program for execution on the processor; and
using the processor to execute the executable computer program to simulate the circuit design.

55.-59. (canceled)

60. The method of claim 54, wherein the simulation kernel includes instructions for simulating clock cycles and for updating values for each of the component re-usable program elements being simulated for each of the simulated clock cycles.

61. The method of claim 60, wherein the simulation kernel includes instructions for a loop to update each asynchronous component being simulated for each of the simulated clock cycles.

62. (canceled)

63. The method of claim 61, wherein the simulation kernel includes instructions for a loop to update the internal states of each synchronous component being simulated for each of the simulated clock cycles.

64.-66. (canceled)

67. The method of claim 63, wherein at least some of the component re-usable program elements represent logic gates that are simulated using the asynchronous simulation loop.

68. The method of claim 67, wherein at least some of the component re-usable program elements represent flip-flops that are simulated using the synchronous simulation loop.

69.-73. (canceled)

74. The method of claim 68, wherein at least some of the component re-usable program elements represent circuit components that comprise a plurality of logic gates, wherein:
the instructions for simulating the functional behavior of the circuit component include instructions for calculating a functional result for the respective circuit component without simulating the functional behavior of each of the logic gates.

75. The method of claim 74, wherein at least some of the component re-usable program elements represent circuit components that comprise a plurality of synchronous circuit elements, wherein:
the instructions for simulating the functional behavior of the circuit component include instructions for calculating a functional result for the respective circuit component without simulating the functional behavior of each of the synchronous circuit elements.

76. (canceled)

77. The method of claim 75, further comprising instructions to disable or bypass simulation of at least some of the instances of the component re-usable program elements.

78. (canceled)

79. The method of claim 77, wherein the instructions to simulate at least some of the component re-usable program elements include instructions for simulating individual circuit elements of the respective circuit component, and instructions for calculating a functional result for the component re-usable program element without simulating the individual circuit elements of the respective circuit component.

80.-92. (canceled)

93. A computer implemented method for simulating a circuit design comprising a plurality of circuit components, the method comprising:
providing a plurality of component re-usable program elements, wherein each component re-usable program element comprises:
wire re-usable program elements with a maximum bit-width on each input and output; and
instructions for simulating the respective circuit component by calculating a functional result for the respective circuit component using instructions from a processor instruction set without simulating the behavior of each of the individual circuit structures for the respective circuit component;
providing computer program instructions representing the circuit design, including a plurality of instances of the component re-usable program elements;
using a computer to compile the computer program instructions into an executable computer program for the processor instruction set; and
executing the executable computer program on a processor compatible with the processor instruction set to simulate the circuit design.

94.-98. (canceled)

99. The method of claim 93, wherein the component re-usable program elements include at least one component re-usable program element for a floating-point adder and the instructions for simulating the respective circuit component comprise a floating-point add instruction of the processor instruction set.

100.-113. (canceled)

114. The method of claim 99, wherein the component re-usable program elements include at least one component re-usable program element for a multiplexer and the instructions for simulating the respective circuit component comprise if-else conditional instructions, switch-case instructions, or instructions for a memory look-up into an array containing the input values, for the processor instruction set.

115.-117. (canceled)

118. The method of claim 114, wherein the component re-usable program elements include at least one component re-usable program element for a register and the instructions for simulating the respective circuit component comprise instructions for reading and modifying a memory location of the processor instruction set.

119.-120. (canceled)

121. The method of claim 118, wherein the component re-usable program elements include at least one component re-usable program element for an integer adder and the instructions for simulating the respective circuit component comprise an integer add instruction of the processor instruction set.

122.-124. (canceled)

125. The method of claim 121, wherein the component re-usable program elements include at least one component re-usable program element for an memory and the instructions for simulating the respective circuit component comprise an array with instructions for reading and modifying array elements.

126.-142. (canceled)

143. A computer implemented method for simulating a circuit design comprising a plurality of circuit components, the method comprising:
providing a plurality of component re-usable program elements, wherein each component re-usable program element is associated with a type of circuit component, wherein each of the component re-usable program elements include:
wire re-usable program elements with a maximum bit-width on each input and output; and
instructions for selectively simulating the functional behavior of the respective circuit component using a low level model, and
instructions for selectively simulating the functional behavior of the respective circuit component using a high level model;
providing computer program instructions representing the circuit design, including a plurality of instances of the component re-usable program elements wherein at least one implementation option is specified for each instance of the component reusable program elements;
using a processor to execute the computer program instructions representing the circuit design to simulate the functional behavior of the circuit design, including instructions for dynamically selecting between the low level model and the high level model for simulation for at least some of the instances of the component re-usable program elements.

144. The method of claim 143, wherein at least one of the component re-usable program elements represents a floating-point adder.

145. The method of claim 144, wherein the low-level model for the floating point adder includes a model comprising boolean gates and flip-flops, and wherein the high-level model for the floating-point adder includes instructions that use a floating-point add operator of the processor.

146.-151. (canceled)

152. The method of claim 145, wherein at least one of the component re-usable program elements represents an integer adder.

153. The method of claim 152, wherein the low-level model for the integer adder includes a model comprising boolean gates and flip-flops, and wherein the high-level model for the integer adder includes instructions that use an integer add operator of the processor.

154.-159. (canceled)

160. The method of claim 153, wherein at least one of the component re-usable program elements represents a multiplexer.

161. The method of claim 160, wherein the low-level model for the multiplexer includes a model comprising boolean gates and/or flip-flops, and wherein the high-level model for the multiplexer includes instructions that use if-else conditional instructions, switch-case instructions, or instructions for a memory look-up into an array containing the input values, of the processor.

162.-165. (canceled)

166. The method of claim 161, wherein at least one of the component re-usable program elements represents a register.

167. The method of claim 166, wherein the low-level model for the register includes a model comprising boolean gates and flip-flops, and wherein the high-level model for the counter includes instructions for reading and modifying a memory location of the processor.

168.-169. (canceled)

170. The method of claim 167, wherein at least one of the component re-usable program elements represents a memory.

171. The method of claim 170, wherein the low-level model for the memory includes a model comprising boolean gates and flip-flops, and wherein the high-level model for the memory includes an array with instructions for reading and modifying array elements on the processor.

172.-249. (canceled)
